(19) United States
(12) Patent Application Publication
(10) Pub. No.: US 2022/0280912 A1
(43) Pub. Date: Sep. 8, 2022

(54) ZINC-CONTAINING ZEOLITES FOR CAPTURE OF CARBON DIOXIDE FROM LOW-CO2 CONTENT SOURCES AND METHODS OF USING THE SAME

(71) Applicant: California Institute of Technology, Pasadena, CA (US)

(72) Inventors: Donglong Fu, Pasadena, CA (US); Mark E. Davis, Pasadena, CA (US)

(21) Appl. No.: 17/681,649

(22) Filed: Feb. 25, 2022

Related U.S. Application Data
(60) Provisional application No. 63/154,334, filed on Feb. 26, 2021.
(60) Provisional application No. 63/237,180, filed on Aug. 26, 2021.

(51) Int. Cl. B01J 20/18; B01D 53/62; B01J 20/28

(52) U.S. Cl. CPC B01J 20/186; B01D 53/62; B01J 20/2808; B01D 2253/1085; B01D 2257/504

(57) ABSTRACT

The present disclosure is directed to metal ion-containing zeolitic compositions, preferably transition metal ion-containing, more preferably zinc ion containing zeolitic compositions, that are useful for scavenging CO₂ from low-CO₂-content feed streams, including air, and method of making and using the same. In some embodiments, the compositions comprise zinc-ion-doped zeolites having AEI, AFX, or CHA topologies.

### CROSS REFERENCE TO RELATED APPLICATIONS

This application claims the benefit of U.S. Provisional Application No. 63/154,334, filed Feb. 26, 2021, and U.S. Provisional Application No. 63/237,180, filed Aug. 26, 2021. Each of the aforementioned applications is incorporated by reference herein in its entirety.

### TECHNICAL FIELD

The present disclosure is directed to metal ion-containing zeolitic compositions, preferably transition metal ion-containing, more preferably zinc ion-containing zeolitic compositions that are useful for scavenging carbon dioxide (CO₂) from low-CO₂-content gaseous source mixtures (feed streams), including air, and methods of making and using the same. In some preferred embodiments, the compositions comprise zinc ion-doped zeolites having AEI, AFX, or CHA topologies capable of efficiently removing carbon dioxide from low-CO₂-content gaseous source mixtures.

### BACKGROUND

Mitigation of the increasing concentration of CO₂ in the atmosphere has been recognized as one of the most serious global challenges in the 21^{st} century. The level of global atmospheric CO₂ surpassed 409 ppm in 2018, and predictions suggest that it could reach 500 ppm by 2050. See “Climate Change: Atmospheric Carbon Dioxide|NOAA Climate.gov,” can be found under https://www.climate.gov/news-features/understanding-climate/climate-change-atmospheric-carbon-dioxide). Even if drastic measures are taken to completely halt anthropogenic CO₂ emissions by 2040, the climate risks posed by high atmospheric CO₂ concentration are likely to persist for decades afterward. See D. W. Keith, Science 2009, 325, 1654-1655; D. Archer, et al., Annu. Rev. Earth Planet. Sci. 2009, 37, 117-134. Therefore, active removal of CO₂ from air using direct air capture (DAC) is one strategy (amongst many) being considered to assist in the battle to limit further increases in CO₂ concentration in the atmosphere. See K. S. Lackner, et al., Proc. Natl. Acad. Sci. 2012, 109, 13156-13162. Compared to the conventional point-source CO₂ capture from cement plants, power stations, iron/steel industry installations, and oil refineries, DAC could mitigate CO₂ emissions from all sources, and in turn, enable onsite technologies that require CO₂ as a feedstock (thereby eliminating the need for storage and transport infrastructure). See C. Brady, et al. Proc. Natl. Acad Sci. 2019, 116, 25001-25007; C. Breyer, et al. Joule 2019, 3, 2053-2057; E. S. Sanz-Pérez, et al. Chem. Rev. 2016, 116, 11840-11876.

Carbon dioxide (CO₂) capture is being investigated as an important approach to limit further increases in CO₂ concentration in the atmosphere. See K. S. Lackner, et al. Proc. Natl. Acad Sci. 2012, 109, 13156-13162. The conventional approaches for capturing high concentration (>10%) CO₂ are being developed for addressing emissions from point sources, such as cement plants, power stations, iron/steel industry installations, and oil refineries. However, point source capture by itself will not be able to reduce atmospheric CO₂ as ca. 50% of the anthropogenic emissions are from mobile sources. See E. S. Sanz-Pérez, et al. Chem. Rev. 2016, 116, 11840-11876. Direct air capture (DAC) may be able to aid in mitigating global CO₂ amounts originating from point source and non-point source emissions, and allow for onsite technologies for CO₂ storage or unitization (thereby eliminating the need for storage and transport infrastructure). See E. S. Sanz-Pérez, et al. Chem. Rev. 2016, 116, 11840-11876; C. Brady, et al. Proc. Natl. Acad. Sci. 2019, 116, 25001-25007; C. Breyer, et al. Joule 2019, 3, 2053-2057. DAC is also promising for capture of leaked CO₂ from carbon capture and storage (CCS) point sources and/or geologic CO₂ storage sites. See X. Shi, et al. Angew. Chem. Int. Ed 2019, 59, 6984-7006. DAC requires capture from low concentrations of CO₂, ca. 400 ppm CO₂. In addition to DAC, efficient removal of low concentration CO₂ may be useful for other situations such as air purification in space stations and future human space environments, aircraft, submarine, and office buildings, and in medicine, e.g., anesthesia machines. See O. Shekhah, et al. Nat. Commun. 2014, 5, 4228; S. Mukherjee, et al. Sci. Adv. 2019, 5, eaax9171. In order to create efficient capture technologies for low concentration CO₂ environments, there is a need for new adsorbents.

Development of low cost physisorbents may be useful for CO₂ capture because they have the potential for fast kinetics and low energy requirements for regeneration that could drastically reduce the cost of operations. See A. Kumar, et al. Angew. Chem. Int. Ed. 2015, 54, 14372-14377; S. Choi, et al. ChemSusChem 2009, 2, 796-854. These properties will likely be particularly significant in applications involving trace CO₂ capture, as the low concentrations of CO₂ often result in both low diffusion rates and low CO₂ capacities. See J. Liu, et al. ACS Sustain. Chem. Eng. 2019, 7, 82-93. Zeolites are used in many commercial applications including catalysis, adsorption and separation due to their physical and chemical stabilities as well as other merits attributed to their unique structures. See M. Flanigen, et al. in Zeolites in Industrial Separation and Catalysis (Ed.: S. Kulprathipanja), Wiley-VCH, Weinheim, 2010, pp. 1-26; Y. Li, L. Li, J. Yu, Chem 2017, 3, 928-949; M. E. Davis, Nature 2002, 417, 813-821. They can be synthesized at very large scale over a broad range of properties, e.g., very hydrophilic to very hydrophobic. Zeolites already have shown promising performance for CO₂ capture in post-combustion carbon capture processes as well as CO₂ removal in air pre-purification processes (including the international space station). See S. Choi, et al. ChemSusChem 2009, 2, 796-854; K. T. Chue, et al. Ind Eng. Chem. Res. 1995, 34, 591-598; S. Sircar, W. C. Kratz, 1981, U.S. Pat. No. 4,249,915A; R. Kay, SAE Trans. 1998, 107, 514-522.

Capture of CO₂ requires an effective and economic sorbent that possesses merits such as moderate CO₂-binding affinity, fast sorption kinetics, high capacity, good selectivity against other components in the air, easy regeneration with minimal energy input, long-term stability, and low cost. See S. Choi, et al. ChemSusChem 2009, 2, 796-854. To this end, DAC efforts in the past decade or so have involved a variety of sorbent types; chemisorbents using amine-based materials (see E. S. Sanz-Pérez, et al. Chem. Rev. 2016, 116, 11840-11876; S. A. Didas, et al. Acc. Chem. Res. 2015, 48, 2680-2687; J. J. Lee, et al. Langmuir 2018, 34, 12279-12292; A. R. Sujan, et al. ACS Sustain. Chem. Eng. 2019, 7, 5264-5273), moisture-swing sorbents (see X. Shi, et al., Angew. Chem. Int. Ed 2019, 59, 6984-7006; M. Oschatz and M. Antonietti, Energy Environ. Sci. 2018, 11, 57-70), and physisorbents like zeolites (see A. Kumar, et al. Angew. Chem. Int. Ed 2015, 54, 14372-14377; S. M. W. Wilson and F. H. Tezel, Ind Eng. Chem. Res. 2020, 59, 8783-8794), and metal-organic frameworks (MOFs), see P. M. Bhatt, et al. J. Am. Chem. Soc. 2016, 138, 9301-9307; K. Sumida, et al., Chem. Rev. 2012, 112, 724-781; D. M. D'Alessandro, et al., Angew. Chem. Int. Ed 2010, 49, 6058-6082. Chemisorbents have been extensively studied for DAC of CO₂ due to their high CO₂ uptake. This type of sorbent is currently being used by several companies such as Carbon Engineering, ClimeWorks, and Global Thermostat. See H. Azarabadi and K. S. Lackner, Appl. Energy 2019, 250, 959-975. These sorbents either require elevated temperatures (100-900° C.) for regeneration or they suffer from time-dependent oxidation, and can expel toxic volatiles into the atmosphere. See E. S. Sanz-Pérez, et al. Chem. Rev. 2016, 116, 11840-11876; A. Kumar, et al. Angew. Chem. Int. Ed 2015, 54, 14372-14377. DAC via physisorption is attractive because of the potential for high selectivity, fast kinetics and low energy requirements for recycling. A. Kumar, et al. Angew. Chem. Int. Ed 2015, 54, 14372-14377.

Porous materials, in particular zeolites, are one class of adsorbent material with potential for DAC. Zeolites are crystalline, aluminosilicate materials that have a proven track record of use in industry for catalysis, adsorption and separation due to their physical and chemical stabilities. See S. Kulprathipanja, Wiley—VCH Verl. GmbH Co KGaA 2010, 620. The charge mismatch between the framework Si⁴⁺ with Al³⁺ results in a net negative charge that can be balanced by alkali metal, alkaline earth metal, proton and ammonium cations or some type other positively charged species. The abundance of cation exchangeable sites in their pore networks enables this class of material to adsorb a wide variety of gas molecules, including acidic gas molecules such as CO₂. See S. Choi, et al. ChemSusChem 2009, 2, 796-854. Indeed, zeolites are promising sorbents for CO₂ capture in post-combustion carbon capture processes as well as CO₂ removal in air pre-purification processes and are used in a number of locations including the international space station. See S. Choi, et al. ChemSusChem 2009, 2, 796-854; K. T. Chue, et al., Ind Eng. Chem. Res. 1995, 34, 591-598; S. Sircar and W. C. Kratz, Removal of Water and Carbon Dioxide from Air, 1981, U.S. Pat. No. 4,249,915A; R. Kay, SAE Trans. 1998, 107, 514-522.

Although numerous zeolites have been investigated for carbon capture (see A. Khelifa, et al. Microporous Mesoporous Mater. 1999, 32, 199-209; V. P. Shiralkar, S. B. Kulkarni, Zeolites 1985, 5, 37-41; K. S. Walton, et al. Microporous Mesoporous Mater. 2006, 91, 78-84; T.-H. Bae, et al. Energy Environ. Sci. 2012, 6, 128-138; Y. Zhou, et al. Science 2021, 373, 315-320), the research for capture of low concentrations of CO₂ has mainly been focused on low-silica FAU-type zeolites (Si/Al of less than 2). See A. Kumar, et al. Angew. Chem. Int. Ed. 2015, 54, 14372-14377; N. R. Stuckert, R. T. Yang, Environ. Sci. Technol. 2011, 45, 10257-10264; S. M. W. Wilson, F. H. Tezel, Ind Eng. Chem. Res. 2020, 59, 8783-8794. Low-silica zeolites are hydrophilic so they have high water capacity as well as low hydrothermal stability that likely will present challenges for large scale commercialization of carbon capture technologies. See N. S. Wilkins, J. A. Sawada, A. Rajendran, Adsorption 2020, 26, 765-779. Zeolites with higher Si/Al give higher hydrophobicity, yet they are known to have low CO₂ capacity.

Low-silica zeolites with the FAU (13X and Y as trade names) and LTA (4A as the trade name) framework topologies are among the most commonly used adsorbents in industrial gas adsorption and separations. See A. Khelifa, et al., Microporous Mesoporous Mater. 1999, 32, 199-209; V. P. Shiralkar and S. B. Kulkarni, Zeolites 1985, 5, 37-41; K. S. Walton, et al., Microporous Mesoporous Mater. 2006, 91, 78-84; T.-H. Bae, et al., Energy Environ. Sci. 2012, 6, 128-138. However, their strong CO₂ binding energy via both physisorption and chemisorption as well as their hydrothermal stability can lead to difficulties with regeneration, and thus lead to low recyclability even under vacuum regenerating conditions.^{[15,24,31]} See S. M. W. Wilson and F. H. Tezel, Ind. Eng. Chem. Res. 2020, 59, 8783-8794; T. D. Pham, et al., Langmuir 2013, 29, 832-839; P. J. E. Harlick, F. H. Tezel, Microporous Mesoporous Mater. 2004, 76, 71-79. Recently, a high-silica zeolite, SSZ-13, possessing the CHA framework topology, has gained attention, as it is now successfully commercialized for selective catalytic reduction of NO_{X} with ammonia in vehicle emissions. See J. H. Kwak, R. G. Tonkyn, D. H. Kim, J. Szanyi, C. H. F. Peden, J. Catal. 2010, 275, 187-190; I. Bull, et al., Copper CHA Zeolite Catalysts, 2009, U.S. Pat. No. 7,601,662B2. Both experimental results and computer simulations have shown promising adsorption capacity and CO₂/N₂ selectivity of cation exchanged SSZ-13 zeolites for CO₂ capture. See T. D. Pham, et al., Langmuir 2013, 29, 832-839; M. R. Hudson, et al., J. Am. Chem. Soc. 2012, 134, 1970-1973; J. Shang, et al., J. Am. Chem. Soc. 2012, 134, 19246-19253; T. Du, Research on Chemical Intermediates volume 2017, 1783-1792; M. Sun, et al., Chem. Eng. J. 2019, 370, 1450-1458; J. Zhang, et al., Microporous Mesoporous Mater. 2008, 111, 478-487; M. Debost, et al., Angew. Chem. Int. Ed. 2020, 59, 23491-23495; J. K. Bower, et al., ACS Appl. Mater. Interfaces 2018, 10, 14287-14291. Yet, there are no studies reported for DAC of CO₂ with SSZ-13.

Zinc-exchanged CHA has been reported for CO₂ capture. See Du, T., et al. Preparation of zinc chabazite (ZnCHA) for CO₂ capture. Res Chem Intermed 43, 1783-1792 (2017). https://doi.org/10.1007/s11164-016-2729-y; Mingzhe Sun, et al., Transition metal cation-exchanged SSZ-13 zeolites for CO₂ capture and separation from N2, Chemical Engineering Journal, Volume 370, 2019, 1450-1458, ISSN 1385-8947, https://doi.org/10.1016/j.cej.2019.03.234. However, these materials have been examined for CO₂ capture from flue gasses which comprise large proportions of CO₂. An adsorbent that is effective for capturing CO₂ from gasses having a high CO₂ do not necessarily demonstrate similar performance in the context of gasses having relatively low CO₂ concentrations. Indeed, the preparation method of the CHA with Si/Al=2.2 did not show good performance (CO₂ uptake) for 400 ppm CO₂. See Zn-CHA2(a)-1.91E in Table 2 herein.

Thus, a need exists for efficient adsorbents for DAC of CO₂ from feed gasses having relatively low CO₂ concentrations, such as, for example, atmospheric air.

### SUMMARY

The present disclosure provides metal ion-doped crystalline microporous aluminosilicate compositions comprising:

(a) a three-dimensional aluminosilicate framework containing α-cages with 8-MR openings that are sized to accommodate the molecular dimensions of carbon dioxide (3.3 Å);

(b) the framework further comprising d6r (or D6MR) composite building blocks having 6-membered rings that face (are part of) or connect the α-cage of the framework;

wherein the crystalline microporous aluminosilicate contains 1.2 to 8 metal ions per unit cell, wherein the ratio of metal ions to aluminum within the unit cell is from 0.33 to 0.85; and

wherein the metal ion-doped crystalline microporous aluminosilicate composition adsorbs carbon dioxide when exposed to a gaseous mixture comprising carbon dioxide.

The present disclosure also is directed to compositions useful for capturing carbon dioxide (CO₂) from low-CO₂-content gaseous source mixtures (feed streams), including air, and methods of making and using the same. In certain embodiments, the compositions comprise metal ion-doped crystalline microporous aluminosilicate compositions comprising:

(a) a three-dimensionally aluminosilicate framework containing α-cages interconnected by 8-MR openings that are appropriately sized for accommodating the molecular dimensions of carbon dioxide (3.3 Å);

(b) the framework further comprising d6r (or D6MR) composite building blocks having 6-membered rings that face (are part of) the α-cage of the framework;

wherein the crystalline microporous aluminosilicate contains metal ions, preferably transition metal ions, more preferably zinc ions, positioned within the framework lattice; and

wherein the metal ion-doped crystalline microporous aluminosilicate composition adsorbs carbon dioxide more than the otherwise same crystalline microporous aluminosilicate composition that does not contain the metal ions when subjected to the same gaseous source mixture under the same conditions.

In certain independent aspects:

(a) the aluminosilicate framework has a AEI, AFT, AFX, CHA, EAB, KFI, LEV, or SAS topology, preferably a AEI, AFX, or CHA (e.g., SSZ-13) topology;

(b) the aluminosilicate framework have a Si:Al atomic ratio is in a range of from 1:1 to 20:1, or any one of the ranges defined elsewhere herein;

(c) the metal ions positioned within the framework lattice comprise a transition metal ion, preferably iron, cobalt, nickel, copper, zinc, or silver, more preferably zinc;

(d) the (transition) metal ions are present within the framework lattice in a ratio of from 0.5 to 6 metal ions per unit cell, or any one of the ranges defined elsewhere herein;

(e) the compositions contain or have the capacity to contain carbon dioxide in a range of from 0.5 to 0.55 to 1.7 mmol adsorbed CO₂ per unit cell, when the metal ion-doped crystalline microporous aluminosilicate composition is exposed to a gas source having (i) a total pressure in a range of from 50 kPa to 125 kPa, or any one of the ranges or values defined elsewhere herein, and (ii) a CO₂ content in a range of from 350 to 425 ppm, or any one of the ranges or values defined elsewhere herein;

(f) in those compositions containing carbon dioxide, the carbon dioxide is desorbed at a temperature of less than 130° C., less than 125° C., less than 120° C., less than 115° C., less than 110° C., or less than 100° C.;

(g) the composition adsorbs less than 15 wt %, less than 10 wt %, or less than 5 wt % water, relative to the weight of the anhydrous metal ion-doped crystalline microporous aluminosilicate composition; and/or

(h) in those compositions containing water, the water desorbs at a temperature of less than 250° C., less than 225° C., less than 200° C., less than 175° C., or less than 150° C.

In certain independent aspects:

(a) the aluminosilicate framework has a AEI, AFT, AFX, CHA, EAB, KFI, LEV, or SAS topology, preferably a AEI, AFX, or CHA (e.g., SSZ-13) topology;

(b) the aluminosilicate framework have a Si:Al atomic ratio is in a range of from 1:1 to 20:1, or any one of the ranges defined elsewhere herein;

(c) the metal ions positioned within the framework lattice comprise a transition metal ion, preferably iron, cobalt, nickel, copper, zinc, or silver, more preferably zinc;

(d) the (transition) metal ions are present within the framework lattice in a ratio of from 0.5 to 6 metal ions per unit cell, or any one of the ranges defined elsewhere herein;

(e) the compositions contain or have the capacity to contain carbon dioxide in a range of from 0.5 to 0.55 to 1.3 mmol adsorbed CO₂ per unit cell, when the metal ion-doped crystalline microporous aluminosilicate composition is exposed to a gas source having (i) a total pressure in a range of from 50 kPa to 125 kPa, or any one of the ranges or values defined elsewhere herein, and (ii) a CO₂ content in a range of from 350 to 425 ppm, or any one of the ranges or values defined elsewhere herein;

(f) in those compositions containing carbon dioxide, the carbon dioxide is desorbed at a temperature of less than 130° C., less than 125° C., less than 120° C., less than 115° C., less than 110° C., or less than 100° C.;

(g) the composition adsorbs less than 15 wt %, less than 10 wt %, or less than 5 wt % water, relative to the weight of the anhydrous metal ion-doped crystalline microporous aluminosilicate composition; and/or

(h) in those compositions containing water, the water desorbs at a temperature of less than 250° C., less than 225° C., less than 200° C., less than 175° C., or less than 150° C.

Certain embodiments provide that the compositions set forth herein can be prepared by methods comprising contacting a precursor crystalline microporous aluminosilicate with an aqueous solution of a salt of a suitable metal ion, and optionally rinsing the resulting metal ion-doped crystalline microporous aluminosilicate with water and/or optionally drying the metal ion-doped crystalline microporous aluminosilicate, wherein the salt is any one of the salts described elsewhere herein, and the method steps are optionally those described herein.

Certain embodiments provide methods of capturing carbon dioxide from a gaseous source mixture, such methods comprising contacting the gaseous source mixture with any one or more of the metal ion-doped crystalline microporous aluminosilicate compositions set forth herein so as to adsorb the carbon dioxide into the composition, and optionally desorbing the carbon dioxide from the carbon-dioxide laden metal ion-doped crystalline microporous aluminosilicate.

In certain independent aspects of these methods:

(a) the contacting of the metal ion-doped crystalline microporous aluminosilicate with the gaseous source mixture is done in the absence or without the use of an added desiccant; and/or

(b) the contacting of the metal ion-doped crystalline microporous aluminosilicate with the gaseous source mixture is done in the presence or with the use of an added desiccant.

Certain additional embodiments provide for the material configurations that allow for the practice of these methods.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present application is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In addition, the drawings are not necessarily drawn to scale.

FIGS. 1A-1B show the research setup and methodology for the adsorption/desorption measurements. 1A) Schematic illustration of the set-up used in this work for the CO₂ adsorption/desorption dynamics measurement. 1B) A representative CO₂ breakthrough profile for zeolites obtained at 30° C. with a gas mixture of 400 ppm CO₂/400 ppm Ar (internal standard)/He.

FIG. 2 shows X-ray diffraction (XRD) patterns for zeolites studied in the disclosed Examples.

FIG. 3 shows scanning electron micrographs (SEM) for zeolites studied in the disclosed Examples.

FIGS. 4A-4B show ²⁹Si magic angle spinning (MAS) NMR spectra of CHA zeolites with different Si/Al ratios. The spectra were deconvoluted using a Gaussian function. Note that strong peak of Q(2Al) was observed for CHA2 zeolite, indicating the presence of abundant paired aluminum sites.

FIG. 5 shows bar graphs comparisons of CO₂ capacity (see also Table 2 herein) from CO₂ breakthrough curves of M-CHA7-0.5 zeolites, where M (denoted along the bottom axis) indicates cations exchanged into the CHA cage, in comparison with 13X zeolite and “as made” CHA7. The adsorption experiments were performed at 30° C. with a gas mixture of 400 ppm CO₂/400 ppm Ar (internal standard)/He. The results show that Zn-CHA zeolites possess the highest CO₂ adsorption capacity amongst the CHA materials. Note that all samples were not washed after ion exchange unless otherwise mentioned.

FIG. 6 shows bar graphs comparison of CO₂ capacity from CO₂ breakthrough curves of Zn-CHA7-NIE where N indicates the molar concentration of zinc acetate aqueous solution, IE means the sample was washed 6 times with copious amount of distilled water after ion exchange. The adsorption experiments were performed at 30° C. with a gas mixture of 400 ppm CO₂/400 ppm Ar (internal standard)/He.

FIG. 7 shows bar graphs comparison of CO₂ capacity from CO₂ breakthrough curves of Zn-CHAX-0.5, where X indicates the Si/Al ratios of zeolites. The adsorption experiments were performed at 30° C. with a gas mixture of 400 ppm CO₂/400 ppm Ar (internal standard)/He. Note that ion exchange was performed without washing with distilled water.

FIG. 8 shows bar graphs of breakthrough and saturation capacities from FAU (zeolite 13X) and Zn-exchanged small pore zeolites studied in this work. The results show much smaller differences in the breakthrough and saturation capacities for small pore zeolites than zeolite 13X. This suggests that Zn-exchanged small pore zeolites possess faster diffusion kinetics than 13×.

FIGS. 9A-9D show TPD results for CO₂ desorption from 9A, 9B) FAU (zeolite 13) and 9C, 9D) Zn-CHA7-1.9IE after being saturated with CO₂ from a gas stream of 400 ppm CO₂/400 ppm Ar (internal standard)/He. 9A, 9C) TPD spectra obtained using the following heating rates: 2, 5, 10, 15, 20 K.min⁻¹. 9B, 9D) Microkinetics analysis assuming first order desorption.

FIGS. 10A-10D show in situ FT-IR spectra for desorption of CO₂ from 10A, 10B) Zn-CHA7-1.9IE and 10C, 10D) zeolite 13X. The physisorption and chemisorption regions are in panels 10A, 10C) and 10B, 10D), respectively. The IR absorption peak at ca. 2356 cm⁻¹ is assigned to the physiosorbed CO₂ molecules, while the peaks between ca. 1300 and 1700 cm⁻¹ are attributed to the chemisorbed carbonate-like species. For example, the ca. 1700 and 1365 cm⁻¹ pair and ca. 1485 and 1425 cm⁻¹ pair are both originated from carbonate-like species. The results in 10A, 1° C.) show that physiosorbed molecules can be desorbed by Ar purging at RT, the chemisorbed species, however, were still present at 300° C. Moreover, the absence of the CO₂ vibrations in the chemisorption region in panel 10B) demonstrates that CO₂ exclusively adsorbed in the Zn-CHA zeolite via physisorption.

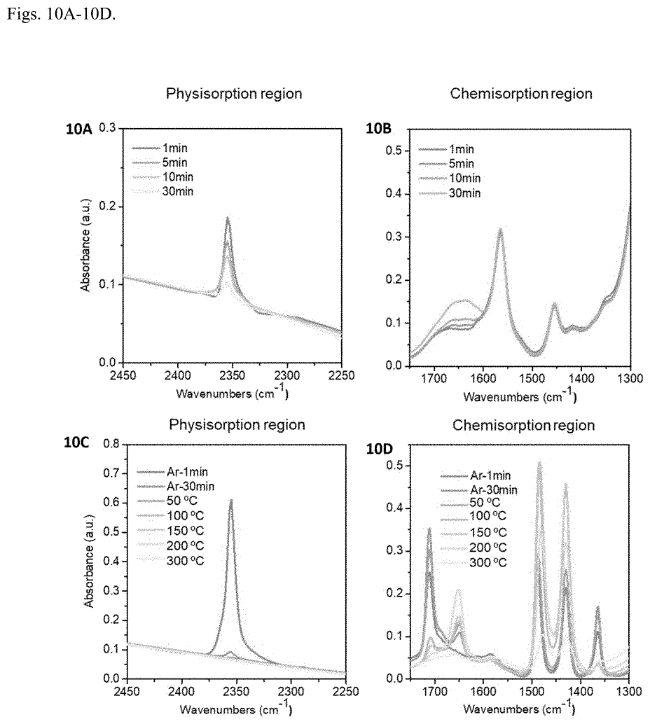

FIG. 11 shows TGA profiles of FAU (zeolite 13X) and Zn-CHA zeolites after equilibrium at RT under air with a relative humidity of ca. 20%. The TGA experiments were performed with a ramp rate of 10° C.min⁻¹ under dry N₂ flow. The results show that Zn-CHA zeolites are more hydrophobic than zeolite 13X, and that water removal from Zn-CHA requires less energy (lower temperature, as indicated by the arrow).

FIG. 12 shows Dry 400 ppm CO₂/400 ppm Ar (internal standard)/He adsorption-desorption recyclability over 7 consecutive cycles for Zn-CHA7-1.9IE. The first three cycles were obtained by regenerating the material at 550° C. for 120 min. Then the material was regenerated at 100° C. for 240 min for two cycles before a deep regeneration at 550° C. for 120 min. The last cycle was obtained by regenerating the sample at 60° C. for 240 min. The results show that the material exhibit high recyclability even at temperature as low as 100° C. Note that the relatively low starting capacity (compared to data in FIG. 6) is because the material has been tested for adsorption of CO₂ under humid conditions (49% RH) before the recyclability test.

FIG. 13 shows the FT-IR spectra for the O—H vibration region for the Zn-CHA7 zeolites as a function of Zn loading. The gradually decreased intensity of peak at 3660 cm⁻¹ indicates that Zn ions replace Brönsted acid sites (BAS). The appearance of a new band at 3665 cm⁻¹ indicates the formation of Zn(OH)⁺ in all stages upon loading Zn into the CHA cage.

FIG. 14 shows ¹H MAS NMR spectra for the pristine H-CHA7 and representative Zn-CHA7 samples with various Zn loadings. The gradually decreased peak intensity of SiOHAl indicates that Zn ions replace Brönsted acid sites (BAS). Moreover, a new peak at 1.08 ppm appeared concomitantly upon Zn loading, suggesting the formation of Zn(OH)⁺.

FIGS. 15A-15F show ¹H MAS NMR spectra for the Zn-CHA7 samples with various Zn ion loadings. The spectra were deconvoluted using a Gaussian function. Note that ion exchange experiments for samples in (15B-15D) were performed in Zn²⁺ aqueous solution with pH adjusted to 4.92 by adding 0.1 M HCl aqueous solution. The pH values for (15D-15F) were not controlled.

FIG. 16 shows number of residual H⁺ sites measured by ¹H MAS NMR on Zn-CHA7 samples of increasing Zn density. The two dashed lines reflect exchange of only monovalent (1 Zn vs. 1 H⁺) or monovalent (1 Zn vs. 2 H⁺) species, respectively. The results show that most of the Zn ions replace two H⁺ at stage I, while they start to replace more H⁺ sites at stage II, and followed by primarily exchanging one H⁺ sites at stage III.

FIG. 17 shows correlation of Zn²⁺ cation and total Zn ion density per unit cell SSZ-13, denoted as Zn²⁺/U.C. and Zn/U.C., respectively. The results show that Zn²⁺ continuously increases at stages I and II upon Zn loading. Dashed lines are interpolations to guide the eye.

FIGS. 18A-18B show a plausible speciation mechanism of Zn ions in CHA zeolites. 18A) Potential extra-framework cation locations are denoted by brown and blue spheres in 8MRs and below D6MRs in a CHA cage, respectively. 18B) The proposed mechanism for the speciation of Zn ion in CHA cages is consistent with the disclosed results and previous research on Cu-CHA zeolites (synthesized using Na⁺ as the mineralizer), that contain isolated and paired aluminum sites in the in 8MRs and below D6MRs, respectively.

FIGS. 19A-19D shows the FT-IR spectra of Zn-CHA7(K) with various Zn loadings. 19A) TOT region; 19B) OH region; 19C, 19D) CO₂ physisorption (19C) and chemisorption (19D) regions. The results show that the Zn ions are preferential coordinated in the D6MRs with the formation of Zn(OH)+ when Zn/U.C.<0.84, and that further increased Zn ions locate at the 8MRs. Moreover, CO₂ adsorbed in Zn-CHA7(K) exclusively in the form of physisorption as no apparent absorption peaks were observed in the chemisorption region.

FIGS. 20A-20D show ¹H MAS NMR spectra for the Zn-CHA(K)7 samples with various Zn loadings. The spectra were deconvoluted using a Gaussian function.

FIG. 21 shows number of residual H⁺ sites measured by ¹H MAS NMR on Zn-CHA(K)7 samples of increasing Zn density. The two dashed lines reflect exchange of only monovalent (1 Zn vs. 1 H⁺) or monovalent (1 Zn vs. 2 H⁺) species, respectively. The results show that most of the Zn ions replace one H⁺ at stage I, while they primarily exchange two H⁺ sites at stage II.

FIG. 22 shows UV-Vis diffuse reflectance spectra of Zn-CHA(K)7 zeolites with various Zn loading. the absence of the O₂→Zn²⁺ ligand-to-metal charge transfer transition band at 360 nm in the UV-Vis DRS spectra for all samples demonstrates that there is no Zn—O—Zn species formed in Zn-CHA(K)7 materials.

FIGS. 23A-23B show Zn-loading dependent adsorption performance of Zn-CHA(K)7. 23A) Bar graphs of breakthrough and saturation CO₂ capacities obtained from CO₂ breakthrough curves for Zn-CHA(K)7 zeolites. 23B) CO₂ capacity per unit cell (CO₂/U.C.) and CO₂ capacity per zinc (CO₂/Zn) measured on Zn-CHA(K)7 samples of increasing Zn ion density. Adsorption experiments were performed at 30° C. with a gas mixture of 400 ppm CO₂/400 ppm Ar (internal standard)/He. Dashed lines are interpolations to guide the eye.

FIGS. 24A-24B show plausible speciation mechanism of Zn ions in CHA(K) zeolites. 24A) Potential extra-framework cation locations are denoted by brown and blue spheres in 8MRs and below D6MRs in a CHA cage, respectively. 24B) The proposed mechanism for the speciation of Zn ion s in CHA cages is consistent with the disclosed results and on work disclosing the Al sites in K-directed CHA zeolites, that contain paired and isolated aluminum sites in the 8MRs and D6MRs, respectively.

FIG. 25 shows Illustrations of framework topologies for AEI-type, AFX-type and CHA-type zeolites. The 8-membered rings (8MRs) and double 6-membered rings (D6MRs) are highlighted in pink and gold, respectively.

FIG. 26 shows illustrations of framework topologies for FAU-type and LTA-type zeolites. The 8 or 12-membered rings (8MRs, or 12MRs), double 6-membered rings (D6MRs) and D4MRs are highlighted in pink, gold and purple, respectively. Roman numerals in the FAU framework indicate the possible exchange sites for divalent cations. Also shown are d6r and SOD building blocks.

FIGS. 27A-27B show in situ FT-IR spectra for desorption of CO₂ from Zn-exchanged 13× (Zn-FAU-0.5IE). The physisorption and chemisorption regions are in panels 27A) and 27B), respectively. The absence of the peaks for both physisorbed (2356 cm⁻¹) and chemisorbed (1300-1700 cm⁻¹) CO₂ in 27A, 27B) demonstrates that Zn-exchange inhibits CO₂ adsorption in zeolite 13×.

FIGS. 28A-28D show in situ FT-IR spectra for desorption of CO₂ from 28A, 28B) 4A (LTA-type) and 28C, 28D) Zn-exchanged 4A (Zn-LTA-0.5IE). The physisorption and chemisorption regions are in panels 28A, 28C) and 28B, 28D), respectively. The IR absorption peak at ca. 2356 cm⁻¹ is assigned to the physiosorbed CO₂ molecules, while the peaks between 1300-1700 cm⁻¹ are attributed to the chemisorbed carbonate-like species. For example, the ca. 1700 and 1365 cm⁻¹ pair and ca. 1485 and 1425 cm⁻¹ pair are both originated from carbonate-like species. The results show that physiosorbed molecules can be desorbed by Ar purging at RT, the chemisorbed species, however, were still present even at 300° C. Moreover, the absence of the peaks for both physisorbed and chemisorbed CO₂ in 28C, 28D) demonstrate that Zn-exchange inhibits CO₂ adsorption in zeolite 4A.

FIGS. 29A-29C show performance of Zn ion exchanged CHA-type zeolites for CO₂ adsorption. 29A) CHA cage with 8-membered ring (8MRs) and double 6-membered ring (D6MR) highlighted in pink and gold, respectively. Extra-framework cation locations are shown by brown and blue spheres in the 8MR and below the D6MR, respectively. 29B) The capacities for CO₂ adsorption in cation-exchanged CHA-type (M-CHAR-NIE2X) zeolites, where M, R, N and IE indicate the cation, Si/Al ratio, aqueous concentrations of ions and how many exchanges (if no value listed, only one exchange was performed), respectively. 29C) Dynamic gas breakthrough profiles for 13X and Zn-CHA7-1.9IE. Zeolite 13X is used for comparison since it is a standard and top-performing zeolite adsorbent for direct air capture (DAC). All experiments were performed at 30° C. with a gas mixture of 400 ppm CO₂/400 ppm Ar (internal standard)/He.

FIGS. 30A-30D show speciation of Zn ions in the CHA-type zeolites and the impact on CO₂ adsorption. 30A) CO₂ capacity per unit cell (CO₂/U.C.) of Zn-CHA7 samples with increasing Zn ion density (Zn/U.C.). Adsorption was performed at 30° C. with a gas mixture of 400 ppm CO₂/400 ppm Ar (internal standard)/He. 30B) The FT-IR spectra for the framework T-O-T vibration of Zn-CHA7 materials with various Zn ion loading. 30C) UV-Vis diffuse reflectance spectra of Zn-CHA7 zeolites with various Zn ion loading. 30D) Correlation of the number of Zn²⁺ and CO₂ per unit cell. Dashed lines are interpolations to guide the eye.

FIG. 31 shows Zeolite topology-dependent CO₂ adsorption. Group I is small-pore zeolites with framework topologies more like the CHA-type. Group II includes the standard low-silica zeolite adsorbents. Adsorption experiments were performed at 30° C. with a gas mixture of 400 ppm CO₂/400 ppm Ar (internal standard)/He.

FIGS. 32A-32B show the dynamic gas breakthrough profiles of powder and sieved zeolite 32A) 13× and 32B) Zn-CHA2-1.9W2X. Solid and dash lines indicate the breakthrough profiles from powder and sieved (160-600 μm) zeolites, respectively. The results show that Zn-CHA zeolites exhibit faster adsorption kinetics than 13×.

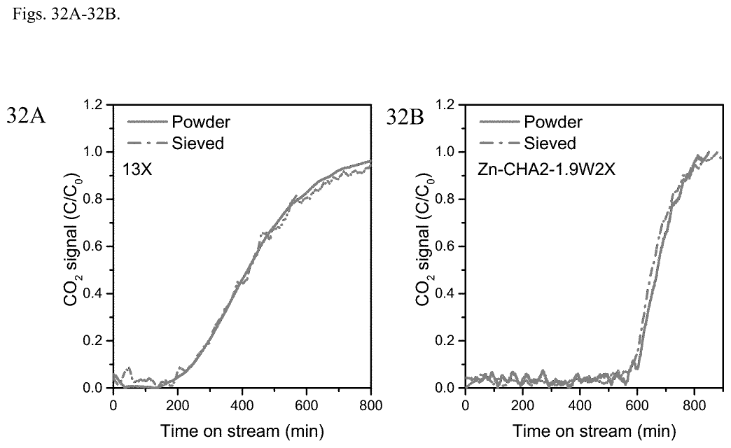

### DETAILED DESCRIPTION OF ILLUSTRATIVE EMBODIMENTS

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range. For example, a range defined as from 400 to 450 ppm includes 400 ppm and 450 ppm as independent embodiments.

It is to be appreciated that certain features of the invention which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

The transitional terms “comprising,” “consisting essentially of,” and “consisting” are intended to connote their generally in accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element, step, or ingredient not specified in the claim; and (iii) “consisting essentially of” limits the scope of a claim to the specified materials or steps “and those that do not materially affect the basic and novel characteristic(s)” of the claimed invention. Embodiments described in terms of the phrase “comprising” (or its equivalents), also provide, as embodiments, those which are independently described in terms of “consisting of” and “consisting essentially of.” For those embodiments provided in terms of “consisting essentially of,” the basic and novel characteristic(s) is the facile operability of the methods or compositions/systems to provide the aluminosilicate compositions at meaningful yields (or the ability of the systems using only those ingredients listed. Other components or steps may be included, as long as these additional components or steps do not materially affect the basic and novel characteristic(s) of the claimed invention.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C,” as separate embodiments, as well as C1-3.

Throughout this specification, words are to be afforded their normal meaning, as would be understood by those skilled in the relevant art. However, so as to avoid misunderstanding, the meanings of certain terms will be specifically defined or clarified.

The terms “method(s)” and “process(es)” are considered interchangeable within this disclosure.

The terms “separating” or “separated” carry their ordinary meaning as would be understood by the skilled artisan, insofar as they connote physically partitioning or isolating of one material from another or the selective capture of one component from a broader mixture. For example, in the case where the terms are used in the context of gas processing, the terms “separating” or “separated” connote a partitioning of the gases by adsorption or by permeation based on size or physical or chemical properties, as would be understood by those skilled in the art.

In the context of CO₂ content in a gaseous source mixture, the terms “low concentration” or “low-CO₂-content” refers to embodiments where the CO₂ content of is in a range of from 100 ppm to 1000 ppm, or more preferably in an amount approximating the content of CO₂ in our atmosphere (i.e., ca. 400 ppm), but also the higher levels found in buildings. In some specific embodiments, the CO₂ content in a gaseous source mixture may range from 300 to 350 ppm, 350 to 400 ppm, 400 to 450 ppm, 450 to 500 ppm, 500 to 600 ppm, 600 to 700 ppm, 700 to 800 ppm, 800 to 900 ppm, 900 to 1000 ppm, or the CO₂ content may be defined in terms of any of the foregoing values or two or more of the foregoing ranges. The term “gaseous source mixture” or the like refers to the gas from which the CO₂ is being extracted, typically air or, in the case of testing, helium, optionally in the presence of argon present as an internal standard. The gaseous source mixture is typically present at ambient atmospheric pressure (i.e., 101 kPa) or within 10% or 20% of that pressure, though higher pressures (i.e., up to 202 kPa) may also be considered in the present context.

The term “microporous,” according to IUPAC notation refers to a material having pore diameters of less than 2 nm. Similarly, the term “macroporous” refers to materials having pore diameters of greater than 50 nm. And the term “mesoporous” refers to materials whose pore sizes are intermediate between microporous and macroporous. Within the context of the present disclosure, the material properties and applications depend on the properties of the framework such as pore size and dimensionality, cage dimensions and material composition.

“Optional” or “optionally” means that the subsequently described circumstance may or may not occur, so that the description includes instances where the circumstance occurs and instances where it does not. For example, the phrase “optionally heated” refers to both embodiments where the material is and is not heated. Similarly, the term “optionally present” refers to both embodiments where the component is and is not present. Each of these embodiments (is and is not heated or is and is not present) represents individual and independent embodiments.

As used herein, the term “crystalline microporous solids” or “crystalline microporous aluminosilicate” are crystalline structures having very regular pore structures of molecular dimensions, i.e., under 2 nm. The maximum size of the species that can enter the pores of a crystalline microporous solid is controlled by the dimensions of the openings. These materials are sometimes referred to as “molecular sieves,” having very regular pore structures of molecular dimensions, i.e., under 2 nm. The term “molecular sieve” refers to the ability of the material to selectively sort molecules based primarily on a size exclusion process. The maximum size of the species that can enter the pores of a crystalline microporous solid is controlled by the dimensions of the openings. These are conventionally defined by the ring size of the aperture, where, for example, the term “8-MR” or “8-membered ring” refers to a closed loop that is typically built from eight tetrahedrally coordinated silicon (or aluminum) atoms and 8 oxygen atoms. These rings are not necessarily symmetrical, due to a variety of effects including strain induced by the bonding between units that are needed to produce the overall structure, or coordination of some of the oxygen atoms of the rings to cations within the structure. As used herein, in the context of the invention, the term “8-MR” or 8-MR zeolite” refers only to those aluminosilicate crystalline materials, or optionally substituted derivatives, having frameworks comprising 8-membered rings as the largest ring for entrance of molecules into the intracrystalline void space. Exemplary structures can identified in Baerlocher, et al., Atlas of Zeolite Framework Types, Sixth Revised Edition (2007), this reference being incorporated by reference herein for this teaching. In the present disclosure, the terms can also refer specifically to one or more compositions having AEI, AFX, and CHA topologies or any of the other topologies cited herein.

AEI topology is a three-dimensional interconnected channel system, bound by 8-membered rings 8MRs (3.8×3.8 Å) and basket-shaped cages, which are connected by double 6-membered rings (D6Rs).

AFX topology is made up of elongated larger aft cages (0.55×1.35 nm) and smaller gme cages (0.33×0.74 nm), which each joined by D6Rs units.

CHA topology is composed of D6Rs in an AABBCC sequence. All D6Rs have the same orientation, and link to other D6Rs to give a structure that contains the cha cage. Each cha cage is linked to six others via 8MR windows.

FAU topology is built by linking sodalite (SOD) cages through D6Rs, which creates a large cavity in FAU called the “supercage” accessible by a three-dimensional 12MR pore system.

LTA topology is built by linking SOD cages through double 4-membered rings, which creates a large cavity in FAU called the “supercage” accessible by a three-dimensional 8MR pore system.

The term “metal ion-doped” is intended to confer the same meaning as “metal ion-containing” in the context of the metal ions set forth elsewhere herein.

The term “silicate” refers to any composition including silicate (or silicon oxide) within its framework. It is a general term encompassing, for example, pure-silica (i.e., absent other detectable metal oxides within the framework), aluminosilicate, borosilicate, ferrosilicate, germanosilicate, stannosilicate, titanosilicate, or zincosilicate structures. The term “aluminosilicate” refers to any composition including both silicon and aluminum oxides within its framework. The term “zeolite” refers to an aluminosilicate composition that is a member of this family. For this reason, the terms “metal ion-doped zeolitic composition(s)” and “metal ion-doped crystalline microporous aluminosilicate composition(s)” are considered equivalent and are used interchangeably herein. Such aluminosilicates may be “pure-aluminosilicates (i.e., absent other detectable metal oxides within the framework) or optionally substituted (i.e., containing other metal oxides within the lattice framework). When described as “optionally substituted,” the respective framework may contain boron, gallium, germanium, hafnium, iron, tin, titanium, indium, vanadium, zinc, zirconium, or other atoms substituted for one or more of the atoms not already contained in the parent lattice or framework.

As used herein, the term “transition metal” refers to any element in the d-block of the periodic table, which includes groups 3 to 12 on the periodic table, as well as the elements of the f-block lanthanide and actinide series. This definition of transition metals specifically encompasses Group 4 to Group 12 elements. In certain other independent embodiments, the transition metals comprises an element of Groups 6, 7, 8, 9, 10, 11, or 12. In still other independent embodiments, the transition metal comprises scandium, yttrium, titanium, zirconium, vanadium, manganese, chromium, molybdenum, tungsten, iron, ruthenium, osmium, cobalt, rhodium, iridium, nickel, palladium, platinum, copper, silver, gold, zinc, or mixtures thereof, preferably iron, cobalt, nickel, copper, silver, and zinc.

In some cases herein, the term “metal ion-doped crystalline microporous aluminosilicate compositions” are referred to as “zeolitic compositions” or “metal-doped zeolitic compositions,” and the like.

The present disclosure is directed to new compositions of matter useful for extracting carbon dioxide (CO₂) from feed streams, especially feed streams containing low levels of CO₂, including air. Such new compositions comprise transition metal-containing zeolites, including those zeolites having the framework characteristics set forth herein, including those provided in C. Baerlocher, Atlas of Zeolite Framework Types, 6th Revised Edition 2007, which is incorporated by reference for its teaching of such frameworks, and preferably those compositions where the transition metal is zinc and the zeolites have AEI, AFX, and CHA topologies. The disclosure is also directed to methods of making and using these compositions, including configurations useful for using these compositions to extract the CO₂ from gaseous feed streams.

The present invention may be understood more readily by reference to the following description taken in connection with the accompanying Figures and Examples, all of which form a part of this disclosure. It is to be understood that this invention is not limited to the specific products, methods, conditions, or parameters described or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. For example, though the some of the present disclosure comments on the placement of the transition metal (zinc) ions in the zeolitic framework, the present inventions are not constrained by the correctness or incorrectness of these comments as to the placement. Throughout this text, it is recognized that the descriptions refer to compositions and methods of making and using said compositions. That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using).

### Compositions

In some aspects, the disclosure is directed to metal ion-doped crystalline microporous aluminosilicate compositions comprising:

(a) a three-dimensional aluminosilicate framework containing α-cages with 8-MR openings that are sized to accommodate the molecular dimensions of carbon dioxide (3.3 Å);

(b) the framework further comprising d6r (or D6MR) composite building blocks having 6-membered rings that face (are part of) or connect the α-cage of the framework;

wherein the crystalline microporous aluminosilicate contains 1.2 to 8 metal ions per unit cell, wherein the ratio of metal ions to aluminum within the unit cell is from 0.33 to 0.85; and

wherein the metal ion-doped crystalline microporous aluminosilicate composition adsorbs carbon dioxide when exposed to a gaseous mixture comprising carbon dioxide.

In some embodiments, the compositions are useful for extracting CO₂ from gaseous sources, including air, that can be described in compositional or functional terms, or in a combination of compositional and functional terms. In functional terms, the compositions share an enhanced capacity to capture CO₂ from gas mixtures, including those gas mixtures themselves having low CO₂ levels, for example having CO₂ contents approximating the levels of CO₂ found in air.

The crystalline microporous aluminosilicate compositions (e.g., zeolitic compositions) described herein share at least the following compositional and structural similarities:

(1) They are described in terms of crystalline microporous aluminosilicate compositions comprising a three-dimensional framework having pores defined by 8-membered rings (i.e., 8-MR openings) that are appropriately sized for accommodating the molecular dimensions of carbon dioxide (3.3 Å). These 8-MR openings interconnect cavities that are larger than the 8-MR openings themselves, these cavities also referred to as the α-cages of the zeolites.

(2) They show a substantial increase in their ability to capture CO₂ under the test conditions when doped with metal ions, including transition metal ions, such as zinc ions, relative to their non-doped condition.

(3) The structures of the zeolites further comprise double 6-membered rings (d6r or D6MR) composite building blocks whose 6-membered rings face (are part of) the α-cage of the zeolite (e.g., AEI, AFX, and CHA).

Topologies that exhibit at least these structural characteristics (i.e., containing α-cages with interconnecting 8-MR openings with facing 6-membered rings associated with d6r building blocks) include AEI, AFT, AFX, CHA, EAB, KFI, LEV, and SAS. Other zeolites that exhibit at least these structural characteristics are considered within the scope of this disclosure, including those provided in C. Baerlocher, Atlas of Zeolite Framework Types, 6th Revised Edition 2007, which is incorporated by reference for its teaching of such frameworks. Those zeolites having AEI, AFX, and CHA topologies (or similar; with d6r building blocks facing the openings/cages that are accessible to CO₂ molecules) are shown herein to exhibit substantially increased capacities for CO₂ when appropriately doped with zinc ions.

In some embodiments, the metal ion-doped crystalline microporous aluminosilicate compositions of the disclosure are those wherein the three-dimensional aluminosilicate framework has an AEI, AFT, AFX, CHA, EAB, KFI, LEV, or SAS topology.

In other embodiments, the metal ion-doped crystalline microporous aluminosilicate compositions of the disclosure are those wherein the three-dimensional aluminosilicate framework has AEI, AFX, or CHA topology.

In other embodiments, the metal ion-doped crystalline microporous aluminosilicate compositions of the disclosure are those wherein the three-dimensional aluminosilicate framework has AEI topology.

In other embodiments, the metal ion-doped crystalline microporous aluminosilicate compositions of the disclosure are those wherein the three-dimensional aluminosilicate framework has AFX topology.

In other embodiments, the metal ion-doped crystalline microporous aluminosilicate compositions of the disclosure are those wherein the three-dimensional aluminosilicate framework has CHA topology.

In some embodiments in which the metal ion-doped crystalline microporous aluminosilicate compositions of the disclosure has CHA topology, the CHA topology is synthetic CHA. As used herein, “synthetic CHA” refers to CHA that has a Si/Al ration that may be greater than or less than 4. CHA with an Si/Al>4 has the tradename SSZ-13. (Zones, S.I. U.S. Pat. No. 4,544,538A).

Other zeolites comprising sodalite (sod) building blocks, which do not have d6r building blocks or have d6r building blocks that do not face the α-cage do not exhibit the enhanced CO₂ absorption with zinc-doping (considered representative of other transition metal-doping). Indeed, and by sharp contrast, zinc-doping is shown herein to substantially inhibit the ability of these LTA zeolites to adsorb CO₂. For example, zeolites of EMT and FAU topology have 12-MR openings and both d6r and sod building blocks. These frameworks comprise 6-membered rings in their 12-MR α-cages, but these 6-membered rings are associated only with the sod, but not the d6r, building blocks, and these zeolites not only fail to respond to zinc doping with enhanced CO₂ absorption, but instead exhibit substantially reduced CO₂ absorption with zinc-doping. Zeolites with the LTA topology do not have d6r building blocks also fail to respond to zinc doping with enhanced CO₂ absorption, and exhibit substantially reduced CO₂ absorption with zinc-doping.

The ability of the crystalline microporous aluminosilicate (zeolitic) compositions that react positively to metal doping (i.e., that exhibit this enhanced CO₂ capacity) is shown to depend both on the Si:Al ratios of the zeolites and the transition metal ion (e.g., zinc ion) content in the zeolite.

In some embodiments, the metal ion-doped crystalline microporous aluminosilicate compositions of the disclosure have a Si:Al atomic ratio in a range of from 1:1 to 20:1.

In other embodiments, the metal ion-doped crystalline microporous aluminosilicate compositions of the disclosure have a Si:Al atomic ratio in a range of from 2:1 to 8.5:1, or from 2:1 to 7.5:1, or from 5.5:1 to 8.5:1, or from 6.5:1 to 7.5:1, or from 7.5:1 to 8.5:1.

In other embodiments, the metal ion-doped crystalline microporous aluminosilicate compositions of the disclosure have a Si:Al atomic ratio in a range of from 5.5:1 to 8.5:1, or from 6.5:1 to 7.5:1, or from 7.5:1 to 8.5:1.

In other embodiments, the metal ion-doped crystalline microporous aluminosilicate compositions of the disclosure have a Si:Al atomic ratio in a range of from 2:1 to 8.5:1.

In other embodiments, the metal ion-doped crystalline microporous aluminosilicate compositions of the disclosure have a Si:Al atomic ratio in a range of from 2:1 to 7.5:1.

In other embodiments, the metal ion-doped crystalline microporous aluminosilicate compositions of the disclosure have a Si:Al atomic ratio in a range of from 2:1 to 6:1.

In other embodiments, the metal ion-doped crystalline microporous aluminosilicate compositions of the disclosure have a Si:Al atomic ratio in a range of from 2:1 to 4:1.

In other embodiments, the metal ion-doped crystalline microporous aluminosilicate compositions of the disclosure have a Si:Al atomic ratio in a range of from 5.5:1 to 8.5:1.

In other embodiments, the metal ion-doped crystalline microporous aluminosilicate compositions of the disclosure have a Si:Al atomic ratio in a range of from 6.5:1 to 7.5:1.

In other embodiments, the metal ion-doped crystalline microporous aluminosilicate compositions of the disclosure have a Si:Al atomic ratio in a range of from 7.5:1 to 8.5:1.

Si:Al ratios in a range of from 5.5:1 to 8.5:1 work well, or from 6.5:1 to 7.5:1, or about 7:1 especially in the presence of zinc ions. But even zeolitic compositions containing lower Si:Al ratios (i.e., having Si:Al ratios as low as about 2:1 or about 4:1—e.g., having a range of from 2:1 to 8.5:1) if prepared in such a way as to ensure pore volumes comparable to their higher Si:Al ratio analogues (e.g., in a range of from 0.15 to 0.25 or about 0.2 cm³/g), such as otherwise set forth herein.

More generally, in certain embodiments, the zeolitic compositions have an Si:Al atomic ratio of about 1:1 or in a range of from 1:1 to 1.5:1, from 1.5:1 to 2:1, from 2:1 to 2.5:1, from 2.5:1 to 3:1, from 3:1 to 3.5:1, from 3.5:1 to 4:1, from 4:1 to 4.5:1, from 4.5:1 to 5:1, 5:1 to 5.5:1, from 5.5:1 to 6:1, from 6:1 to 6.5:1, from 6.5:1 to 7:1, 7:1 to 7.5:1, from 7.5:1 to 8:1, from 8:1 to 8.5:1, from 8.5:1 to 9:1, 9:1 to 9.5:1, from 9.5:1 to 10:1, from 10:1 to 11:1, from 11:1 to 12:1, 12:1 to 13:1, from 13:1 to 14:1, from 14:1 to 15:1, from 15:1 to 20:1, or a range defined by the combination of two or more of the foregoing ranges, for example from 1.5:1 to 3:1, 2:1 to 4:1, about 2:1, about 3:1, about 4:1, from 4:1 to 8:1, from 8:1 to 12:1, from 5.5:1 to 8.5:1, about 5:1, about 6:1, about 7:1, about 8:1, or from 1.5:1 to 8.5:1.

In certain embodiments, the aluminosilicate framework may be substituted with one or more of boron oxide, cerium oxide, gallium oxide, germanium oxide, hafnium oxide, iron oxide, tin oxide, titanium oxide, indium oxide, vanadium oxide, or zirconium oxide.

In some aspects, the metal ion-doped crystalline microporous aluminosilicate compositions of the disclosure contain at least one metal ion, present in a range of from 0.1 to 0.5 metal ion per unit cell, from 0.5 to 1 metal ion per unit cell, from 1 to 1 to 1.25 metal ions per unit cell, from 1.25 to 1.5 metal ions per unit cell, from 1.5 to 1.75 metal ions per unit cell, from 1.75 to 2 metal ions per unit cell, from 2 to 2.25 metal ions per unit cell, from 2.25 to 2.5 metal ions per unit cell, from 2.5 to 2.75 metal ions per unit cell, from 2.75 to 3 metal ions per unit cell, from 3 to 3.25 metal ions per unit cell, from 3.25 to 3.5 metal ions per unit cell, from 3.5 to 3.75 metal ions per unit cell, from 3.75 to 4 metal ions per unit cell, from 4 to 4.25 metal ions per unit cell, from 4.25 to 4.5 metal ions per unit cell, from 4.5 to 4.75 metal ions per unit cell, from 4.75 to 5 metal ions per unit cell, from 5 to 5.25 metal ions per unit cell, from 5.25 to 5.5 metal ions per unit cell, from 5.5 to 5.75 metal ions per unit cell, from 5.75 to 6 metal ions per unit cell, from 6 to 6.5 metal ions per unit cell, from 6.5 to 7 metal ions per unit cell, from 7 to 7.5 metal ions per unit cell, from 7.5 to 8 metal ions per unit cell, or a range defined by two or more of the foregoing ranges, for example, from 1.5 to 4 metal ions per unit cell. Loadings of about 2.25 to 3 metal ions per unit cell (e.g., about 2.5 atoms per unit cell of CHA-7) or 7 to 8 metal ions per unit cell (e.g., about 7.5 atoms per unit cell of CHA-2) appears especially attractive. Metal ion content is conveniently determined by EDS.

In some embodiments, the metal ion-doped crystalline microporous aluminosilicate compositions of the disclosure contain 1.2 to 8 metal ions per unit cell.

In other embodiments, the metal ion-doped crystalline microporous aluminosilicate compositions of the disclosure contain 1.2 to 4 metal ions per unit cell.

In other embodiments, the metal ion-doped crystalline microporous aluminosilicate compositions of the disclosure contain 1.21 to 2.6 metal ions per unit cell.

In other embodiments, the metal ion-doped crystalline microporous aluminosilicate compositions of the disclosure contain 1.5 to 4 metal ions per unit cell.

In other embodiments, the metal ion-doped crystalline microporous aluminosilicate compositions of the disclosure contain 1.2 to 3 metal ions per unit cell.

In other embodiments, the metal ion-doped crystalline microporous aluminosilicate compositions of the disclosure contain 1.2 to 3 metal ions per unit cell.

In other embodiments, the metal ion-doped crystalline microporous aluminosilicate compositions of the disclosure contain 2.25 to 3 metal ions per unit cell.

In some embodiments, the metal ion-doped crystalline microporous aluminosilicate compositions of the disclosure contain 4 to 8 metal ions per unit cell.

In some embodiments, the metal ion-doped crystalline microporous aluminosilicate compositions of the disclosure contain 6 to 8 metal ions per unit cell.

In some embodiments, the metal ion-doped crystalline microporous aluminosilicate compositions of the disclosure contain 7 to 8 metal ions per unit cell.

In some embodiments, the metal ion is a transition metal ion.

In some embodiments, the metal ion in the metal ion-doped crystalline microporous aluminosilicate compositions of the disclosure comprises zirconium, iron, cobalt, nickel, copper, zinc, or silver.

In other embodiments, the metal ion in the metal ion-doped crystalline microporous aluminosilicate compositions of the disclosure comprises iron, cobalt, nickel, copper, zinc, or silver.

In some embodiments, the metal ion in the metal ion-doped crystalline microporous aluminosilicate compositions of the disclosure comprises zinc.

In some embodiments, the zeolitic compositions (crystalline microporous aluminosilicate compositions) of the disclosure contain at least one transition metal ion, present in a range of from 0.1 to 0.5 transition metal ion per unit cell, from 0.5 to 1 transition metal ion per unit cell, from 1 to 1 to 1.25 transition metal ions per unit cell, from 1.25 to 1.5 transition metal ions per unit cell, from 1.5 to 1.75 transition metal ions per unit cell, from 1.75 to 2 transition metal ions per unit cell, from 2 to 2.25 transition metal ions per unit cell, from 2.25 to 2.5 transition metal ions per unit cell, from 2.5 to 2.75 transition metal ions per unit cell, from 2.75 to 3 transition metal ions per unit cell, from 3 to 3.25 transition metal ions per unit cell, from 3.25 to 3.5 transition metal ions per unit cell, from 3.5 to 3.75 transition metal ions per unit cell, from 3.75 to 4 transition metal ions per unit cell, from 4 to 4.25 transition metal ions per unit cell, from 4.25 to 4.5 transition metal ions per unit cell, from 4.5 to 4.75 transition metal ions per unit cell, from 4.75 to 5 transition metal ions per unit cell, from 5 to 5.25 transition metal ions per unit cell, from 5.25 to 5.5 transition metal ions per unit cell, from 5.5 to 5.75 transition metal ions per unit cell, from 5.75 to 6 transition metal ions per unit cell, from 6 to 6.5 transition metal ions per unit cell, from 6.5 to 7 transition metal ions per unit cell, from 7 to 7.5 transition metal ions per unit cell, from 7.5 to 8 transition metal ions per unit cell, or a range defined by two or more of the foregoing ranges, for example, from 1.5 to 4 transition metal ions per unit cell. Loadings of about 2.25 to 3 transition metal ions per unit cell (e.g., about 2.5 transition atoms per unit cell of CHA-7) appears especially attractive. Metal ion content is conveniently determined by EDS.

In some embodiments, the crystalline microporous aluminosilicate compositions of the disclosure contain 1.2 to 8 transition metal ions per unit cell.

In other embodiments, the crystalline microporous aluminosilicate compositions of the disclosure contain 1.2 to 4 transition metal ions per unit cell.

In other embodiments, the crystalline microporous aluminosilicate compositions of the disclosure contain 1.2 to 3 transition metal ions per unit cell.

In other embodiments, the crystalline microporous aluminosilicate compositions of the disclosure contain 1.21 to 2.6 transition metal ions per unit cell.

In other embodiments, the crystalline microporous aluminosilicate compositions of the disclosure contain 1.5 to 4 transition metal ions per unit cell.

In other embodiments, the crystalline microporous aluminosilicate compositions of the disclosure contain 2.25 to 3 transition metal ions per unit cell.

In some embodiments, the crystalline microporous aluminosilicate compositions of the disclosure contain 4 to 8 transition metal ions per unit cell.

In some embodiments, the crystalline microporous aluminosilicate compositions of the disclosure contain 6 to 8 transition metal ions per unit cell.

In some embodiments, the crystalline microporous aluminosilicate compositions of the disclosure contain 7 to 8 transition metal ions per unit cell.

In some aspects, the crystalline microporous aluminosilicate compositions of the disclosure transition are characterized by the metal ions per Al and these are considered independent embodiments. These ratios can be determined experimentally or, to a good approximation by using the number of atoms in the unit cell in combination with the Si:Al ratios of the underlying zeolite. These ratio ranges, as determined by comparing the metal ions per unit cell and the Si/Al atoms in the corresponding unit cell, represent additional or alternative embodiments. For example, a pure CHA7 aluminosilicate unit cell framework containing 2.5 Zn ions per unit cell (a CHA unit cell framework nominally has 36 atoms of Si and Al) and having an Si:Al ratio of 7:1 contains 36/8 or 4.5 Al atoms per unit cell, corresponding to about 0.56 Zn atoms/Al atoms. A range of 2.25 to 3 metal ions per CHA7 unit cell would correlate to 0.5 to 0.67 Zn atoms/Al atoms. A pure CHA2 aluminosilicate unit cell framework containing 7.5 Zn ions per unit cell (a CHA unit cell framework nominally has 36 atoms of Si and Al) and having an Si:Al ratio of 2:1 contains 36/3 or 12 Al atoms per unit cell, corresponding to about 0.63 Zn atoms/Al atoms. A range of 7 to 8 metal ions per CHA2 unit cell would correlate to 0.58 to 0.67 Zn atoms/Al atoms.

In some embodiments, the crystalline microporous aluminosilicate compositions of the disclosure are characterized by the transition metal ions per Al and these are considered independent embodiments. These ratios can be determined experimentally or, to a good approximation by using the number of atoms in the unit cell in combination with the Si:Al ratios of the underlying zeolite. These ratio ranges, as determined by comparing the transition metal ions per unit cell and the Si/Al atoms in the corresponding unit cell, represent additional or alternative embodiments. For example, a pure SSZ-13-7 aluminosilicate unit cell framework containing 2.5 Zn ions per unit cell (a CHA unit cell framework nominally has 36 atoms of Si and Al) and having an Si:Al ratio of 7:1 contains 36/8 or 4.5 Al atoms per unit cell, corresponding to about 0.56 Zn atoms/Al atoms. A range of 2.25 to 3 transition metal ions per SSZ-13-7 unit cell would correlate to 0.5 to 0.67 Zn atoms/Al atoms.

In some embodiments, the metal ion-doped crystalline microporous aluminosilicate compositions of the disclosure have a ratio of metal ions to aluminum within the unit cell is from 0.34 to 0.58, such as, for example, a ratio of metal ions to aluminum within the unit cell that is 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, or 0.58.

In other embodiments the metal ion-doped crystalline microporous aluminosilicate compositions of the disclosure have a ratio of metal ions to aluminum within the unit cell is from 0.59 to 0.85, such as, for example, a ratio of metal ions to aluminum within the unit cell that is 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, or 0.85.

Additionally or alternatively, the zeolitic compositions contain one or more ions of strontium, magnesium, calcium, indium, or barium in a range of from 0.5 to 1 ions per unit cell, from 1 to 1 to 1.25 ions per unit cell, from 1.25 to 1.5 ions per unit cell, from 1.5 to 1.75 ions per unit cell, from 1.75 to 2 ions per unit cell, from 2 to 2.25 ions per unit cell, from 2.25 to 2.5 ions per unit cell, from 2.5 to 2.75 ions per unit cell, from 2.75 to 3 ions per unit cell, from 3 to 3.25 ions per unit cell, from 3.25 to 3.5 ions per unit cell, from 3.5 to 3.75 ions per unit cell, from 3.75 to 4 ions per unit cell, from 4 to 4.25 ions per unit cell, from 4.25 to 4.5 ions per unit cell, from 4.5 to 4.75 ions per unit cell, from 4.75 to 5 ions per unit cell, from 5 to 5.25 ions per unit cell, from 5.25 to 5.5 ions per unit cell, from 5.5 to 5.75 ions per unit cell, from 5.75 to 6 ions per unit cell, or a range defined by two or more of the foregoing ranges, for example, from 2.25 to 3 ions per unit cell, or from 1.5 to 4 ions per unit cell.

Additionally or alternatively, the ion content of the zeolitic compositions may be defined in terms of the corresponding ion content per gram or unit volume of the corresponding zeolite.

Additionally or alternatively, in certain embodiments, the zeolitic compositions are defined in terms of their carbon dioxide content or carbon dioxide capacity.

In some embodiments, the content or capacity of carbon dioxide in the zeolitic compositions are defined in terms of molecules of CO₂ per unit cell. In certain of these embodiments, the carbon dioxide content or carbon dioxide capacity of the ion-doped (preferably zinc-doped) zeolitic compositions are in a range of from 0.5 to 0.55, from 0.55 to 0.6, from 0.6 to 0.65, from 0.65 to 0.7, from 0.7 to 0.75, from 0.75 to 0.8, from 0.8 to 0.85, from 0.85 to 0.9, from 0.95 to 1.0, from 1.0 to 1.05, from 1.05 to 1.1, from 1.1 to 1.15, from 1.15 to 1.2, from 1.2 to 1.25, from 1.25 to 1.3, from 1.3 to 1.7 molecules adsorbed CO₂ per unit cell of the doped zeolite, when the doped zeolite is exposed to a gas source having a total pressure in a range of from 50 kPa to 75 kPa, from 75 kPa to 100 kPa, from 100 kPa to 125 kPa, from 125 kPa to 150 kPa, or a range defined by two or more of the foregoing ranges, and having a CO₂ content in a range of from 350 to 375 ppm, from 375 to 400 ppm, from 400 ppm to 425 ppm, or a range defined by two or more of the foregoing ranges.

In other embodiments, the metal ion-doped crystalline microporous aluminosilicate compositions of the disclosure contain, or have the capacity to contain, carbon dioxide in a range of from 0.3 to 1.7 molecules adsorbed CO₂ per unit cell; or in a range of from 0.4 to 0.6 molecules adsorbed CO₂ per unit cell; or in a range of from 0.6 to 1.25 molecules adsorbed CO₂ per unit cell; or in a range of from 1.26 to 1.7 molecules adsorbed CO₂ per unit cell.

In some embodiments, the metal ion-doped crystalline microporous aluminosilicate compositions of the disclosure are those wherein exposure of the crystalline microporous aluminosilicate composition to a gas source having (a) a total pressure in a range of from 50 kPa to 125 kPa, such as, for example, a total pressure in a range of from 50 kPa to 75 kPa, or from 75 kPa to 100 kPa, or from 100 kPa to 125 kPa, or from 125 kPa to 150 kPa, and (b) a CO₂ content in a range of from 350 to 425 ppm, such as, for example, 350 to 375 ppm, or from 375 to 400 ppm, or from 400 ppm to 425 ppm, results in adsorption of carbon dioxide in a range of from 0.3 to 1.7 molecules adsorbed CO₂ per unit cell, such as, for example, from 0.4 to 6 molecules adsorbed CO₂ per unit cell, from 0.6 to 1.25 molecules adsorbed CO₂ per unit cell, or from 1.25 to 1.7 molecules adsorbed CO₂ per unit cell.

In other embodiments, the content of carbon dioxide in the zeolitic compositions are defined in terms of millimoles of CO₂ per gram of zeolite. In certain of these embodiments, the carbon dioxide content or carbon dioxide capacity of the metal ion-doped (preferably zinc ion-doped) zeolitic compositions of the disclosure are in a range of from 0.25 to 0.3, from 0.3 to 0.35, from 0.35 to 0.4, from 0.4 to 0.45, from 0.45 to 0.5, from 0.5 to 0.55, from 0.55 to 0.6, from 0.6 to 0.65, from 0.65 to 0.7 mmol adsorbed CO₂ per gram doped zeolite, or a range defined by two or more of the foregoing ranges, when the metal ion-doped zeolite is exposed to a gas source having a total pressure in a range of from 50 kPa to 75 kPa, from 75 kPa to 100 kPa, from 100 kPa to 125 kPa, from 125 kPa to 150 kPa, or a range defined by two or more of the foregoing ranges, and having a CO₂ content in a range of from 350 to 375 ppm, from 375 to 400 ppm, from 400 ppm to 425 ppm, from 425 ppm to 450 ppm, from 450 ppm to 500 ppm, from 500 ppm to 1000 ppm, or a range defined by two or more of the foregoing ranges.

In some embodiments, the metal ion-doped crystalline microporous aluminosilicate composition of the disclosure are those wherein exposure of the metal ion-doped crystalline microporous aluminosilicate composition to a gas source having (a) a total pressure in a range of from 50 kPa to 125 kPa, such as, for example, from 50 kPa to 75 kPa, from 75 kPa to 100 kPa, from 100 kPa to 125 kPa, from 125 kPa to 150 kPa, or about 100 kPa; and (b) a CO₂ content in a range of from 350 to 425 ppm, such as, for example, from 350 to 375 ppm, from 375 to 400 ppm, from 400 ppm to 425 ppm, or about 400 ppm; results in adsorption of carbon dioxide in a range of from 0.2 to 0.7 mmols, such as, for example, from 0.2 to 0.5 mmol, from 0.3 to 0.7 mmol, or from 0.5 to 0.7 mmol, adsorbed CO₂ per gram of metal ion-doped crystalline microporous aluminosilicate composition.

In some embodiments, the metal ion-doped crystalline microporous aluminosilicate composition of the disclosure are those wherein passage of a gas having (a) a total pressure in a range of from 50 kPa to 125 kPa, and (b) a CO₂ content in a range of from 350 to 425 ppm, through a tube containing a fixed bed of the metal ion-doped crystalline microporous aluminosilicate composition, results in complete breakthrough of CO₂ after adsorption of 0.2-0.7 mmol, such as, for example, such as, for example, from 0.2 to 0.5 mmol, from 0.3 to 0.7 mmol, or from 0.5 to 0.7 mmol of CO₂ per gram of metal ion-doped crystalline microporous aluminosilicate composition. In some embodiments, the gas source is 400 ppm CO₂/400 ppm Ar balanced by He at a flow rate of 20 mL·min⁻¹ at 30° C. In other embodiments, the gas source is 400 ppm CO₂/1% Ar/20% O₂/N₂, at a flow rate of 14 mL·min⁻¹ at 30° C.

As used herein, “complete breakthrough (or saturation)” refers to the condition at which the CO₂ concentration in the gas entering the fixed bed of the metal ion-doped crystalline microporous aluminosilicate composition is the same as the CO₂ concentration in the gas exiting the fixed bed.

In other embodiments, the metal ion-doped crystalline microporous aluminosilicate composition of the disclosure are those wherein passage of a gas having (a) a total pressure in a range of from 50 kPa to 125 kPa, and (b) a CO₂ content in a range of from 350 to 425 ppm, through a tube containing a fixed bed of the metal ion-doped crystalline microporous aluminosilicate composition, results in complete breakthrough of CO₂ after adsorption of an amount of CO₂ (on a mmol/g basis) that is 1.4-1.6 times greater than the amount of CO₂ adsorbed by an equal weight of zeolite 13X before complete breakthrough of CO₂ occurs under the same conditions. In some embodiments, the gas source is 400 ppm CO₂/400 ppm Ar balanced by He at a flow rate of 20 mL·min⁻¹ at 30° C. In other embodiments, the gas source is 400 ppm CO₂/1% Ar/20% O₂/N₂, at a flow rate of 14 mL·min⁻¹ at 30° C.

Additionally or alternatively, the content or capacity of the metal ion-doped zeolitic compositions are defined in terms of the amount of carbon dioxide adsorbed or adsorbable when subjected to a gas source having a given partial pressure of CO₂ at a given ambient temperature. In exemplary embodiments, a zeolitic compositions containing or having the capacity to adsorb 0.4 mmol CO₂ per gram of ion-doped zeolite at 30° C. (303K) from an gas at one atmosphere (101 kPa) containing 400 ppm CO₂ (4×0.0001×101 kPa) has a content or capacity corresponding to a partitioning of 10 mmol adsorbed CO₂ per gram zeolite per kPa CO₂ source at 303K. The foregoing CO₂ contents/capacities at the pressures indicated (50 kPa to 150 kPa, including sub-ranges therein, with CO₂ contents in a range of from 350 to 1000 ppm, and sub-ranges therein) can be viewed also in these ratio terms.

Additionally or alternatively, in separate independent embodiments, the metal ion doped zeolitic compositions can be or are defined in their ability to desorb CO₂. In certain of these embodiments, the metal ion doped zeolitic compositions containing CO₂ desorb their CO₂ at temperatures less than 130° C., less than 125° C., less than 120° C., less than 115° C., less than 110° C., or less than 100° C.

In some embodiments, the metal ion-doped crystalline microporous aluminosilicate compositions of the disclosure are those wherein adsorbed CO₂ is completed desorbed at a temperature that is lower than the temperature required to completely desorb CO₂ from zeolite 13X under the otherwise same conditions.

In some embodiments, the metal ion-doped crystalline microporous aluminosilicate compositions of the disclosure are those wherein the metal ion-doped crystalline microporous aluminosilicate composition has a selectivity for CO₂ over N₂ of at least 800:1.

As used herein, selectivity for CO₂ over N₂ is the ratio of CO₂ to N₂ divided by the ratio of their partial pressures or volume fractions in the streams, i.e., (Q_{CO2}/Q_{N2})/(F_{CO2}/F_{N2}) where Q_{CO2} is CO₂ uptake, F_{CO2} is the CO₂ fraction, Q_{N2} is N₂ uptake, F_{N2} is the N₂ fraction.

In some embodiments, the metal ion-doped crystalline microporous aluminosilicate compositions of the disclosure are those wherein the metal ion-doped crystalline microporous aluminosilicate composition has a selectivity for CO₂ over N₂ of at least 900:1.

Additionally or alternatively, in separate independent embodiments, the metal ion doped zeolitic compositions adsorb less water than do their corresponding pristine (i.e., containing no metal ion dopants) zeolites. In some embodiments, the metal ion doped zeolitic compositions adsorb less than 15 wt %, less than 10 wt %, or less than 5 wt % water, relative to the weight of the anhydrous metal ion doped zeolitic compositions

Additionally or alternatively, in separate independent embodiments, the metal ion doped zeolitic compositions can be or are defined in their ability to desorb occluded water. In certain of these embodiments, the metal ion doped zeolitic compositions containing water desorb water at temperatures less than 250° C., less than 225° C., less than 200° C., less than 175° C., or less than 150° C.

This combination of high CO₂ absorptions, facile CO₂ desorptions, low hydrophilicity, and facile water desorption at mild temperatures provides good recyclability (upwards of 10 absorption/desorption cycles at ambient atmospheric pressure) of these materials for CO₂ capture applications.

Every combination of the foregoing descriptions of topology, Si:Al ratio, metal ion and metal ion content, CO₂ content or capacity, and CO₂ or water absorption or desorption characteristics are considered separate and independent embodiments, as if separately explicitly defined and enumerated as such. That is, the metal ion-doped crystalline microporous aluminosilicate composition can be independently defined with respect to any of the prescribed topologies, Si:Al ratios, metals, metal loadings and/or CO₂/water contents set forth elsewhere herein. For example, the compositions may be described in terms of a metal ion-doped crystalline microporous aluminosilicate composition comprising:

(a) a three-dimensionally aluminosilicate framework having α-cages interconnected by 8-MR openings that are appropriately sized for accommodating the molecular dimensions of carbon dioxide (3.3 Å);

(b) the framework further comprising d6r (or D6MR) composite building blocks having 6-membered rings that face (are part of) the α-cage of the framework; wherein the metal ion-doped crystalline microporous aluminosilicate composition is characterized by one or more of the following features:

(c) wherein the framework is a AEI, AFT, AFX, CHA, EAB, KFI, LEV, or SAS topology, preferably a AEI, AFX, and CHA topology;

(d) optionally wherein the aluminosilicate has an Si:Al ratio in a range of from 1:1 to 8.5:1, from 1.5:1 to 2.5:1, about 2:1, from 5.5:1 to 8.5:1, or from 6.5:1 to 7.5:1, or about 7:1, or any one of the values, ranges, or sub-ranges elsewhere set forth herein;

(e) wherein the crystalline microporous aluminosilicate contains metal ions, preferably transition metal ions, more preferably zinc ions;

(f) optionally wherein the composition contains from 1.5 to 4 transition metal ions per unit cell, or from about 2.25 to 3 transition metal ions per unit cell;

(g) wherein the metal ion-doped crystalline microporous aluminosilicate composition exhibits an increased capacity for CO₂ relative to the metal-free crystalline microporous aluminosilicate composition when subjected to a low-CO₂-content gaseous source mixtures, for example air.

(h) optionally wherein the carbon dioxide adsorbed by metal ion-doped crystalline microporous aluminosilicate composition desorbs at a temperature of less than 130° C., less than 125° C., less than 120° C., less than 115° C., less than 110° C., or less than 100° C.; and/or

(i) optionally wherein any water adsorbed by metal ion-doped crystalline microporous aluminosilicate composition desorbs at a temperature of less than 250° C., less than 225° C., less than 200° C., less than 175° C., or less than 150° C.

Further, any of the materials or combinations of materials or steps set forth in the Examples are also considered independent embodiments of the present disclosure.

### Methods of Preparing the Inventive Compositions

The zeolitic frameworks can be prepared by methods known in the art (including, e.g., U.S. Pat. Nos. 3,140,249; 3,140,251; and 3,140,253), some of which are set forth herein.

These zeolitic frameworks can be further modified, for example, by incorporating metal ions (also referred to herein as dopants), such as set forth above, in the frameworks by methods also known in the art, such as are described herein. Acetates, halides (e.g., chlorides), and nitrates are preferred sources of these doping metals. Acetate salts (or salts of other carboxylic acids) appear to be preferred; for example, zinc acetate (or other organic acid) appears to be a preferred source of zinc.

As set forth in the Examples, different metal loadings can be achieved by washing the precursor zeolite (either pristine—no added metal—or previously loaded with metals) with aqueous solutions of specific concentrations of the metal salt(s). The aqueous salt solutions may comprise a single metal cation or multiple metal cations. The pH of the aqueous salt solution may be controlled, for example using dilute strong acid, dilute strong base, or buffer, or may be left uncontrolled. After exposure to the aqueous salt solution, the metal ion containing zeolite may be optionally rinsed with a second salt solution and/or one or more rinses of water, preferably distilled water, before drying and/or calcining the metal ion containing zeolite to remove occluded water.

In some aspects, the disclosure is directed to methods of preparing a metal ion-doped crystalline microporous aluminosilicate composition, the method comprising contacting a calcined precursor crystalline microporous aluminosilicate with an aqueous solution of a salt of the metal ion, and optionally rinsing the resulting metal ion-doped crystalline microporous aluminosilicate with water and/or optionally drying the metal ion-doped crystalline microporous aluminosilicate.

In some embodiments, the calcined precursor crystalline microporous aluminosilicate has an AEI, AFX, or CHA topology.

In other embodiments, the calcined precursor crystalline microporous aluminosilicate has an AEI topology. In other embodiments, the calcined precursor crystalline microporous aluminosilicate having an AEI topology is SSZ-39.

In some embodiments, the calcined precursor crystalline microporous aluminosilicate has an AFX topology. In other embodiments, the calcined precursor crystalline microporous aluminosilicate having an AFX topology is SSZ-16.

In some embodiments, the calcined precursor crystalline microporous aluminosilicate has a CHA topology. In other embodiments, the calcined precursor crystalline microporous aluminosilicate having a CHA topology is SSZ-13. In yet other embodiments, the calcined precursor crystalline microporous aluminosilicate having an CHA topology is synthetic CHA.

In some embodiments of the methods of preparing a metal ion-doped crystalline microporous aluminosilicate composition, the metal ion in the aqueous solution of a salt of the metal ion is one or more of Zn(OAc)₂, ZnCl₂, Zn(NO₃)₂, ZnSO₄, or ZnBr₂.

In some embodiments of the methods of preparing a metal ion-doped crystalline microporous aluminosilicate composition, the metal ion in the aqueous solution of a salt of the metal ion is Zn²⁺.

### Uses of the Inventive Compositions

The metal ion-doped zeolitic compositions as disclosed herein are described as useful in extracting CO₂ from gaseous source mixtures or to otherwise separate gases. For example, these can be used to separate water and carbon dioxide from fluid streams, such as from air. Typically, the molecular sieve is used as a component in a membrane that is used to separate the gases. Examples of such membranes are disclosed in U.S. Pat. No. 6,508,860.

For each of the preceding processes described, additional corresponding embodiments include those comprising a device or system comprising or containing the materials described for each process. For example, in the gas of the gas trapping, additional embodiments include those devices known in the art as direct air capture devices In such devices, carbon dioxide is captured and stored until subject to conditions for desorption. The devices may also comprise membranes comprising the metal ion-doped zeolitic compositions useful in the processes described.

In certain embodiments, the metal ion-doped compositions may be present and/or used in a fixed bed arrangement, either suitable for its intended purpose by itself or with another material. For example, in some embodiments, the metal ion-doped compositions may be suitable for use in extracting CO₂ from the atmosphere without the need for additional desiccant material(s). In such cases, the metal ion-doped compositions may be present in a fixed bed or other suitable arrangement that allows a gaseous source mixture to pass through, over, or otherwise around these compositions. The metal ion-doped compositions may be present or used in the absence of a separate desiccant material, whether the separate desiccant material is present upstream (optionally proximate to, for example in a tandem fixed bed arrangement) or intermingled with the configured metal ion-doped compositions set forth herein. In other embodiments, the metal ion-doped compositions may be present or used with a separate desiccant material, either in a tandem bed (or functionally equivalent) arrangement or intermingled together. When present or used with a separate desiccant material, for example in a tandem or dual bed arrangement, the materials are configured to allow a gaseous source mixture to pass through the desiccant before passing through the metal ion-doped compositions set forth herein.

In either case, the metal ion-doped zeolitic compositions may be configured in such a way as to allow a gaseous source mixture to pass through, over, or otherwise around these compositions.

In some aspects, the disclosure is directed to methods of capturing carbon dioxide from a gaseous source mixture, the method comprising contacting the gaseous source mixture with a metal ion-doped crystalline microporous aluminosilicate of the disclosure such that carbon dioxide in the gaseous source mixture is adsorbed by the metal ion-doped crystalline microporous aluminosilicate.

In some embodiments, the methods of the disclosure further comprise desorbing the carbon dioxide from the carbon-dioxide laden metal ion-doped crystalline microporous aluminosilicate.

In some embodiments, contacting the metal ion-doped crystalline microporous aluminosilicate with the gaseous source mixture is done in the absence of, or without the use of, an added desiccant.

In other embodiments, contacting the metal ion-doped crystalline microporous aluminosilicate with the gaseous source mixture is done in the presence of, or with the use of, an added desiccant.

In some embodiments, contacting the gaseous source mixture with the metal ion-doped crystalline microporous aluminosilicate comprises passing the gaseous source mixture through a fixed-bed of adsorbent comprising the metal ion-doped crystalline microporous aluminosilicate.

In some embodiments, contacting the gaseous source mixture with the metal ion-doped crystalline microporous aluminosilicate occurs at a temperature of less than 50° C., such as, for example, a temperature of less than 45° C., a temperature of less than 40° C., a temperature of less than 35° C., a temperature of less than 30° C., a temperature of less than 25° C., a temperature of less than 20° C., or a temperature of less than 15° C.

In some embodiments, desorbing the carbon dioxide from the carbon-dioxide laden metal ion-doped crystalline microporous aluminosilicate occurs at a temperature less than 130° C., such as for example, a temperature less than 125° C., a temperature less than 120° C., a temperature less than 115° C., a temperature less than 110° C., or a temperature less than 100° C.

In some embodiments, the gaseous source mixture comprises water.

In some embodiments, the methods of the disclosure further comprise desorbing water from the metal ion-doped crystalline microporous aluminosilicate at a temperature less than 250° C., such as, for example, a temperature less than 225° C., a temperature less than 200° C., a temperature less than 175° C., or a temperature less than 150° C.

### EXAMPLES

While each Example is considered to provide specific individual embodiments of composition, methods of preparation and use, these teachings should be considered representative of the more general disclosure; i.e., none of the Examples should be considered to limit the more general embodiments described herein.

In the following examples, efforts have been made to ensure accuracy with respect to numbers used (e.g. amounts, temperature, etc.) but some experimental error and deviation should be accounted for. Unless indicated otherwise, temperature is in degrees C., pressure is at or near atmospheric.

SSZ-13 is a “high-silica composition” with Si/Al>4, and described in Zones, S.I. U.S. Pat. No. 4,544,538, 1985. Reference to this material defines embodiments both specific to this material and representative of the CHA and other topologies set forth herein.

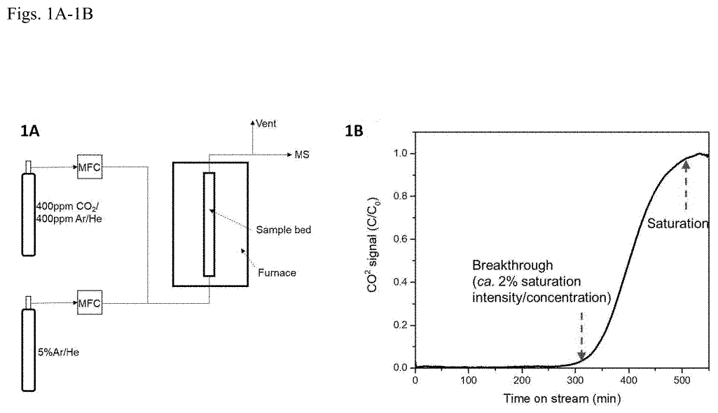

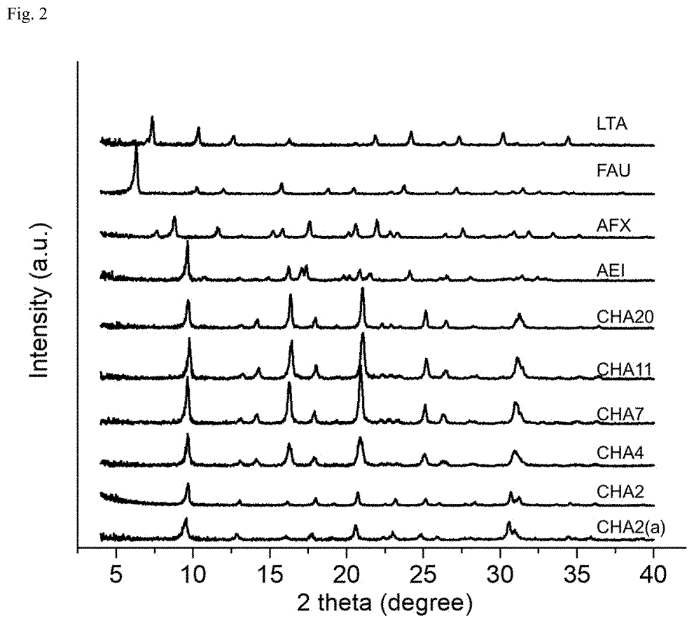

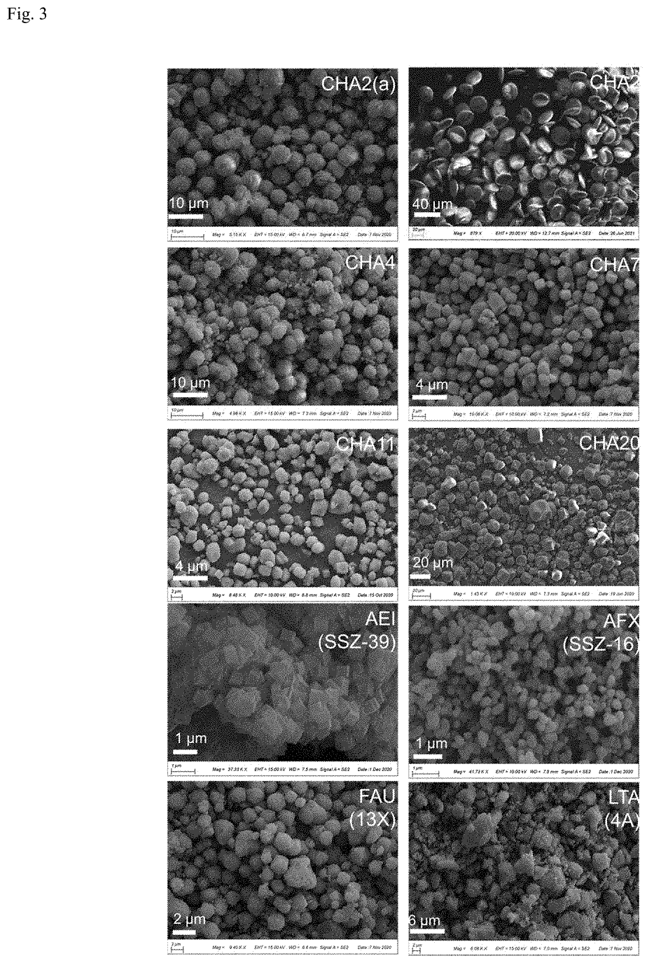

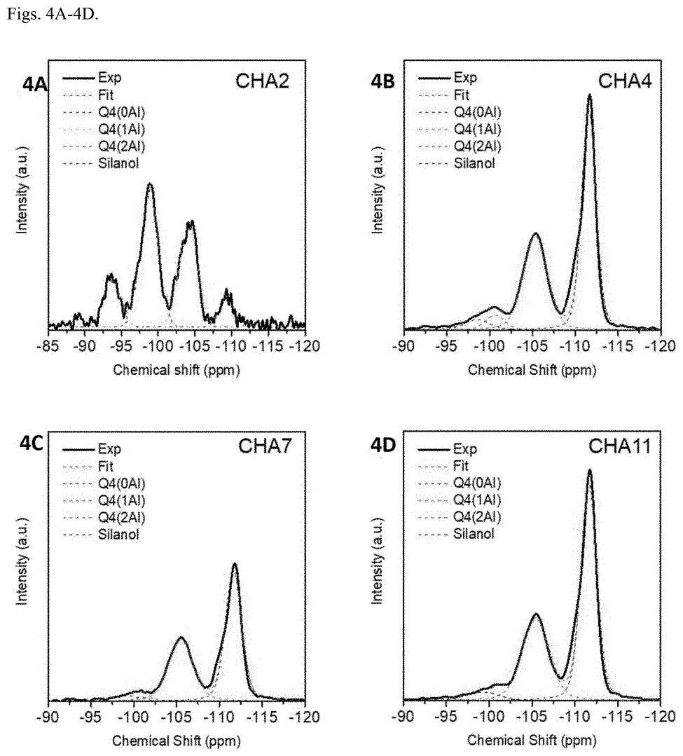

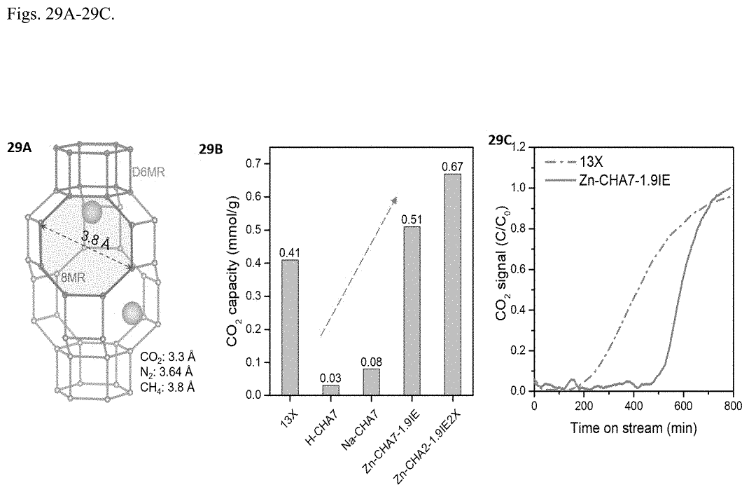

CHA-type zeolites possess the CHA framework topology (FIG. 29a) that consists of CHA cages connected via double six-membered rings (D6MRs) and have small pores (those that are constructed from 8 T-atoms (Si+Al) and 8 oxygen atoms—denoted an 8-membered ring, 8MRs). CHA-type materials were synthesized with different Si/Al ratios (FIGS. 2-4 and Table 1). The samples were denoted as M-CHAR-NIE, where M, R and N indicate the extra-framework cation type, Si/Al ratio and cation concentrations of aqueous solutions for ion exchange (IE), respectively. If no value is listed after IE, then only one exchange was performed. Column breakthrough experiments (see details in FIG. 1) in a fixed-bed were used to examine the CO₂ capture performance, as this method provides breakthrough capacity, saturation capacity and diffusion kinetics, as well as desorption energy when coupled with temperature programmed desorption (TPD).

Alkali cation containing SSZ-13 zeolites have been shown to adsorb CO₂ due to the strong electric field and acid-base interaction induced by the ions. The results presented herein (FIG. 29b) show that Na-CHA7-0.5 gives a two-fold increase of CO₂ capacity over the H-CHA7 zeolite. To test the effect of the varying number of ions in the solids on adsorption capacity, Na-CHA zeolites with different Si/Al ratios were investigated. The adsorption capacity (Table 2) for the zeolites with Si/Al ratios of 2, 4, 7, 11 and 20 are all substantially lower (0.16 mmol/g or less) than that of the 13× zeolite (0.41 mmol/g). Note that 13× zeolite has reported values in the literature of 0.40-0.41 mmol/g for CO₂ concentrations between 395-500 ppm, validating the reliability of our method. See S. Mukherjee, et al., Sci. Adv. 2019, 5, eaax9171; N. R. Stuckert, R. T. Yang, Environ. Sci. Technol. 2011, 45, 10257-10264; S. M. W. Wilson, F. H. Tezel, Ind Eng. Chem. Res. 2020, 59, 8783-8794.

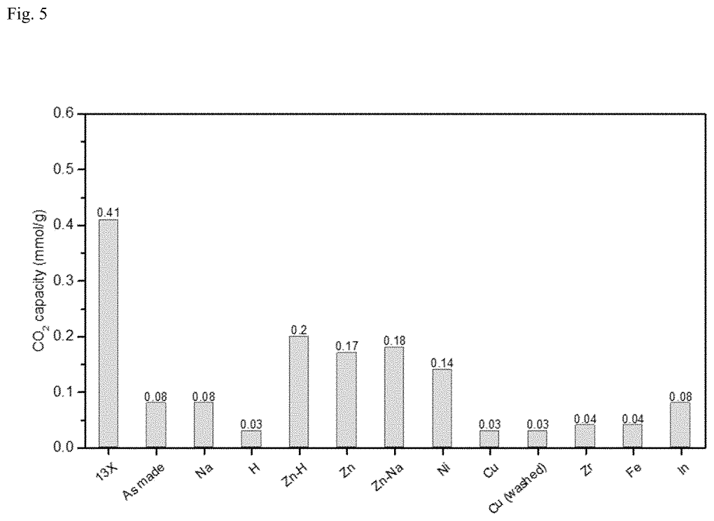

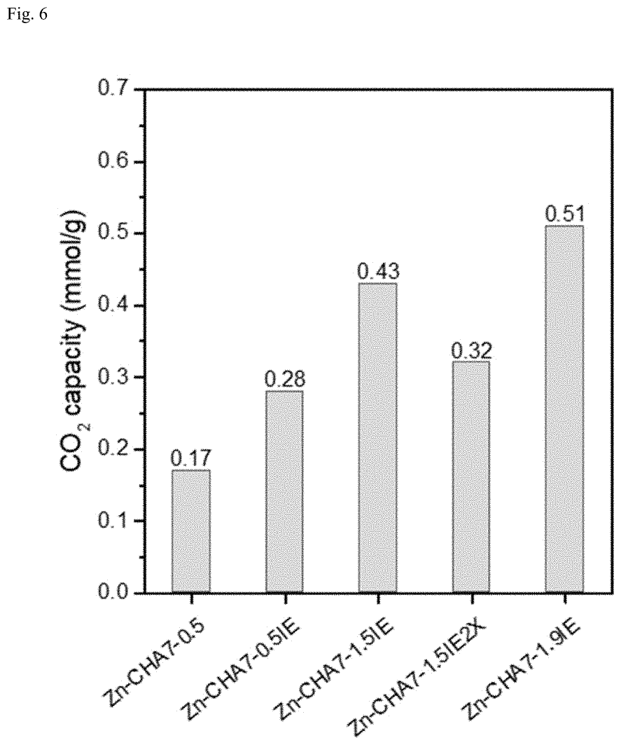

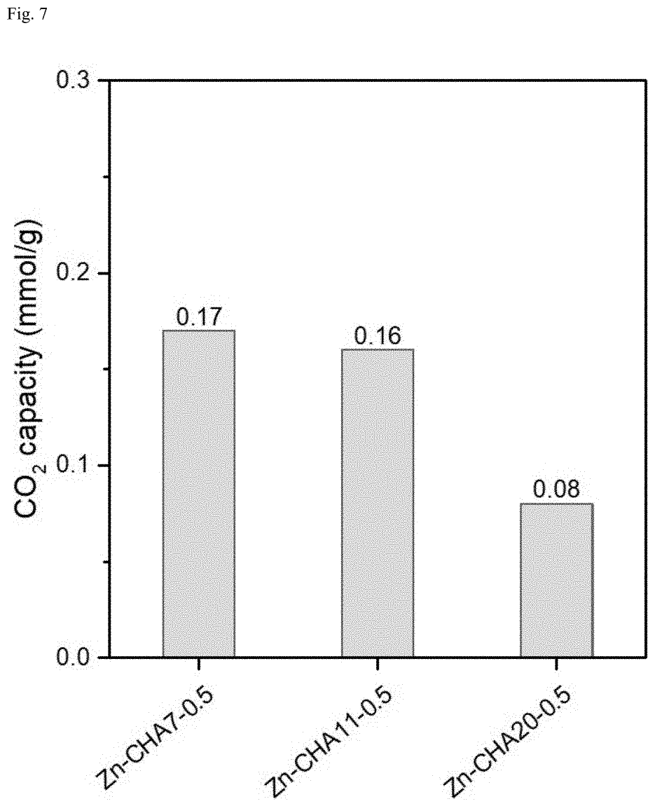

As it was not possible to obtain high CO₂ capacity using Na-CHA zeolites, alternative cation types were investigated for CO₂ adsorption in CHA-type zeolites. Transition metals can be used for catalytic processes such as CO₂ hydrogenation. Here, transition metals were explored for DAC. Several transition metals exchanged into CHA-type zeolites exhibited increased CO₂ adsorption capacities as shown in FIG. 5 and Table 2. Specifically, Zn, Nickel (Ni) and Indium (In) ions exchanged into H-CHA7 show CO₂ capacities of 0.17, 0.14 and 0.08 mmol/g, respectively. The CO₂ capacity of Zn-CHA7-0.5 (FIG. 6) is increased to 0.28 mmol/g by simply washing the materials after ion-exchanged (denoted as Zn-CHA7-0.51E). An increased CO₂ capacity of 0.51 mmol/g (FIG. 29b) resulted for Zn-CHA7-1.91E, and the value is larger than that obtained from 13× zeolites. The CO₂ capacities are a function of the Si/Al ratios of the CHA-type zeolites (FIG. 7), as more Zn ions can be exchanged into lower Si/Al frameworks. Successful synthesis of CHA-type zeolite with Si/Al=2 and then ion exchanged to give Zn-CHA2-1.9IE2X shows the highest CO₂ capacity of 0.67 mmol/g (FIG. 29b). Zn-CHA zeolites have been reported for CO₂ adsorption at higher pressure. See M. Sun, et al., Chem. Eng. J. 2019, 370, 1450-1458; T. Du, Res. Chem. Intermed. 2017, 1783-1792. However, a lower adsorption capacity was observed for Zn-CHA compared to its H-form counterpart. This seemingly contrary result to the data obtained here at low concentration of CO₂ could be due to differences in the preparation of Zn containing zeolites. In order to better understand the structural features that provide the high adsorption capacity observed in this work, the active sites for CO₂ adsorption were investigated and discussed below.

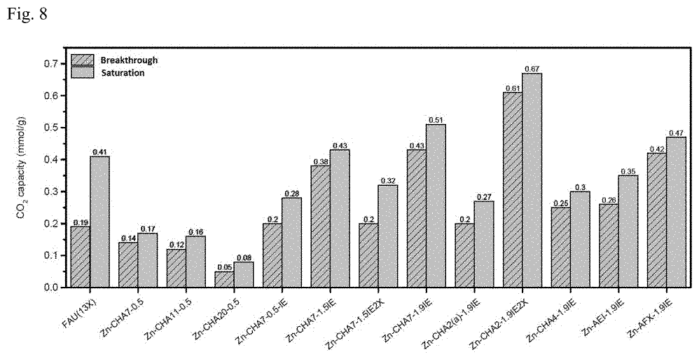

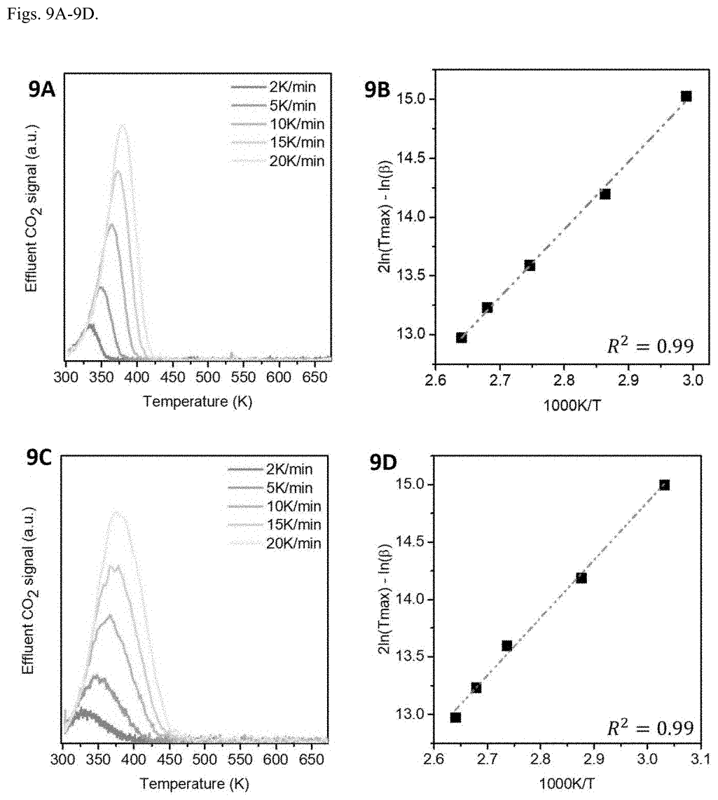

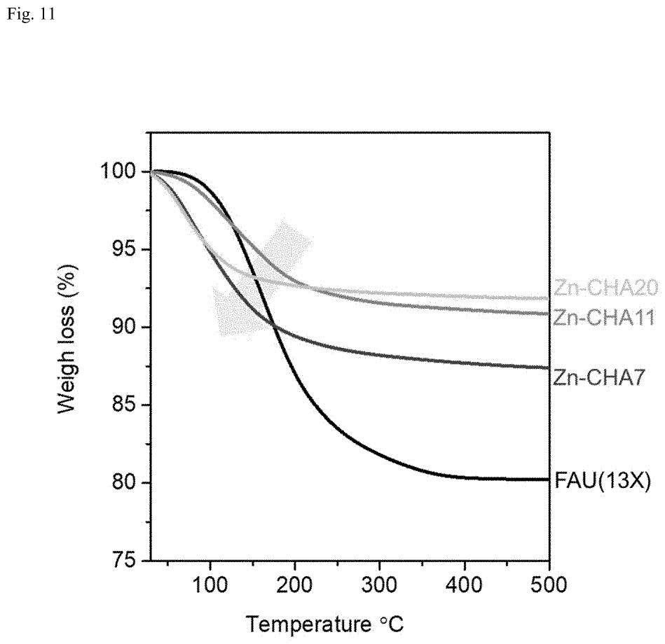

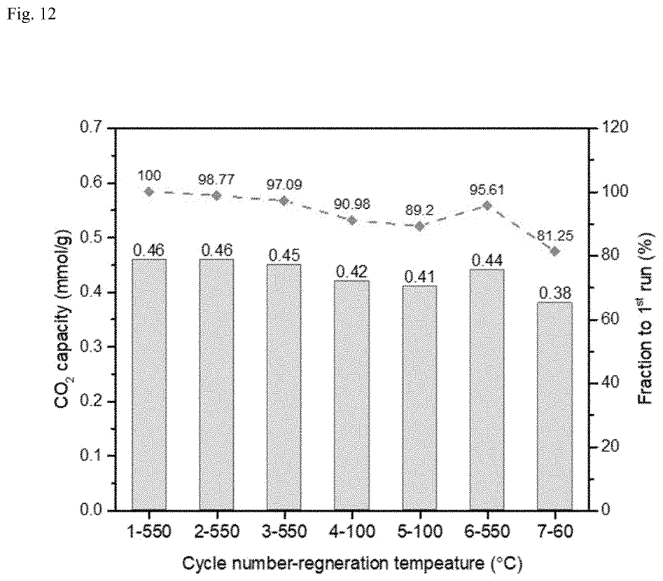

The Zn-CHA-type materials exhibit faster adsorption kinetics than 13×, as illustrated by the sharper breakthrough profile for Zn-CHA7-1.91E compared to 13× (FIG. 29c). This results in a smaller difference between breakthrough and saturation capacities. Similar results were observed for all Zn-CHA zeolites (physicochemical properties in Table 3) studied in this work (FIG. 8). Furthermore, TPD experiments (FIG. 9 and Table 4) show lower desorption energy for Zn-CHA7-1.91E (41.86 kJ.mol⁻¹) than 13× (47.93 kJ.mol⁻¹). The value for 13× is consistent with the adsorption energy (46-49 kJ.mol⁻¹, with detailed discussion in Supporting Information) at zero coverage (see A. Khelifa, et al., Microporous Mesoporous Mater. 1999, 32, 199-209; T.-H. Bae, et al., Energy Environ. Sci. 2012, 6, 128-138) and desorption energy (46.39 kJ.mol⁻¹) (see Y. Guo, et al. Adsorpt. Sci. Technol. 2018, 36, 1389-1404) reported in the literature. Fourier-transform infrared (FTIR, Figure S10) spectra reveal that CO₂ molecules are exclusively physisorbed in Zn-CHA zeolites. The physisorbed CO₂ can be removed at low temperatures. However, besides physisorbed CO₂ molecules, chemisorbed, carbonate-like species are observed in 13× zeolite, and cannot be removed at 300° C. See S. M. W. Wilson, F. H. Tezel, Ind Eng. Chem. Res. 2020, 59, 8783-8794. Moreover, TGA results (FIG. 11) show that the CHA7 zeolite adsorbed less water (12.51 wt %) than 13× (19.78 wt %) after equilibrating under the same humid environments (ca. 20% relative humidity), suggesting the former possesses higher hydrophobicity. Furthermore, the Zn-CHA zeolites show high recyclability (FIG. 12) at temperatures as low as 100° C. under ambient pressure, while low recyclability is reported in 13× when temperature is lower than 261° C. due to its high affinity to CO₂. See S. M. W. Wilson, F. H. Tezel, Ind. Eng. Chem. Res. 2020, 59, 8783-8794.

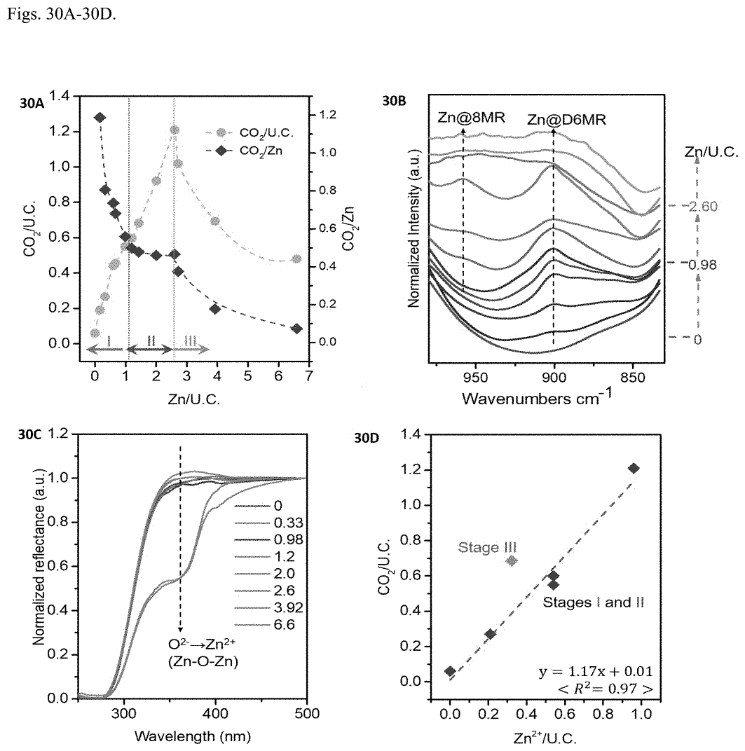

A series of Zn-CHA7 samples were prepared with fixed Al composition (Si/Al=7) and Zn/U.C. ranging from 0 to 6.60 (Table 5), where Zn/U.C. denotes the number of Zn ions per CHA unit cell, i.e., Zn ion density. As shown by the data in FIG. 30a, a volcano shape profile with three distinct stages was observed. CO₂ capacity increases at two different rates (stage I and stage II) before declining when the Zn ion loading is higher than ca. 2.60 Zn/U.C. Simultaneously, the adsorption efficiency, i.e., CO₂ per Zn ion, gradually decreases with the increase of Zn ion loading. Nitrogen physisorption results show comparable pore volumes (0.18-0.21 cm³/g, Table S3) for Zn-CHA7 materials with Zn ion density lower than 6.60/U.C. Thus, the distinct behaviors at the three stages, as well as the variations of CO₂ capacities, are due to the speciation of Zn ions.

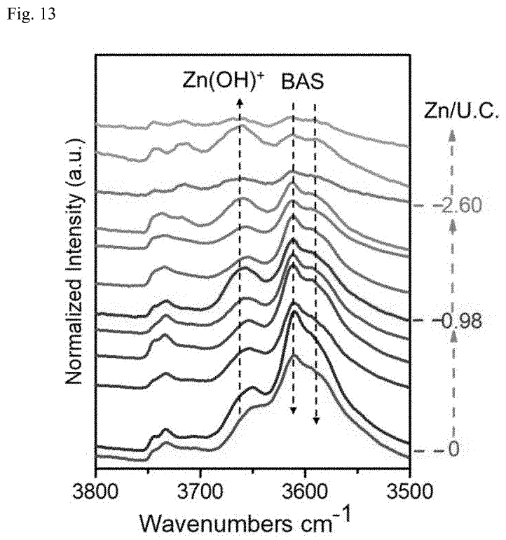

The environments and states of Zn ions were examined to understand the CO₂ adsorption behavior. As shown in FIG. 30b, two new FTIR features are seen at ca. 902 and 950 cm⁻¹ for the Zn-CHA7 samples in comparison to H-CHA7 (Zn/U.C.=0). These vibrations are assigned to perturbed T-O-T structural vibrations in the vicinity of extra-framework cations occupying sites in the D6MRs and 8MRs in the CHA cage, respectively. See J. H. Kwak, et al. Chem. Commun. 2012, 48, 4758-4760; K. Mlekodaj, et al., J. Phys. Chem. C 2019, 123, 7968-7987; Y. Shan, et al., Appl. Catal. B Environ. 2020, 264, 118511. Notably, only one band at 902 cm⁻¹ appears for Zn-CHA samples at stage I followed by the evolution of an extra band at 950 cm⁻¹ at stage II (Zn/U.C.>1.21). These results suggest that the Zn ions are exclusively located in the D6MRs at stage I, and that further increase of the Zn ion loading results in the addition of Zn ions to the 8MRs. The UV-Vis diffuse reflectance (FIG. 30c) results show the formation of Zn—O—Zn species solely at stage III with high Zn ion loadings, (J. A. Biscardi, et al., J. Catal. 1998, 179, 192-202; A. Mehdad, R. F. Lobo, Catal. Sci. Technol. 2017, 7, 3562-3572) as suggested by the appearance of the O²⁻→Zn²⁺ ligand-to-metal charge transfer transition band at ca. 360 nm. See N. Koike, et al., Chem.-Eur. J. 2018, 24, 808-812. Thus, Zn ions are incorporated as Zn²⁺ and/or Zn(OH)⁺ ions (FIGS. 13-18) at stages I and II, consistent with previous research on copper ion exchange into CHA-type zeolites. See E. Borfecchia, et al., Chem. Sci. 2014, 6, 548-563.

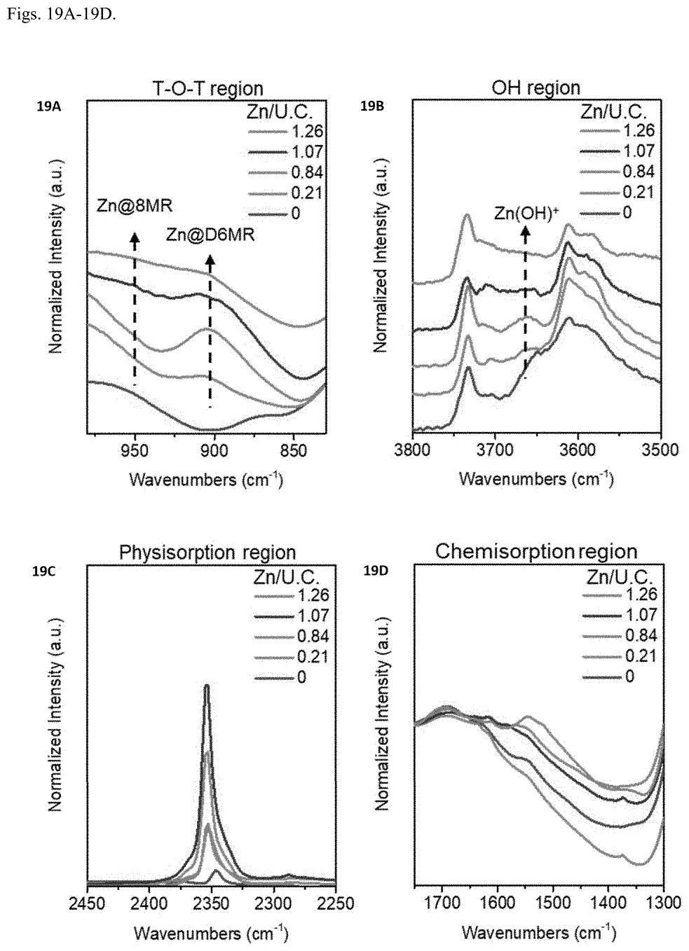

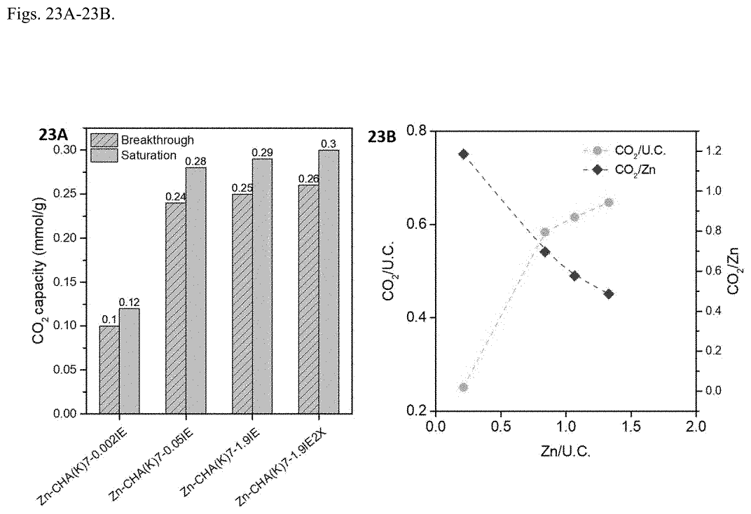

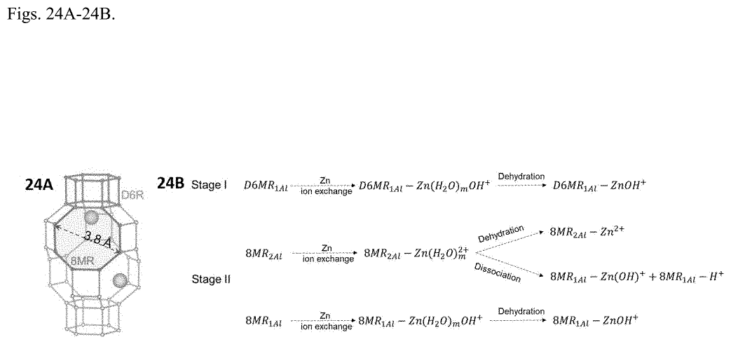

Quantitative analysis of ¹H MAS NMR data suggests that Zn²⁺ (Tables 6-7) ions are the predominate species for at stage I that is with high adsorption efficiency, i.e., CO₂/Zn. Correlation of the numbers of Zn²⁺ and CO₂/U.C. gives a linear relation (FIG. 30d) at stages I and II. These results are consistent with Zn²⁺ being the primary adsorption site. This also explains the observed positive correlation (FIGS. 29b and 7) between CO₂ capacity and Al content in Zn-CHA zeolites, as a higher Al content often leads to more paired Al (denoted as 2Al) in the D6MRs that can accommodate more Zn²⁺.See C. Paolucci, et al., J. Am. Chem. Soc. 2016, 138, 6028-6048. Further study was performed using SSZ-13 zeolites synthesized with K⁺ to minimize 2Al (FIGS. 19-24 and Tables 8-9) in the D6MRs and locate 2Al in the 8MRs. See J. R. Di Iorio, et al., J. Am. Chem. Soc. 2020, 142, 4807-4819. These zeolites contain predominately Zn(OH)⁺ and Zn²⁺ species in the D6MRs and 8MRs, respectively. The adsorption results (FIG. 23) show that CO₂ capacity was clearly increased with the addition of Zn ions in the D6MRs with an adsorption efficiency lower than 1. These data suggest a limited fraction of Zn(OH)⁺ species located in the D6MRs are able to adsorb CO₂. CO₂ capacity remained almost constant when loading Zn²⁺ ions in the 8MRs. This result suggests that the Zn²⁺ ions in the 8MRs are likely inactive, and thus highlighting the significance of locating Zn²⁺ species in the D6MRs for high CO₂ adsorption capacity. Additionally, Zn—O—Zn is likely an extra site for CO₂ adsorption, as it is the only new species appearing at stage III with CO₂/U.C. vs. Zn²⁺/U.C. sitting above (FIG. 30d) the linear correlation. Collectively, these results show that Zn²⁺ ions in the D6MRs are the primary sites for CO₂ adsorption (see detailed discussion in Supporting Information). Therefore, the Al distribution in the framework with maximizing Al located in D6MRs as 2Al sites has a critical effect on enhanced CO₂ adsorption performance.

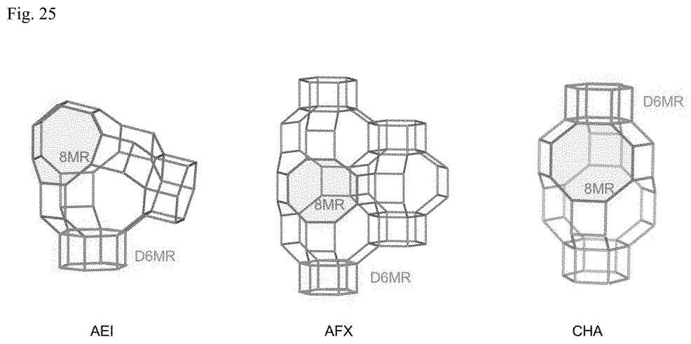

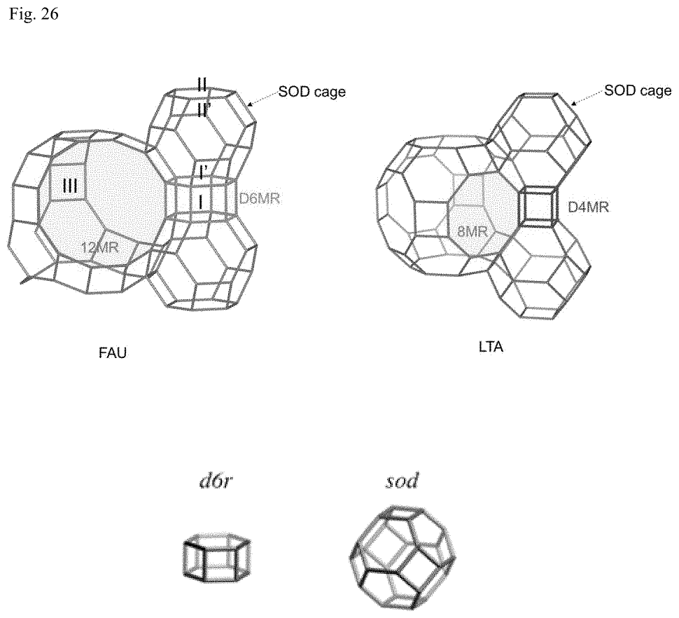

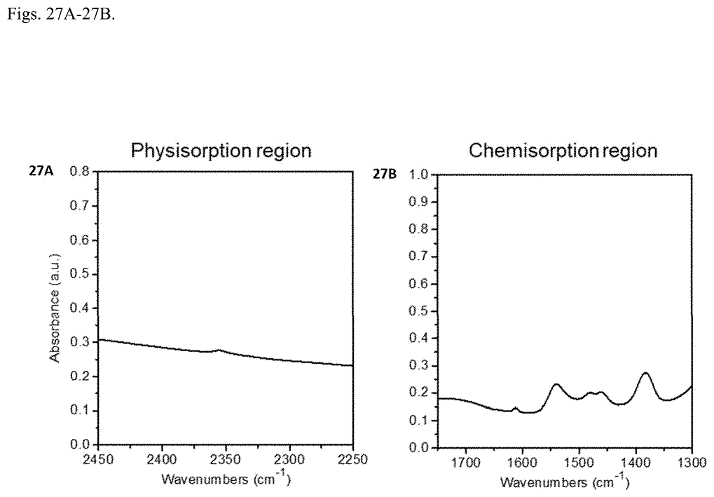

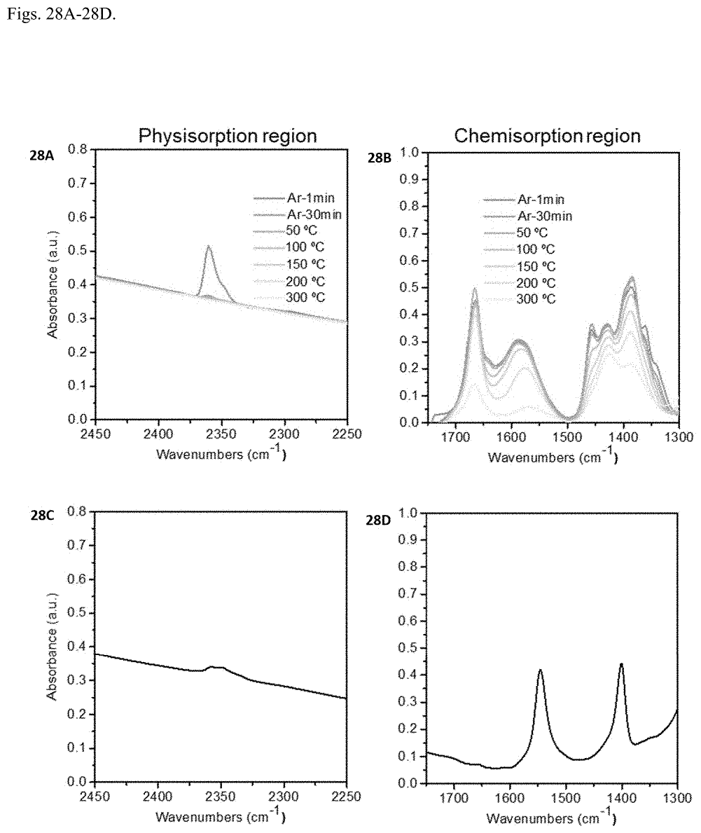

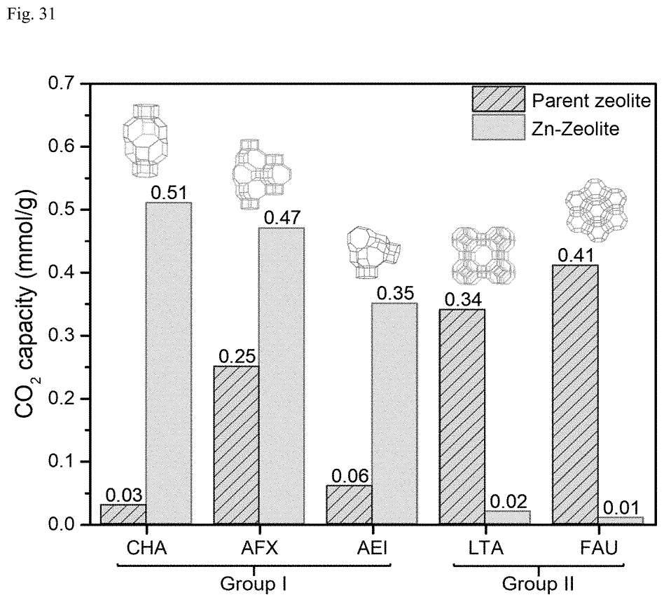

In order to assess the impact of framework topology on CO₂ adsorption performance, several other zeolites were prepared that possess significant variations in topologies. Two groups of materials were selected: Group I (FIG. 25) is small-pore zeolites with framework topologies more like the CHA-type. Group II (FIG. 26) includes the standard low-silica zeolite adsorbents, namely FAU-type (13×) and LTA-type (zeolite A). CO₂ adsorption (FIG. 31) in zeolites from group I (AEI, AFX) show increased capacities after Zn ion exchange. This is attributed to the presence of abundant D6MRs in these frameworks that can preferentially accommodate the divalent ions (Zn²⁺), as shown in previous studies of copper ion exchanged AEI (see G. Fu, et al., Microporous Mesoporous Mater. 2021, 320, 111060) and AFX. See D. W. Fickel, R. F. Lobo, J. Phys. Chem. C 2010, 114, 1633-1640. For group II, the addition of Zn ions surprisingly prohibits the adsorption of CO₂ in these zeolites. These results are consistent with those from higher pressure (>0.66 mbar) adsorption where CO₂ capacity decreased with the addition of Zn ions into 13×. See A. Khelifa, et al., Microporous Mesoporous Mater. 1999, 32, 199-209. The significant decline in CO₂ adsorption is corroborated by the negligible absorption in the CO₂ vibration region as shown in the FTIR spectra (FIGS. 27 and 28). This observation could be partially attributed to the preference location of divalent ions inside sodalite (SOD) cages in these materials (FIG. 26) that are inaccessible to CO₂ molecules. See A. Khelifa, et al., Microporous Mesoporous Mater. 1999, 32, 199-209; W. P. J. H. Jacobs, et al. Zeolites 1993, 13, 170-182. These results altogether indicate that the framework topology and thus the positioning of extra-framework ions dictate their CO₂ adsorption properties. Specifically, the lack of SOD cages and the abundance of accessible D6MRs are two crucial factors for CO₂ adsorption in the Zn exchanged zeolites.

Thus, the addition of Zn ions into CHA-type zeolites, e.g., SSZ-13, produced greatly enhanced performance for adsorbing low concentrations of CO₂. The Zn ion containing zeolites exhibited higher CO₂ capacity, faster kinetics, lower desorption energy than the standard low-silica 13× zeolites. Control of the state and location of Zn ions in the CHA cages was crucial to the high CO₂ adsorption capacity. Zn²⁺ ions located at the D6MRs of SSZ-13 with Si/Al=ca. 7 gave an adsorption capacity of 0.51 mmol CO₂/g-zeolite, a 17-fold increase compared to the parent H-form. Lowering the Si/Al to ca. 2 resulted in an increase of capacity to 0.67 mmol CO₂/g-zeolite. The framework topology of the zeolite plays a key role in the performance of the Zn-exchanged materials by governing the position of divalent ions.

### Example 1: Instrumental Methods

X-ray diffraction: The crystallinity of the materials was examined using powder X-ray diffraction (XRD). The XRD patterns were collected using a Rigaku Miniflex II desktop instrument with a Cu radiation source, K_{α}=1.5418 Å.

Scanning electron microscopy: The morphology of the materials was measured using scanning electron microscopy (SEM, ZEISS 1550 VP FESEM). The SEM was equipped with an Oxford X-Max SDD. Energy dispersive X-ray spectroscopy (EDS) used for determining the element contents (e.g., Si/Al ratios) of each sample. Before measurement, all zeolites were coated with Pt of ca. 10 nm thickness to avoid charging effects.

All-solid-state, magic-angle spinning nuclear magnetic resonance: All-solid-state, magic-angle spinning nuclear magnetic resonance (MAS NMR) spectra were obtained on a Bruker AVANCE 500 MHz (11.2 T) spectrometer using a 4 mm zirconia rotor with a Kel-F cap. ¹H MAS NMR spectroscopy experiments were conducted on representative samples. Prior to the measurement, samples were loaded in the rotor and dehydrated under vacuum (10⁻² Torr) at 400° C. for 12 h using a Schlenk manifold. The spectra were acquired at 500.1 MHz and a spinning rate of 12 kHz using a 90° pulse length of 4 s with varied cycle delay times depending on the relaxation time, and then were deconvoluted using Origin 9.1. Signal intensities corresponding to the Brønsted acid sites were referenced to hexamethyl benzene and normalized by the sample mass to quantify the acid site density (mmol/g). The ¹H-decoupled ²⁹Si MAS NMR spectra were acquired without dehydration at 99.3 MHz and a spinning rate of 8 kHz using a 90° pulse length of 4 μs with a cycle delay time of 60 s. Framework Si/Al ratios were calculated using eq. S1, where I denotes the intensity of the ²⁹Si NMR signal and nₘₐₓ=2 in the present case. See C. A. Fyfe, et al., Zeolites 1985, 5, 179-183. Equation 51:

$$Si / Al ( framework ) = \frac{{\sum }_{n = 0}^{4} {I}_{Si ( nAl )}}{{\sum }_{n = 0}^{4} 0.25 n * {I}_{Si ( nAl )}}$$

TABLE 1
Bulk and framework Si/Al ratios of calcined CHA samples.

| Sample | Bulk Si/Al ratio^{a} | Framework Si/Al ratio^{b} |
|---|---|---|
| CHA2 | 2.33 | 2.82 |
| CHA4 | 5.64 | 8.50 |
| CHA7 | 7.05 | 9.32 |
| CHA11 | 9.25 | 10.32 |

Note:
^{a}Elemental analysis of ca. 40 crystals using EDS.
^{b}The values were calculated from ²⁹Si NMR.

Solid-state NMR (13C and 29Si) spectra were obtained using a Bruker DSX-500 spectrometer (11.7 T) and a Bruker 4 mm MAS probe. The spectral operating frequencies were 500 MHz, 125.7 MHz, and 99.4 MHz for 1H, 13C, and 29Si nuclei, respectively. Spectra were referenced to external standards as follows: tetramethylsilane (TMS) for 1H and 29Si and adamantane for 13C as a secondary external standard relative to tetramethylsilane. Samples were spun at 14 kHz for 1H NMR and 8 kHz for 13C and 29Si MAS and CPMAS NMR experiments.

Fourier transform infrared spectroscopy: Fourier transform infrared (FT-IR) spectra were collected on zeolite samples using a Nexus 470 FT-IR spectrometer equipped with a s deuterated, L-alanine doped triglycine sulfate (DTGS) detector. Catalyst samples (˜10-12 mg) were pressed into a self-supporting wafer (ca. 1.2 cm in diameter) and placed in a custom-built FT-IR cell. The wafers were treated in flowing dry air at 723 K for 120 min, and then cooled to RT for CO₂ adsorption under flowing dry air for 30 min. Spectra were collected with a resolution of 4 cm⁻¹ and averaged over 64 scans. The baseline correction and spectrum normalization follow previously reported method by Gounder et. al. using the framework Si—O—Si combination/overtone band between 2100 and 1750 cm⁻¹. See C. Paolucci, A. A. et al., J. Am. Chem. Soc. 2016, 138, 6028-6048.

UV-Vis diffuse reflectance spectroscopy: UV-Vis Diffuse reflectance (DR) spectra were recorded on a Cary 5000 UV-Vis-NIR spectrometer in a 200-800 nm wavelength range.

Thermogravimetric analysis (TGA) was performed on a Perkin Elmer STA 6000 with a ramp of 10° C. min⁻¹ to 900° C. under air atmosphere. Samples (0.01-0.06 g) were placed in aluminum crucible and heated at 10 K/min in a flowing stream (0.333 cm³/s) comprised of compressed air (Airgas).

### Example 2. Chemicals

Unless otherwise noted, all reagents were purchased from commercial sources and were used as received. Unless otherwise noted all, reactions were conducted in flame-dried glassware under an atmosphere of argon.

All materials for synthesizing zeolites were used as-received without further purifications from the stated vendors. The moisture contents of the solid sources were determined by thermogravimetric analysis (TGA). Ludox-AS40 (40 wt % silica dispersed in water, Sigma-Aldrich) and sodium silicate (homemade, SiO₂: 38.3 wt %, SiO₂/Na₂O: 3.22) were used as silica source. Aluminum sources are aluminum isopropoxide (≥98%, Sigma-Aldrich), aluminum hydroxide powder (63 wt % Al₂O₃, Pfaltz & Bauer), Reheiss F2000 (Al(OH)₃, 45% H₂O) and FAU zeolites with a Si/Al ratio of 12 (denoted as FAU2). The organic structure directing agents (OSDAs) are N,N,N-trimethyl-1-adamantammonium hydroxide (25 wt % in H₂O, TMAdaOH, Sachem), N,N-dimethyl-2,6-dimethylpiperidiunim hydroxide (home synthesized), 1,4-diazabicyclo[2.2.2]octane-C4-diquat dibromide. Alkaline aqueous solutions are NaOH (10 wt %, homemade), NaOH (50 wt %, Sigma-Aldrich), NaOH (1M, VWR), KOH (45 wt %, Sigma-Aldrich). The salts used for ion exchange are zinc(II) acetate dihydrate (Zn(CH₃CO₂)₂.2H₂O, ≥98%, Sigma-Aldrich), copper(II) nitrate trihydrate (Cu(NO₃)₂.3H₂O, 99-104%, Sigma-Aldrich), zirconium(IV) oxynitrate hydrate (ZrO(NO₃)₂.xH₂O, 99%), indium(III) nitrate hydrate (In(NO₃)₃.xH₂O, 99.9%, Sigma-Aldrich), iron(III) nitrate nonahydrate (Fe(NO₃)₃.9H₂O, 99.95%, Sigma-Aldrich), cobalt(II) nitrate hexahydrate (Co(NO₃)₂.6H₂O, ≥98%, Aldrich).

### Example 3. Synthesis of Materials

CHA-Type Zeolites (SSZ-13 and High Aluminum CHA-Type)

The synthesis of SSZ-13 zeolite with Si/Al ratio higher than 5 was modified from the method in international zeolite association (http://www.iza-online.org/synthesis/default.htm). A molar ratio of 1 SiO₂/X Al₂O₃/0.2 TMAdaOH/0.2 NaOH/44 H₂O was used in the synthesis solution (X was calculated based on the targeting Si/Al). Typically, a 25% solution of the OSDA (TMAdaOH) was added to NaOH aqueous solution and stirred for 10 min at room temperature (RT). Then aluminum isopropoxide was added. After 21 h stirring at RT, Ludox-40 was added and stirred 26 h before charging the solution into Teflon-lined Parr autoclaves. SSZ-13 zeolites with lower Si/Al ratio (Si/Al=5) was synthesized following the method from Deimund et al. See M. A. Deimund, et al., ACS Catal. 2016, 6, 542-550. The molar composition of the synthesized gel is: 1 SiO₂/0.078 Al₂O₃/0.2 TMAdaOH/0.2 NaOH/40 H₂O. Reheiss F2000 and fumed silica were the aluminum and silicon source, respectively. The gel was stirred until it was homogeneous. The solution was placed in a Teflon-lined Parr autoclave and heated in a rotating oven to 160° C. for approximately 7 days.

High-aluminum CHA-type zeolites (Si/Al=ca. 2, CHA2) were synthesized using the method reported by Liu et al. See B. Liu, et al. Microporous Mesoporous Mater. 2014, 196, 270-276. The molar ratio in the gel was: 1SiO₂:0.2Al₂O₃: 0.39K₂O:0.3NH₄F:35H₂O. First, aluminum hydroxide was dissolved in a KOH aqueous solution, which was under heating at 80° C. After cooling down, required amount of ammonium fluoride and colloidal silica were added. This mixture was stirred at room temperature for 6 h to form a milk-like gel. The gel was loaded into Teflon-lined Parr autoclaves and hydrothermally treated at 150° C. for 7 days. It should be noted that CHA-type zeolites with Si/Al=2 (denoted as CHA2(a)) were also prepared from the hydrothermal conversion of zeolite Y (FAU-type) following the International Zeolite Association synthesis method. In a typical synthesis, 26.42 g of deionized water was mixed with 3.58 g of a potassium hydroxide solution (45 wt %, Sigma-Aldrich), to which 3.33 g of CBV500 (a NH₄-form zeolite Y with Si/Al of 2.6 from Zeolyst) were added. The mixture was shaken for about 30 s and heated in a sealed polypropylene vessel at 100° C. for 14 days under static conditions. However, the CHA material converted from FAU showed small pore volume (0.05 m³/g, Table 3) after zinc loading, consistent with the recent results from Hong et al. See J. G. Min, K. C. Kemp, K. S. Kencana, S. B. Hong, Microporous Mesoporous Mater. 2021, 323, 111239.

The synthesis of K-SSZ-13 zeolite, denoted as CHA(K)7, follows the reported method by Gounder et al. See J. R. Di Iorio, S. Li, C. B. Jones, C. T. Nimlos, Y. Wang, E. Kunkes, V. Vattipalli, S. Prasad, A. Moini, W. F. Schneider, R. Gounder, J. Am. Chem. Soc. 2020, 142, 4807-4819. A molar ratio of 1 SiO₂/0.0167 Al₂O₃/0.1 TMAdaOH/0.4 KOH/44 H₂O was used in the synthesis solution. In a typical synthesis, an aqueous solution of TMAdaOH (25 wt %, Sachem) was added to distilled water and stirred for 15 minutes under ambient conditions. Then, an aqueous KOH solution (45 wt % in deionized water, Sigma-Aldrich) was added to the TMAdaOH solution and stirred at ambient conditions for 15 minutes. Next, aluminum hydroxide powder (63 wt % Al₂O₃, Pfaltz & Bauer) was added and stirred for 15 minutes under ambient conditions. Finally, an aqueous colloidal silica solution (Ludox AS40, 40 wt %, Sigma-Aldrich) was added and the contents were covered and stirred for 2 h under ambient conditions. The resulting mixture was charged into Teflon-lined Parr autoclaves and heated to 160° C. for 6 days under static conditions.

SSZ-39 (AEI)

The synthesis of SSZ-39 follows the previously reported method by the Davis group. See M. Dusselier, et al., Chem. Mater. 2015, 27, 2695-2702. A molar ratio of 1 SiO₂/0.0167 Al₂O₃/0.14 OSDA/0.57 NaOH/28 H₂O was used in the synthesis solution. First, 3.00 g of home synthesized organic OSDA (N,N-dimethyl-2,6-dimethylpiperidinium hydroxide, 0.7008 mmol/g aqueous solution) were combined with 0.13 g NaOH (10 wt % aqueous solution) and 2.89 g water in a 23 mL Teflon-lined Parr autoclave followed by 20 min stirring under ambient condition. Then, 2.95 g home-made silica source (sodium silicate, SiO₂ 27.97 wt %, Na₂O 8.66 wt %, H₂O 63.38 wt %) as well as aluminum source (CBV500, a NH₄-form zeolite Y with Si/Al of 2.6 from Zeolyst) were added. After 1 h vigorous stirring, a homogeneous gel was obtained. The Teflon-lined Parr autoclave was then sealed and placed in a rotating oven at 140° C. for 7 days.

SSZ-16 (AFX)

Zeolite SSZ-16 was synthesized using the method reported by Zones et al. See S. I. Zones, Zeolite SSZ-16, 1985, U.S. Pat. No. 4,508,837A. A homogeneous solution was prepared by mixing 0.22 g of 1,4-diazabicyclo[2.2.2]octane-C4-diquat dibromide, 0.41 g of the FAU12, 0.99 g of homemade sodium silicate reagent (38% SiO₂, SiO₂/Na₂O=3.3), 4.5 g of 1 N NaOH solution and 0.7 g of water. This mix gives an overall OH⁻/SiO₂ of 0.80. The solution is charged into Teflon-lined Parr autoclaves and heated to 135° C. for 4 days in a rotatory oven.

Zeolite 13X (FAU-type) and 4A (LTA-type)

4A and 13X were obtained from Sigma-Aldrich.

After the synthesis of materials containing OSDAs was finished, the resulting solids were washed three times with distilled water followed by acetone washing. The crystals were dried overnight at 80° C. before calcining in air at 580° C. for 8 h, with a ramp rate of 1.0° C.min⁻¹, to remove the OSDAs. Crystallinity was evaluated by XRD.

Aqueous-Phase Ion-Exchange of Zeolites

Metal-zeolites were prepared by aqueous phase cation ion exchange of calcined zeolites with corresponding salt solutions. Typically, 600 mg of zeolites were added to 30 mL of salt solutions, which were then stirred at 80° C. for 24 h. Metal-zeolites were recovered via centrifugation with or without 6 times washing using distilled H₂O, and the materials were named with and without IE correspondingly. For FAU-type and LTA-type zeolites, ion exchange was performed at room temperature (RT) for 2 days to prevent the dissolution of the materials. The exchanged crystals were dried at 100° C. in ambient air in a free convention oven overnight.

A similar ion exchange procedure was used to prepare samples for the study of speciation of zinc ions in SSZ-13. Depending on the targeting zinc exchange level, 30 mL of 0.001 M to 0.05 M aqueous zinc acetate solution were used as the precursor. The Zn²⁺ solution was adjusted to a pH value of 4.92±0.02 before dispersing NH₄-SSZ-13 zeolites using 0.1 M HCl aqueous solution, and then the solution was stirred at 80° C. for 24 h. The materials were recovered by centrifugation and washed 6 times with copious amount of distilled water. The exchanged crystals were dried at 100° C. overnight.

To titrate the paired aluminum sites in the double six membered rings (D6MRs) in CHA zeolites using Co²⁺, (see J. R. Di Iorio, R. Gounder, Chem. Mater. 2016, 28, 2236-2247; C. T. Nimlos, et al. Chem. Mater. 2020, 32, 9277-9298) the as prepared CHA-type zeolites were first NH₄⁺-exchanged followed by converting to their proton form (H-form) by heating to 580° C. under flowing dry air for 8 h, with a ramp rate of 1.0° C.min⁻¹. Then the H-form CHA was added to a 0.25 M aqueous solution of Co(NO₃)₂ (150 mL·g, >98 wt %, Aldrich) and stirred at 80° C. for three times (5 h, overnight and 5 h) without pH control. This procedure is closely similar to Gounder's method. See C. T. Nimlos, et al., Chem. Mater. 2020, 32, 9277-9298. This process was repeated three times (5 h, overnight, 5 h) followed by 6 times wash with copious amount of distilled water.

TABLE 3
Physicochemical properties of the
Zn ion exchanged zeolite samples.

| | | | | | Micropore |
|---|---|---|---|---|---|
| | Si/Al | Zn/Al | Zn | | volume^{b} |
| Adsorbent | ratio^{a} | ratio^{a} | wt % | Zn/U.C. | (cm³/g) |
| Zn-CHA2(a)-1.9IE | 2.13 | 0.21 | 7.62 | 2.42 | 0.05 |
| Zn-CHA2-1.9IE2X | 2.06 | 0.64 | 19.39 | 7.53 | 0.19 |
| Zn-CHA4-1.9IE | 4.43 | 0.44 | 8.45 | 2.92 | 0.20 |
| Zn-CHA7-1.9IE | 6.50 | 0.54 | 7.19 | 2.60 | 0.20 |
| Zn-CHA7-1.5IE | 7.09 | 0.62 | 8.49 | 2.72 | 0.21 |
| Zn-CHA7-0.5IE | 7.00 | 0.87 | 11.10 | 3.92 | 0.18 |
| Zn-CHA7-0.5 | 6.80 | 1.43 | 17.15 | 6.60 | 0.13 |
| Zn-CHA11-0.5 | 9.25 | 0.73 | 7.25 | 2.56 | 0.14 |
| Zn-CHA20-0.5 | 19.05 | 1.76 | 8.55 | 3.16 | 0.16 |
| Zn-13X-0.5IE | 1.00 | 0.63 | 25.71 | 60.48 | 0.18 |
| Zn-LTA-0.5IE | 0.86 | 0.43 | 20.26 | 5.55 | 0.17 |
| Zn-AEI-1.9IE | 6.28 | 0.36 | 5.12 | 2.37 | 0.22 |
| Zn-AFX-1.9IE | 3.51 | 0.25 | 5.71 | 2.66 | 0.18 |

^{a}Elemental analysis was performed using EDS.
^{b}Micropore volumes were calculated from N₂ adsorption data. The results show comparable micropore pore volumes (0.18-0.21 cm³/g) for Zn-CHA7 with Zn loading lower than 6.60 Zn/U.C.
^{c}The CHA2(a) and CHA2 materials were converted from FAU zeolites and directly synthesized from amorphous gel respectively.

### Example 4. CO₂ Adsorption Performance Testing

The zeolite performance for CO₂ adsorption was tested using fixed bed column breakthrough experiments (FIG. 1). Typically, ca. 500 mg of materials was placed in a quartz tubing (6.74 mm I.D.) to form a fixed bed. First, the adsorbent bed was purged under a 20 mL·min⁻¹ flow of 5% Ar/He gas at 550° C. for 24 h before a breakthrough experiment to completely remove the water and CO₂. Upon cooling to 30° C., the gas flow was switched to the desired gas mixture (ca. 400 ppm CO₂/400 ppm Ar (internal standard) balanced by He) at a flow rate of 20 mL·min⁻¹. The outlet composition was continuously monitored using a Ametek Dymaxion Dycor mass spectrometer until complete breakthrough was achieved. After each breakthrough experiment, the packed column bed was regenerated at 550° C. for 2 h, or 100° C./60° C. for 240 min with constant 5% Ar/He flow (20 mL·min⁻¹) to test the recyclability of the materials.

TABLE 2
CO₂ adsorption results from materials.

| | Samples | Capacity (mmol/g) |
|---|---|---|
| FAU | FAU | 0.41 |
| | Zn-FAU-0.5IE | 0.02 |
| LTA | LTA | 0.34 |
| | Zn-LTA-0.5IE | 0.02 |
| AFX | AFX | 0.25 |
| | Zn-AFX-0.5IE | 0.23 |
| | Zn-AFX-1.9IE | 0.47 |
| AEI | AEI | 0.06 |
| | Zn-AEI-0.5IE | 0.28 |
| | Zn-AEI-1.9IE | 0.35 |
| CHA | Na-CHA2(a)-0.5 | 0.10 |
| | Na-CHA4-0.5 | 0.16 |
| | Na-CHA7-0.5 | 0.08 |
| | Na-CHA11-0.5 | 0.06 |
| | Na-CHA20-0.5 | 0.05 |
| | H-CHA7 | 0.03 |
| | Ni-CHA7-0.5 | 0.14 |
| | Cu-CHA7-0.5 | 0.03 |
| | Cu-CHA7-0.5IE | 0.03 |
| | Zr-CHA7-0.5 | 0.04 |
| | Fe-CHA7-0.5 | 0.04 |
| | In-CHA7-0.5 | 0.08 |
| | Zn-CHA2(a)-1.9IE^{c} | 0.27 |
| | Zn-CHA2-1.9IE2X^{c} | 0.67 |
| | Zn-CHA4-1.9IE | 0.30 |
| | Zn-CHA11-0.5 | 0.16 |
| | Zn-CHA7-0.5(H-form) | 0.20 |
| | Zn-CHA7-0.5(Na-form) | 0.18 |
| | Zn-CHA7-0.5(as synthesized) | 0.17 |
| | Zn-CHA7-0.5IE | 0.28 |
| | Zn-CHA7-1.5IE | 0.43 |
| | Zn-CHA7-1.5IE2X | 0.32 |
| | Zn-CHA7-1.9IE | 0.51 |
| | Zn-CHA20-0.5 | 0.08 |

Notes:
^{a}Zn-CHA7-0.5IE denotes CHA zeolites with a Si/Al ratio of 7 was exchanged by 0.5M Zn²⁺ aqueous solution. If IE was not included, the material was not washed with distilled water after ion exchange.
^{b}The adsorption experiments were performed at 30° C. for a gas mixture of 400 ppm CO₂/400 ppm Ar (internal standard)/He.
^{c}The CHA2(a) and CHA2 materials were converted from FAU zeolites and directly synthesized from amorphous gel, respectively. The low capacity for Zn-CHA2(a)-1.9IE is due to the small pore volume (Table 3).

### Example 5. Estimation of Desorption Kinetic Parameters Using Temperature Programmed Desorption (TPD)

The TPD experiments were carried out in the same setup as in the column breakthrough measurements. Zeolites with comparable dry mass (ca. 77.61 mg, sieved size: 160-600μm) were loaded in a quartz tubing. Prior to TPD experiments, the samples of zeolites were outgassed at 550° C. for 24 h under a 20 mL·min⁻¹ flow of 500 Ar/He gas. After the temperature was lowered to 30° C., the samples were saturated with a gas stream of 400 ppm CO₂/400 ppm Ar (internal standard)/He at a flow rate of 20 mL·min⁻¹. After saturation, TPD experiments were carried out by switching the gas stream to 5% Ar/He at a flow rate of 20 mL·min⁻¹ and heating up with a constant ramp rate (2, 5, 10, 15, 20° C.min⁻¹). Simultaneously, the signal of CO₂ was detected using a mass spectrometer with m/e=44 amu.

### Example 6. Kinetics for Desorption Using Temperature Programmed Desorption

Desorption kinetic parameters of CO2 from 13X and Zn-CHA7-1.9IE zeolites were estimated using temperature programmed desorption (TPD). The method developed by Cvetanovic and Amenomiya was applied with assumption of 1st order desorption and homogeneous adsorption surfaces. See R. J. Cvetanović, Y. Amenomiya, in Adv. Catal. (Eds.: D. D. Eley, H. Pines, P. B. Weisz), Academic Press, 1967, pp. 103-149. Generally, a linear relationship between 2 ln(Tm)−lnβ and 1/Tm can be established (equation 2).

$$2 ln ( {T}_{m} ) - ln β = \frac{{E}_{d}}{{RT}_{m}} + ln \frac{{E}_{d}}{AR}$$

Where Tₘ is the temperature of peak maximum (in K), β is the constant heating rate (in K.s⁻¹), E_{d} is the activation energy for desorption, A is pre-exponential factor for desorption, R is universal gas constant (8.314 J.K⁻¹.mol⁻¹). Therefore, the activation energy (E_{d}) and pre-exponential factor (A) for desorption can be obtained from the slope and intercept of a plot of 2 ln(Tm)−lnβ=f(1/Tm), respectively. The activation energy (E_{d}) for desorption obtained is contributed from the intrinsic activation energy for desorption, diffusion and readsorption. See R. E. Richards, L. V. C. Rees, Zeolites 1986, 6, 17-25. In particular for porous materials like zeolites, where diffusion and readsorption from the micropores are inevitable. See X. Xia, et al., J. Phys. Chem. C 2007, 111, 6000-6008.

The interaction strength between CO₂ and zeolites is often indicated using isosteric heat/entropy of adsorption, Qₛₜ or ΔH_{ads}, that is derived from two to three isotherms measured at different temperatures. In the present work, TPD experiments were performed to directly evaluate the energy required for desorption of CO₂ from zeolites. As shown in Table 4, the desorption energy is 47.93 kJ.mol⁻¹ for 13× after saturated with 400 ppm CO₂. This value is within the range of adsorption energy (46-49 kJ.mol⁻¹) for CO₂ in zeolites at zero coverage. See A. Khelifa, et al., Microporous Mesoporous Mater. 1999, 32, 199-209; T.-H. Bae, et al., Energy Environ. Sci. 2012, 6, 128-138. In the situation of physisorption the adsorption heat released from the adsorption process is the reverse of the desorption heat. See A. Nuhnen, C. Janiak, Dalton Trans. 2020, 49, 10295-10307. As CO₂ molecules primarily/exclusively physisorbed in zeolites, the results obtained from TPD also reflects the adsorption heat. Therefore, the consistency between the desorption energy measured in this work and the reported adsorption energy validates the method used herein.

TABLE 4
Kinetic parameters obtained from TPD analysis of
CO₂ desorption from FAU (zeolite 13) and Zn-CHA7-1.9IE.

| | | | | | | | E_{d} |
|---|---|---|---|---|---|---|---|
| Samples | Tₘ (K) | | | | | A (s⁻¹) | (kJ · mol⁻¹) |
| 13X | 334.50 | 349.21 | 364.17 | 373.17 | 378.14 | 4.94E4 | 47.93 |
| Zn-CHA7-1.9IE | 329.81 | 347.61 | 365.45 | 373.25 | 378.72 | 0.65e4 | 41.86 |

TABLE 5
CO₂ adsorption results from Zn-CHA7
zeolites with different Zn loadings.

| | | Capacity | | |
|---|---|---|---|---|
| Samples | Zn/U.C. | (mmol/g)^{b} | CO₂/unit cell | CO₂/Zn |
| Zn-CHA7-0 | 0 | 0.03 | 0.06 | — |
| Zn-CHA7-0.001IE^{a} | 0.16 | 0.09 | 0.19 | 1.19 |
| Zn-CHA7-0.002IE^{a} | 0.33 | 0.12 | 0.27 | 0.81 |
| Zn-CHA7-0.005IE^{a} | 0.60 | 0.20 | 0.44 | 0.74 |
| Zn-CHA7-0.01IE^{a} | 0.67 | 0.21 | 0.46 | 0.68 |
| Zn-CHA7-0.015IE^{a} | 0.98 | 0.25 | 0.55 | 0.56 |
| Zn-CHA7-0.02IE^{a} | 1.21 | 0.27 | 0.60 | 0.49 |
| Zn-CHA7-0.05IE^{a} | 1.37 | 0.30 | 0.68 | 0.50 |
| Zn-CHA7-0.5IE^{a} | 2.00 | 0.40 | 0.92 | 0.46 |
| Zn-CHA7-1.9IE | 2.60 | 0.51 | 1.21 | 0.44 |
| Zn-CHA7-1.5IE | 2.72 | 0.43 | 1.02 | 0.37 |
| Zn-CHA7-0.5IE | 3.92 | 0.28 | 0.69 | 0.28 |
| Zn-CHA7-0.5 | 6.60 | 0.17 | 0.48 | 0.07 |

Notes:
^{a}Ion exchange experiments were performed in Zn²⁺ aqueous solution with pH adjusted to 4.92 by adding 0.1M HCl aqueous solution. If not labeled, pH was not controlled for those materials during ion exchanges.
^{b}The adsorption experiments were performed at 30° C. for a gas mixture of 400 ppm CO₂/400 ppm Ar (internal standard)/He.

### Example 7. Zinc State and Location/Environment in Zn-CHA Zeolites

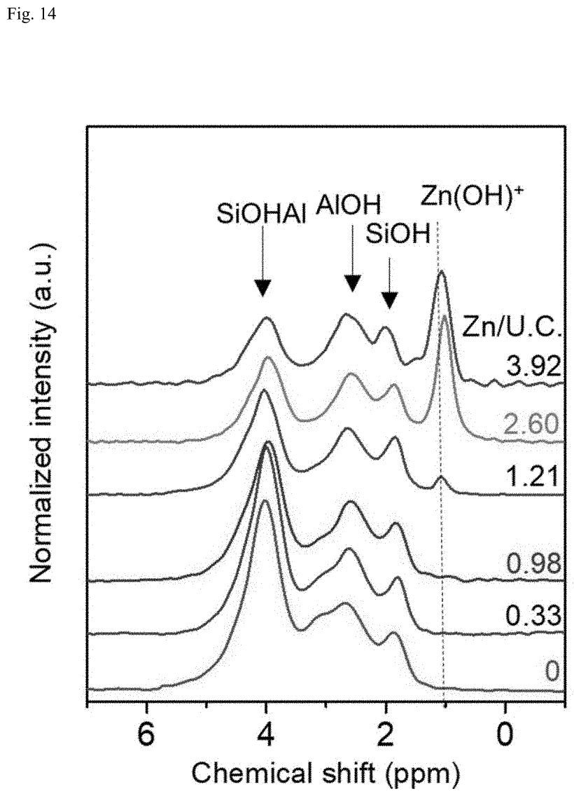

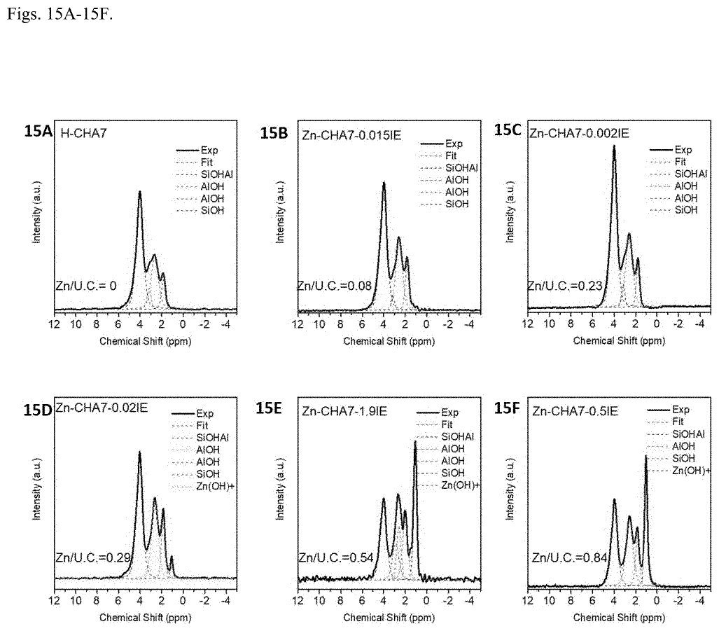

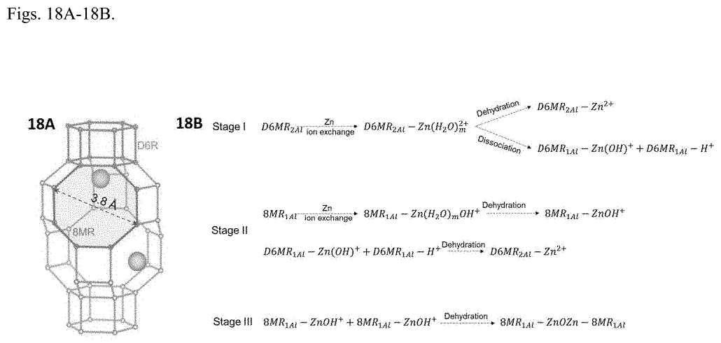

The state of the Zn ions was qualitatively analyzed by studying the OH stretch region (FIG. 13) of the FT-IR spectra and the ¹H MAS NMR spectra (FIGS. 14 and 15). In the H-CHA sample, the Brönsted acid sites (BAS), extra framework Al—OH and silanol groups groups are identified by the three set of features in the O—H region in the FT-IR spectra at 3610 and 3588 cm⁻¹, 3650 cm⁻¹, and 3732 and 3745 cm⁻¹, respectively. See J. Song, et al, ACS Catal. 2017, 7, 8214-8227. Correspondingly, three major ¹H NMR signals (FIG. 14) are observed at 4.0, 2.6 and 1.8 ppm, assigned to Brønsted acidic protons (SiOHAl), extra-framework OH groups (AlOH) and non-acidic silanol groups (SiOH), respectively. See Z. Zhao, et al., Catal. Sci. Technol. 2019, 9, 241-251. The successful ion exchange with Zn ions is demonstrated by the gradual decrease of the bands for BAS as a function of Zn density in the Zn-CHA samples, as shown in FIGS. 13 and 14. Upon Zn exchange at stage I, a new feature appears in FT-IR spectra at 3665 cm⁻¹ (FIG. 13) accompanied by the band at 902 cm⁻¹ (FIG. 30b). On the basis of previous reports of Cu-SSZ-13 zeolites, the OH band at 3665 cm⁻¹ is assigned to the harmonic O—H stretch of Zn(OH)⁺. See E. Borfecchia, et al., Chem. Sci. 2014, 6, 548-563. This is further confirmed by ¹H MAS NMR, where a weak signal at 1.08 ppm resonance at stage I is observed. See G. Qi, et al., Angew. Chem. Int. Ed 2016, 55, 15826-15830. It has been demonstrated that the paired aluminum sites in the D6MRs are energetically favorable for accommodating isolated Z²⁺+, and these sites saturate before remaining isolated aluminum sites are populated with Z(OH)⁺. See C. Paolucci, A. A. et al., J. Am. Chem. Soc. 2016, 138, 6028-6048. Therefore, excluded is the possibility that the Zn(OH)⁺ at the stage I is from the dehydration of Zn(H₂O)ₙ(OH)⁺, that replaces isolated aluminum sites in CHA. Furthermore, another reported approach of the Z(OH)⁺ formation is the dissociation of Z²⁺ (H₂O)ₙ upon calcination. See C. Paolucci, A. A. et al., J. Am. Chem. Soc. 2016, 138, 6028-6048; E. Borfecchia, et al., Chem. Sci. 2014, 6, 548-563. Indeed, it has been demonstrated that the Zn²⁺ in Zn-exchanged zeolites can dissociate water molecules under mild conditions and gives enhanced Brönsted acidity by Zn²⁺ favoring proton transfer reactions. See G. Qi, et al., Angew. Chem. Int. Ed. 2016, 55, 15826-15830; A. N. Subbotin, et al., Kinet. Catal. 2013, 54, 744-748. Therefore, the possibility exists that Zn ions at stage I are initially stabilized as Zn²⁺(H₂O)ₙ in the D6MRs (FIG. 18), that are either directly dehydrated to Zn²⁺ or reduced to Zn(OH)*upon calcination depending on the type of paired aluminum sites in the 6MRs. See K. Mlekodaj, et al., J. Phys. Chem. C 2019, 123, 7968-7987. For stage II and III with Zn ions higher than 1.20 Zn/u.c., the isolated aluminum sites located at the 8-membered rings (8MRs) are normally exchanged by monovalent complexes, i.e., Zn(H₂O)ₙ(OH)⁺. See C. Paolucci, A. A. et al., J. Am. Chem. Soc. 2016, 138, 6028-6048; E. Borfecchia, et al., Chem. Sci. 2014, 6, 548-563; Z. Zhao, et al., Appl. Catal. B Environ. 2017, 217, 421-428. In this case, the formation of Zn(OH)⁺ upon dehydration does not require any water dissociation, and the concentration of Brønsted sites in the dehydrated material are consistent with the total exchange level corresponding to Zn(OH)⁺/Al³⁺=1.

Further, the fraction of Zn²⁺ and Zn(OH)⁺ was quantitatively calculated using the residual H⁺ density obtained from the ¹H NMR results (FIG. 15 and Table 6) and the Zn/Al ratio from elemental analysis.

TABLE 6
Concentration of Brønsted acidic protons (SiOHAl) on
representative samples determined by measuring the integral area
of the ca. 4.0 ppm signal in the ¹H MAS NMR spectra.

| Samples | SiOHAl (mmol/g) |
|---|---|
| H-CHA7 | 1.264 |
| Zn-CHA7-0.002IE^{a} | 1.097 |
| Zn-CHA7-0.015IE^{a} | 0.824 |
| Zn-CHA7-0.02IE^{a} | 0.732 |
| Zn-CHA7-1.9IE | 0.330 |
| Zn-CHA7-0.5IE | 0.106 |

^{a}Ion exchange experiments were performed in Zn²⁺ aqueous solution with pH adjusted to 4.92 by adding 0.1M HCl aqueous solution. If not labeled, pH was not controlled for those materials during ion exchanges.

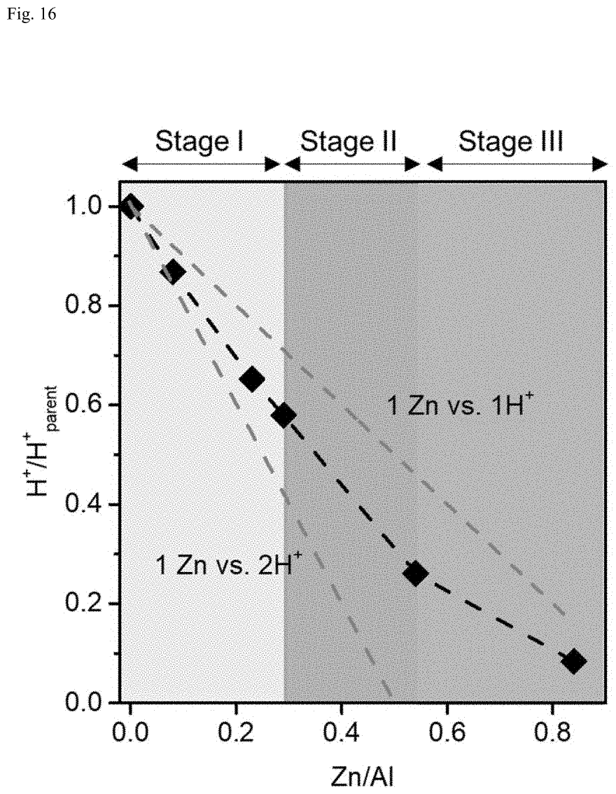

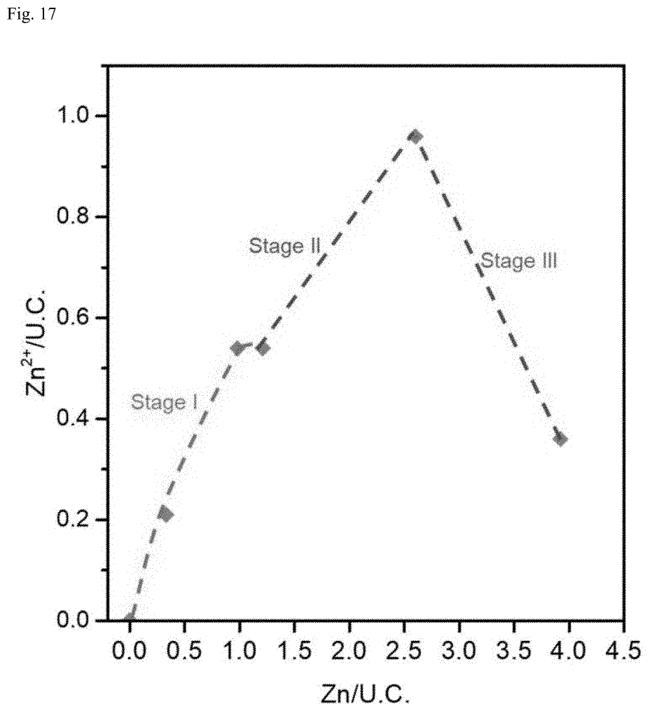

As the data shown in FIG. 16, three stages were clearly observed for the residual H⁺ density vs. Zn/Al in the Zn-CHA7 samples. Specifically, Zn ions primarily exchange two H⁺ sites at stage I, while they gradually replace one H⁺ starting from stage II and mainly consumes one H⁺ per Zn ion at stage III. This reflects the formation of different Zn species in Zn-CHA7 at the three stages. Calculation of the fraction of Zn species (Table 7) confirms that Zn²⁺ is the main species at stage I. It should be noted that a continuous increase of overall Zn²⁺ (FIG. 17) is observed with Zn siting in the 8MRs.

TABLE 7
Chemical compositions and CO₂ capacities of the representative samples.

| | | Znₜₒₜ/ | Zn²⁺/ | Zn(OH)⁺/ | Zn²⁺/ | CO₂/ | CO₂/ |
|---|---|---|---|---|---|---|---|
| Samples | Zn/Al^{b} | U.C.^{c} | Znₜₒₜ^{d} | Znₜₒₜ^{d} | U.C. | U.C. | Zn²⁺ |
| H-CHA7 | 0.00 | 0.00 | 0.00 | 0.00 | 0.00 | 0.06 | — |
| Zn-CHA7-0.002IE^{a} | 0.08 | 0.33 | 0.65 | 0.35 | 0.21 | 0.27 | 1.26 |
| Zn-CHA7-0.015IE^{a} | 0.23 | 0.98 | 0.55 | 0.45 | 0.54 | 0.55 | 1.03 |
| Zn-CHA7-0.02IE^{a} | 0.29 | 1.21 | 0.45 | 0.55 | 0.54 | 0.60 | 1.11 |
| Zn-CHA7-1.9IE | 0.54 | 2.60 | 0.37 | 0.63 | 0.96 | 1.21 | 1.26 |
| Zn-CHA7-0.5IE | 0.84 | 3.92 | 0.09 | 0.91 | 0.36 | 0.69 | 1.94 |

^{a}Ion exchange experiments were performed in Zn²⁺ aqueous solution with pH adjusted to 4.92 by adding 0.1M HCl aqueous solution. If not labeled, pH was not controlled for those materials during ion exchanges.
^{b}Measured by EDS mapping of the area containing at least 100 crystals.
^{c}Total Zn ions per unit cell SSZ-13 calculated from the EDS results.
^{d}Zn²⁺ or Zn(OH)⁺ cations per unit cell SSZ-13 calculated from the EDS results and ¹H density in Table 6.

Previous studies suggest that paired aluminum sites are preferentially located in the D6MRs in the CHA cages for SSZ-13 zeolites synthesized using methods similar to this work with Na⁺as the inorganic mineralizer. See J. R. Di Iorio, et al., J. Am. Chem. Soc. 2020, 142, 4807-4819; C. Paolucci, A. A. et al., J. Am. Chem. Soc. 2016, 138, 6028-6048. Moreover, Co²⁺ titration of the density of paired aluminum sites in the D6MRs shows a CO₂⁺/Al ratio of 0.20 (Table 8). See J. R. Di Iorio, et al., J. Am. Chem. Soc. 2020, 142, 4807-4819.

TABLE 8
Comparison of paired sites densities in the D6MRs in the CHA cages
in CHA7 and CHA(K)7 zeolites determined by Co²⁺ titration.

| Material | Co/Al |
|---|---|
| CHA7 | 0.20 ± 0.03 |
| CHA(K)7 | 0.02 ± 0.02 |

This value is the same to the highest Zn²⁺/Al obtained at the end of stage II. Therefore, the pre-formed Zn(OH)⁺in the D6MRs may then be converted into Zn²⁺. This transformation is responsible for the increase of Zn²⁺ at stage II. Thus, it contributes to a relatively constant fraction of Zn²⁺ species as well as adsorption efficiency. Although Na⁺ can also stabilize paired aluminum sites in the 8MRs, see J. R. Di Iorio, et al., J. Am. Chem. Soc. 2020, 142, 4807-4819, these sites would be excluded for accommodating Zn²⁺ in the present work for the following reasons: 1) The paired aluminum density in the D6MRs is equal to the highest Zn²⁺ density obtained; 2) Using K⁺ directed CHA as a control, it was demonstrated that Zn²⁺ in the 8MRs is likely inactive for CO₂ adsorption, while a sharp increase of CO₂ capacity is observed at stage II in FIG. 30a for Zn-CHA7; 3) It was well-documented that the 8MRs favor the formation of Z²⁺(OH) species for extra framework cations in the Na⁺ directed CHA zeolites, e.g., copper cation. See C. Paolucci, A. A. et al., J. Am. Chem. Soc. 2016, 138, 6028-6048; E. Borfecchia, et al., Chem. Sci. 2014, 6, 548-563; A. Godiksen, et al., J. Phys. Chem. C 2014, 118, 23126-23138; T. V. W. Janssens, et al., ACS Catal. 2015, 5, 2832-2845. Further increase of Zn loading at stage III results in the introduction of a significant amount of Zn(H₂O)ₙ(OH)⁺ at the 8MRs, as evidence by the trend of the residue H⁺ density (FIG. 16). Those species might preferably condense to Zn—O—Zn during calcination rather than converting the Zn(OH)⁺ in the D6MRs as at stage II, as demonstrated by a sharp decline of Zn²⁺ at 6MRs (FIG. 17) as well as the UV-Vis results (FIG. 30c). Based on these results, a plausible speciation mechanism for Zn ions depending on the density in CHA cages is presented in FIG. 18.

### Example 8. Control Experiments for the Identification of Adsorption Sites for CO₂ in Zn-CHA Zeolites

Control experiments were performed to further identify the adsorption sites in Zn-CHA zeolites. The state and location/environment of Zn ions are crucial for CO₂ adsorption. To further study this, CHA zeolites were prepared with a Si/Al of ca. 7 with the K⁺ as the mineralizer, denotated as CHA(K)7. Gounder et al. has demonstrated the predominate presence of isolated aluminum in the D6MRs in K-directed CHA with a Si/Al of 10 and that this material is unable to coordinate bivalent cations in the D6MRs. See J. R. Di Iorio, et al., J. Am. Chem. Soc. 2020, 142, 4807-4819. CHA(K)7 zeolites were prepared using the same method. Co²⁺-titration showed (Table 8) a Co/Al ratio of 0.02±0.02, suggesting that the CHA(K)7 is free of paired aluminum sites in the D6MRs.

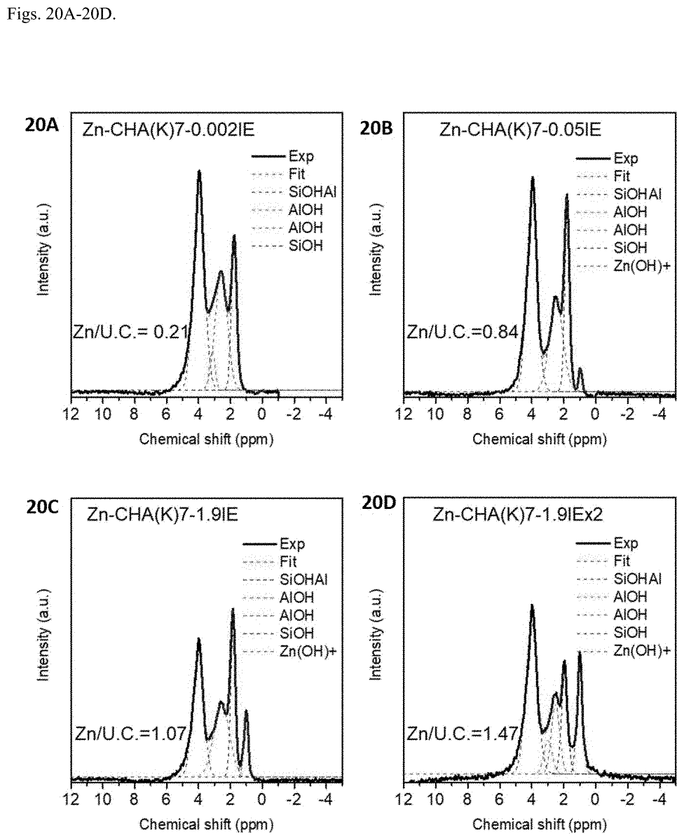

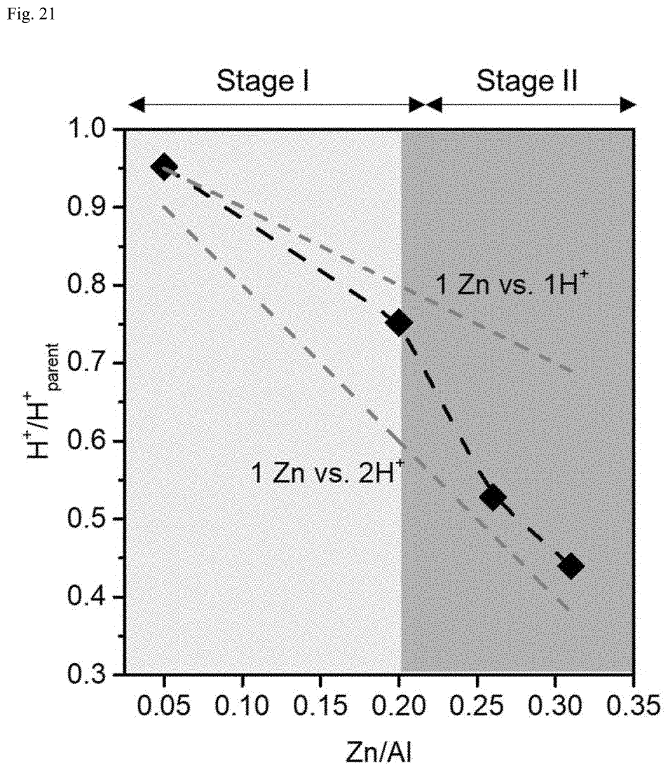

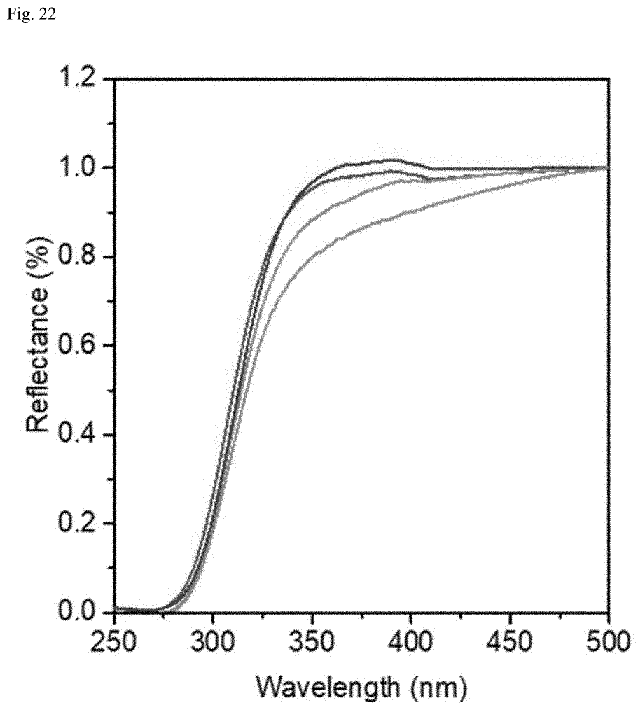

Similar to the CHA7 material, Zn ions were exchanged into CHA(K)7 with various loadings. FT-IR spectra (FIG. 19a) of the T-O-T vibration region shows that Zn ions are firstly located at the D6MRs in the CHA cage (Zn/U.C.<0.84), and further increase of Zn ions leads to the loading of additional Zn ions at the 8MRs. The state of Zn species was quantified using EDS elemental analysis and residual proton density from ¹H MAS NMR (FIG. 20). As shown in FIG. 21, Zn ions primarily replace one H⁺ and two H⁺ at stages I and II, respectively. Calculation of the fraction of Zn species (Table 9) suggest that Zn ions incorporated into the CHA(K)7 are exclusively as Zn(OH)⁺ in the D6MRs, attributed to the dominance of isolated aluminum sites (Table 8). The presence of Zn(OH)⁺ was corroborated by the OH region from the FT-IR spectra (FIG. 19b) with a new band appearance at 3665 cm⁻¹ as well as the ¹H NMR resonance at 1.08 ppm upon Zn loading. Quantitative analysis also shows that Zn ions in the 8MRs in the CHA(K)7 sample are primarily as Zn²⁺ (Table 9). Indeed, the possible existence of paired aluminum sites in 8MRs in the K-directed CHA was predicted by Gounder et al. from simulations. See J. R. Di Iorio, et al., J. Am. Chem. Soc. 2020, 142, 4807-4819. The present work experimentally confirms this predication. Additionally, the absence of the O₂→Zn²⁺ ligand-to-metal charge transfer transition band at 360 nm in the UV-Vis DRS spectra (FIG. 22) for all samples demonstrates that there is no Zn—O—Zn species formed in Zn-CHA(K)7 materials. See N. Koike, et al., Chem.-Eur. J. 2018, 24, 808-812. Therefore, by varying the Zn loadings in the CHA(K)7 material, Zn ions were introduced as Zn(OH)*and Zn²⁺ in the D6MRs and 8MRs, respectively. This is the opposite to the case in the Na⁺ directed CHA materials, where Zn²⁺ and Zn(OH)+ in the D6MRs and 8MRs, respectively.

TABLE 9
Chemical compositions and CO₂ capacities of the representative samples.

| | | SiOH | | | | | | | CO₂ | |
|---|---|---|---|---|---|---|---|---|---|---|
| | Bulk | Al | Zn/ | Zn/ | Zn(OH)⁺/ | Zn²⁺/ | Zn(OH)⁺/ | Zn²⁺/ | capacity | CO₂/ |
| Samples | Si/Al^{b} | (mmol/g)^{c} | Al^{b} | U.C.^{d} | Znₜₒₜ^{e} | Znₜₒₜ^{e} | U.C. | U.C. | (mmol/g) | Zn |
| Zn-CHA(K)7-0.002IE^{a} | 7.50 | 1.19 | 0.05 | 0.21 | 1.00 | 0.00 | 0.21 | 0.00 | 0.12 | 1.18 |
| Zn-CHA(K)7-0.05IE^{a} | 7.59 | 0.94 | 0.20 | 0.84 | 0.96 | 0.05 | 0.80 | 0.04 | 0.28 | 0.65 |
| Zn-CHA(K)7-1.9IE | 7.78 | 0.66 | 0.26 | 1.07 | 0.79 | 0.21 | 0.84 | 0.23 | 0.29 | 0.51 |
| Zn-CHA(K)7-1.9IE2X | 6.61 | 0.55 | 0.31 | 1.47 | 0.75 | 0.25 | 1.10 | 0.37 | 0.30 | 0.44 |

^{a}Ion exchange experiments were performed in Zn²⁺ aqueous solution with pH adjusted to 4.92 by adding 0.1M HCl aqueous solution. If not labeled, pH was not controlled for those materials during ion exchanges.
^{b}Measured by EDS mapping of the area containing at least 100 crystals.
^{c}Calculated from ¹H MAS NMR spectra.
^{d}Total Zn ions per unit cell CHA calculated from the EDS results.
^{e}Zn²⁺ or Zn(OH)⁺ ions per unit cell SSZ-13 calculated from the EDS results and ¹H density in Table 8.

The CO₂ adsorption performance was examined for Zn-CHA(K)7 zeolites with various Zn loadings. The results (Table 9 and FIG. 23a) show that the capacity increased quickly upon loading Zn at D6MRs (Zn/U.C.<0.84). Correspondingly, the adsorption efficiency (FIG. 23b), i.e., CO₂ molecule per Zn, decreased to 0.65 for Zn at the D6MRs. Therefore, these results suggest that only limited fraction of Zn(OH)⁺ at D6MRs in CHA cages can adsorb CO₂ molecules. This could be attributed to the heterogeneous nature of the Al sites in CHA cages, leading to different environments/energies for the same extra framework species. See K. Mlekodaj, et al., J. Phys. Chem. C 2019, 123, 7968-7987. However, locating Zn²⁺ ions at the 8MRs by further increase of Zn density (Zn/U.C.>1.07) only resulted in a slight increase of CO₂ capacity from 0.28 to 0.30 mmol/g, indicating that that Zn²⁺ at the 8MRs are free of CO₂ molecules. It has been demonstrated that Zn²⁺ in the D6MRs is highly efficient for CO₂ adsorption. This altogether demonstrates the significance of Zn state and location for the high CO₂ adsorption performance.

With this discussion, one may argue that Zn(OH)⁺ could be the primary sites for CO₂ molecules adsorbed in CHA cages. However, it should be noted that the adsorption capacity for CO₂ in Zn-CHA7 and Zn-CHA(K)7 are greatly different, with the former showing almost two-fold capacity (0.51 vs. 0.28 mmol/g) under the same ion exchange condition. Moreover, the present work shows that all Zn²⁺ in the D6MRs are active adsorption sites for CO₂ molecules, while only limited fraction Zn(OH)⁺ in the D6MRs are able to adsorb CO₂. Therefore, these results suggest that Zn²⁺ ions in the D6MRs are the primary adsorption sites and that Zn(OH)⁺ species at D6MRs are extra possible sites. Therefore the Al distribution in the framework with maximizing Al located in D6MRs as 2Al sites has a critical effect on enhanced CO₂ adsorption performance.

As those skilled in the art will appreciate, numerous modifications and variations of the present invention are possible in light of these teachings, and all such are contemplated hereby. All of the references cited herein are incorporated by reference herein for all purposes, or at least for their teachings in the context presented.

In some embodiments, the disclosure is directed to the following aspects:
Aspect 1. A metal ion-doped crystalline microporous aluminosilicate composition comprising:
   a. a three-dimensionally aluminosilicate framework containing α-cages interconnected by 8-MR openings that are appropriately sized for accommodating the molecular dimensions of carbon dioxide (3.3 Å);
   b. the framework further comprising d6r (or D6MR) composite building blocks having 6-membered rings that face (are part of) the α-cage of the framework;
   c. wherein the crystalline microporous aluminosilicate contains metal ions, preferably transition metal ions, more preferably zinc ions, positioned within the framework lattice; and
   d. wherein the metal ion-doped crystalline microporous aluminosilicate composition adsorbs carbon dioxide more than the otherwise same crystalline microporous aluminosilicate composition that does not contain the metal ions when subjected to the same gaseous source mixture under the same conditions.
Aspect 2. The metal ion-doped crystalline microporous aluminosilicate composition of aspect 1, wherein the framework has a AEI, AFT, AFX, CHA, EAB, KFI, LEV, or SAS topology, preferably a AEI, AFX, or CHA (e.g., SSZ-13) topology.
Aspect 3. The metal ion-doped crystalline microporous aluminosilicate composition of aspect 1 or 2, which has an Si:Al atomic ratio in a range of from 1:1 to 20:1, or any one of the ranges defined elsewhere herein, including, for example in a range of from 5.5:1 to 8.5:1 or from 6.5:1 to 7.5:1, or from 7.5:1 to 8.5:1.
Aspect 4. The metal ion-doped crystalline microporous aluminosilicate composition of any one of aspects 1 to 3, wherein the metal ions positioned within the framework lattice comprise a transition metal ion, preferably iron, cobalt, nickel, copper, zinc, or silver, more preferably zinc.
Aspect 5. The metal ion-doped crystalline microporous aluminosilicate composition of any one of aspects 1 to 4, wherein the (transition) metal ions are present within the framework lattice in a ratio of from 0.5 to 6 metal ions per unit cell, or any one of the ranges defined elsewhere herein, including, for example, from 1.5 to 4 (transition) metal ions per unit cell or from about 2.25 to 3 transition metal ions per unit cell.
Aspect 6. The metal ion-doped crystalline microporous aluminosilicate composition of any one of aspects 1 to 5 that contain or have the capacity to contain carbon dioxide in a range of from 0.5 to 0.55 to 1.3 mmol adsorbed CO₂ per unit cell, when the metal ion-doped crystalline microporous aluminosilicate composition is exposed to a gas source having (a) a total pressure in a range of from 50 kPa to 125 kPa, or any one of the ranges or values defined elsewhere herein, for example about 100 kPa and (b) a CO₂ content in a range of from 350 to 425 ppm, or any one of the ranges or values defined elsewhere herein, for example about 400 ppm.
Aspect 7. The metal ion-doped crystalline microporous aluminosilicate composition of any one of aspects 1 to 6 that contain carbon dioxide, wherein the carbon dioxide is desorbed at a temperature of less than 130° C., less than 125° C., less than 120° C., less than 115° C., less than 110° C., or less than 100° C.
Aspect 8. The metal ion-doped crystalline microporous aluminosilicate composition of any one of aspects 1 to 7 that adsorb less than 15 wt %, less than 10 wt %, or less than 5 wt % water, relative to the weight of the anhydrous metal ion-doped crystalline microporous aluminosilicate composition.
Aspect 9. The metal ion-doped crystalline microporous aluminosilicate composition of any one of aspects 1 to 8 that contains water, wherein the water desorbs at a temperature of less than 250° C., less than 225° C., less than 200° C., less than 175° C., or less than 150° C.
Aspect 10. A method of preparing a metal ion-doped crystalline microporous aluminosilicate composition of any one of aspects 1 to 9, the method comprising contacting a precursor crystalline microporous aluminosilicate with an aqueous solution of a salt of a suitable metal ion, and optionally rinsing the resulting metal ion-doped crystalline microporous aluminosilicate with water and/or optionally drying the metal ion-doped crystalline microporous aluminosilicate, wherein the salt is any one of the salts described elsewhere herein, and the method steps are optionally those described herein.
Aspect 11. A method of capturing carbon dioxide from a gaseous source mixture, the method comprising contacting the metal ion-doped crystalline microporous aluminosilicate of any one of aspects 1 to 9 with the gaseous source mixture so as to adsorb the carbon dioxide into the metal ion-doped crystalline microporous aluminosilicate, and optionally desorbing the carbon dioxide from the carbon-dioxide laden metal ion-doped crystalline microporous aluminosilicate, preferably under a set of conditions set forth elsewhere herein.
Aspect 12. The method of aspect 11, wherein the contacting of the metal ion-doped crystalline microporous aluminosilicate with the gaseous source mixture is done in the absence or without the use of an added desiccant.
Aspect 13. The method of aspect 11, wherein the contacting of the metal ion-doped crystalline microporous aluminosilicate with the gaseous source mixture is done in the presence or with the use of an added desiccant.
Aspect 14. A metal ion-doped crystalline microporous aluminosilicate composition comprising:
   (a) a three-dimensionally aluminosilicate framework containing α-cages interconnected by 8-MR openings that are appropriately sized for accommodating the molecular dimensions of carbon dioxide (3.3 Å);
   (b) the framework further comprising d6r (or D6MR) composite building blocks having 6-membered rings that face (are part of) the α-cage of the framework;
   wherein the crystalline microporous aluminosilicate contains metal ions, preferably transition metal ions, more preferably zinc ions, positioned within the framework lattice; and
   wherein the metal ion-doped crystalline microporous aluminosilicate composition adsorbs carbon dioxide more than the otherwise same crystalline microporous aluminosilicate composition that does not contain the metal ions when subjected to the same gaseous source mixture under the same conditions.
Aspect 15. The metal ion-doped crystalline microporous aluminosilicate composition of aspect 14, wherein the framework has a AEI, AFT, AFX, CHA, EAB, KFI, LEV, or SAS topology, preferably a AEI, AFX, or CHA (e.g., SSZ-13) topology.
Aspect 16. The metal ion-doped crystalline microporous aluminosilicate composition of aspect 14 or 15, which has an Si:Al atomic ratio in a range of from 1:1 to 20:1, or any one of the ranges defined elsewhere herein, including, for example in a range of from 5.5:1 to 8.5:1 or from 6.5:1 to 7.5:1, or from 7.5:1 to 8.5:1.
Aspect 17. The metal ion-doped crystalline microporous aluminosilicate composition of any one of aspects 14 to 16, wherein the metal ions positioned within the framework lattice comprise a transition metal ion, preferably iron, cobalt, nickel, copper, zinc, or silver, more preferably zinc.
Aspect 18. The metal ion-doped crystalline microporous aluminosilicate composition of any one of aspects 14 to 17, wherein the (transition) metal ions are present within the framework lattice in a ratio of from 0.5 to 6 metal ions per unit cell, or any one of the ranges defined elsewhere herein, including, for example, from 1.5 to 4 (transition) metal ions per unit cell or from about 2.25 to 3 transition metal ions per unit cell.
Aspect 19. The metal ion-doped crystalline microporous aluminosilicate composition of any one of aspects 14 to 18 that contain or have the capacity to contain carbon dioxide in a range of from 0.5 to 0.55 to 1.3 mmol adsorbed CO₂ per unit cell, when the metal ion-doped crystalline microporous aluminosilicate composition is exposed to a gas source having (a) a total pressure in a range of from 50 kPa to 125 kPa, or any one of the ranges or values defined elsewhere herein, for example about 100 kPa and (b) a CO₂ content in a range of from 350 to 425 ppm, or any one of the ranges or values defined elsewhere herein, for example about 400 ppm.
Aspect 20. The metal ion-doped crystalline microporous aluminosilicate composition of any one of aspects 14 to 19 that contain carbon dioxide, wherein the carbon dioxide is desorbed at a temperature of less than 130° C., less than 125° C., less than 120° C., less than 115° C., less than 110° C., or less than 100° C.
Aspect 21. The metal ion-doped crystalline microporous aluminosilicate composition of any one of aspects 14 to 20 that adsorb less than 15 wt %, less than 10 wt %, or less than 5 wt % water, relative to the weight of the anhydrous metal ion-doped crystalline microporous aluminosilicate composition.
Aspect 22. The metal ion-doped crystalline microporous aluminosilicate composition of any one of aspects 14 to 21 that contains water, wherein the water desorbs at a temperature of less than 250° C., less than 225° C., less than 200° C., less than 175° C., or less than 150° C.
Aspect 23. A method of preparing a metal ion-doped crystalline microporous aluminosilicate composition of any one of aspects 14 to 22, the method comprising contacting a precursor crystalline microporous aluminosilicate with an aqueous solution of a salt of a suitable metal ion, and optionally rinsing the resulting metal ion-doped crystalline microporous aluminosilicate with water and/or optionally drying the metal ion-doped crystalline microporous aluminosilicate, wherein the salt is any one of the salts described elsewhere herein, and the method steps are optionally those described herein.
Aspect 24. A method of capturing carbon dioxide from a gaseous source mixture, the method comprising contacting the metal ion-doped crystalline microporous aluminosilicate of any one of aspects 14 to 22 with the gaseous source mixture so as to adsorb the carbon dioxide into the metal ion-doped crystalline microporous aluminosilicate, and optionally desorbing the carbon dioxide from the carbon-dioxide laden metal ion-doped crystalline microporous aluminosilicate, preferably under a set of conditions set forth elsewhere herein.
Aspect 25. The method of aspect 24, wherein the contacting of the metal ion-doped crystalline microporous aluminosilicate with the gaseous source mixture is done in the absence or without the use of an added desiccant.
Aspect 26. The method of aspect 24, wherein the contacting of the metal ion-doped crystalline microporous aluminosilicate with the gaseous source mixture is done in the presence or with the use of an added desiccant.
Aspect 27. A metal ion-doped crystalline microporous aluminosilicate composition comprising:
   (a) a three-dimensional aluminosilicate framework containing α-cages with 8-MR openings that are sized to accommodate the molecular dimensions of carbon dioxide (3.3 Å);
   (b) the framework further comprising d6r (or D6MR) composite building blocks having 6-membered rings that face (are part of) or connect the α-cage of the framework;
   wherein the crystalline microporous aluminosilicate contains 1.2 to 8 metal ions per unit cell, wherein the ratio of metal ions to aluminum within the unit cell is from 0.33 to 0.85; and
   wherein the metal ion-doped crystalline microporous aluminosilicate composition adsorbs carbon dioxide when exposed to a gaseous mixture comprising carbon dioxide.
Aspect 28. The metal ion-doped crystalline microporous aluminosilicate composition of aspect 27, wherein the three-dimensional aluminosilicate framework has an AEI, AFT, AFX, CHA, EAB, KFI, LEV, or SAS topology.
Aspect 29. The metal ion-doped crystalline microporous aluminosilicate composition of aspect 28, wherein the three-dimensional aluminosilicate framework has an AEI, AFX, or CHA topology.
Aspect 30. The metal ion-doped crystalline microporous aluminosilicate composition of aspect 29, wherein the three-dimensional aluminosilicate framework has an AEI topology.
Aspect 31. The metal ion-doped crystalline microporous aluminosilicate composition of aspect 29, wherein the three-dimensional aluminosilicate framework has an AFX topology.
Aspect 32. The metal ion-doped crystalline microporous aluminosilicate composition of aspect 29, wherein the three-dimensional aluminosilicate framework has a CHA topology.
Aspect 33. The metal ion-doped crystalline microporous aluminosilicate composition of aspect 32, wherein the CHA is synthetic CHA.
Aspect 34. The metal ion-doped crystalline microporous aluminosilicate composition of any one of aspects 27-33, wherein the composition has a Si:Al atomic ratio in a range of from 1:1 to 20:1.
Aspect 35. The metal ion-doped crystalline microporous aluminosilicate composition of any one of aspects 27-34, wherein the composition has a Si:Al atomic ratio in a range of from 2:1 to 8.5:1, or from 2:1 to 7.5:1, or from 5.5:1 to 8.5:1, or from 6.5:1 to 7.5:1, or from 7.5:1 to 8.5:1.
Aspect 36. The metal ion-doped crystalline microporous aluminosilicate composition aspect 35, wherein the composition has a Si:Al atomic ratio in a range of from 5.5:1 to 8.5:1, or from 6.5:1 to 7.5:1, or from 7.5:1 to 8.5:1.
Aspect 37. The metal ion-doped crystalline microporous aluminosilicate composition of aspect 35, wherein the composition has a Si:Al atomic ratio in a range of from 2:1 to 8.5:1.
Aspect 38. The metal ion-doped crystalline microporous aluminosilicate composition of aspect 37, wherein the composition has a Si:Al atomic ratio in a range of from 2:1 to 7.5:1.
Aspect 39. The metal ion-doped crystalline microporous aluminosilicate composition of aspect 38, wherein the composition has a Si:Al atomic ratio of about 2:1.
Aspect 40. The metal ion-doped crystalline microporous aluminosilicate composition of aspect 35, wherein the composition has a Si:Al atomic ratio in a range of from 5.5:1 to 8.5:1.
Aspect 41. The metal ion-doped crystalline microporous aluminosilicate composition of aspect 40, wherein the composition has a Si:Al atomic ratio in a range of from 6.5:1 to 7.5:1.
Aspect 42. The metal ion-doped crystalline microporous aluminosilicate composition of aspect 40, wherein the composition has a Si:Al atomic ratio in a range of from 7.5:1 to 8.5:1.
Aspect 43. The metal ion-doped crystalline microporous aluminosilicate composition of any one of aspects 27-42, wherein the metal ions are positioned within the lattice of the three-dimensional aluminosilicate framework.
Aspect 44. The composition according to aspect 43, wherein the (transition) metal ions are iron, cobalt, nickel, copper, zinc, or silver.
Aspect 45. The composition according to aspect 44, wherein the metal ions are zinc.
Aspect 46. The metal ion-doped crystalline microporous aluminosilicate composition of any one of aspects 27-45, wherein the metal ions are present within the framework lattice in a ratio of from 7 to 8 metal ions per unit cell.
Aspect 47. The metal ion-doped crystalline microporous aluminosilicate composition of any one of any one aspects 27-46, wherein the metal ions are present within the framework lattice in a ratio of from 1.21 to 2.6 metal ions per unit cell.
Aspect 48. The metal ion-doped crystalline microporous aluminosilicate composition any one aspects 27-46, wherein the metal ions are present within the framework lattice in a ratio of from 1.5 to 4 metal ions per unit cell.
Aspect 49. The metal ion-doped crystalline microporous aluminosilicate composition of any one aspects 27-46, wherein the metal ions are present within the framework lattice in a ratio of from about 2.25 to 3 metal ions per unit cell.
Aspect 50. The metal ion-doped crystalline microporous aluminosilicate composition of any one of aspects 27-49, wherein the ratio of metal ions to aluminum within the unit cell is from 0.34 to 0.58.
Aspect 51. The metal ion-doped crystalline microporous aluminosilicate composition of any one of aspects 27-49, wherein the ratio of metal ions to aluminum within the unit cell is from 0.59 to 0.85.
Aspect 52. The metal ion-doped crystalline microporous aluminosilicate composition of any one of aspects 27-51, wherein the composition contains, or has the capacity to contain, carbon dioxide in a range of from 0.3 to 1.7 molecules adsorbed CO₂ per unit cell.
Aspect 53. The metal ion-doped crystalline microporous aluminosilicate composition of aspect 52, wherein the composition contains, or has the capacity to contain, carbon dioxide in a range of from 0.3 to 1.3 molecules adsorbed CO₂ per unit cell.
Aspect 54. The metal ion-doped crystalline microporous aluminosilicate composition of aspect 53, wherein the composition contains, or has the capacity to contain, carbon dioxide in a range of from 0.4 to 0.6 molecules adsorbed CO₂ per unit cell.
Aspect 55. The metal ion-doped crystalline microporous aluminosilicate composition of aspect 52, wherein the composition contains, or has the capacity to contain, carbon dioxide in a range of from 0.6 to 1.25 molecules adsorbed CO₂ per unit cell.
Aspect 56. The metal ion-doped crystalline microporous aluminosilicate composition of any one of aspects 27-52, wherein exposure of the crystalline microporous aluminosilicate composition to a gas source having (a) a total pressure in a range of from 50 kPa to 125 kPa, and (b) a CO₂ content in a range of from 350 to 425 ppm, results in adsorption of carbon dioxide in a range of from 0.3 to 1.7 molecules adsorbed CO₂ per unit cell.
Aspect 57. The metal ion-doped crystalline microporous aluminosilicate composition of aspect 56, wherein exposure of the crystalline microporous aluminosilicate composition to a gas source having (a) a total pressure in a range of from 50 kPa to 125 kPa, and (b) a CO₂ content in a range of from 350 to 425 ppm, results in adsorption of carbon dioxide in a range of from 0.3 to 1.3 molecules adsorbed CO₂ per unit cell.
Aspect 58. The metal ion-doped crystalline microporous aluminosilicate composition of aspect 57, wherein exposure of the crystalline microporous aluminosilicate composition to a gas source having (a) a total pressure in a range of from 50 kPa to 125 kPa, and (b) a CO₂ content in a range of from 350 to 425 ppm, results in adsorption of carbon dioxide in a range of from 0.4 to 0.6 molecules adsorbed CO₂ per unit cell.
Aspect 59. The metal ion-doped crystalline microporous aluminosilicate composition of aspect 57, wherein exposure of the crystalline microporous aluminosilicate composition to a gas source having (a) a total pressure in a range of from 50 kPa to 125 kPa, and (b) a CO₂ content in a range of from 350 to 425 ppm, results in adsorption of carbon dioxide in a range of from 0.6 to 1.25 molecules adsorbed CO₂ per unit cell.
Aspect 60. The metal ion-doped crystalline microporous aluminosilicate composition of any one of aspects 27-59, wherein exposure of the crystalline microporous aluminosilicate composition to a gas source having (a) a total pressure in a range of from 50 kPa to 125 kPa, and (b) a CO₂ content in a range of from 350 to 425 ppm, results in adsorption of carbon dioxide in a range of from 0.2 to 0.7 mmols adsorbed CO₂ per gram of metal ion-doped crystalline microporous aluminosilicate composition.
Aspect 61. The metal ion-doped crystalline microporous aluminosilicate composition of aspect 60, wherein exposure of the crystalline microporous aluminosilicate composition to a gas source having (a) a total pressure in a range of from 50 kPa to 125 kPa, and (b) a CO₂ content in a range of from 350 to 425 ppm, results in adsorption of carbon dioxide in a range of from 0.3 to 0.7 mmol adsorbed CO₂ per gram of metal ion-doped crystalline microporous aluminosilicate composition.
Aspect 62. The metal ion-doped crystalline microporous aluminosilicate composition of aspect 60, wherein exposure of the crystalline microporous aluminosilicate composition to a gas source having (a) a total pressure in a range of from 50 kPa to 125 kPa, and (b) a CO₂ content in a range of from 350 to 425 ppm, results in adsorption of carbon dioxide in a range of from 0.5 to 0.7 mmol adsorbed CO₂ per gram of metal ion-doped crystalline microporous aluminosilicate composition.
Aspect 63. The metal ion-doped crystalline microporous aluminosilicate composition of any one of aspects 56-62, wherein the gas source has a total pressure of about 100 kPa.
Aspect 64. The metal ion-doped crystalline microporous aluminosilicate composition of any one of aspects 56-63, wherein the gas source has a CO₂ content in a range of about 400 ppm.
Aspect 65. The metal ion-doped crystalline microporous aluminosilicate composition of any one of aspects 27-64, wherein passage of a gas source having (a) a total pressure in a range of from 50 kPa to 125 kPa, and (b) a CO₂ content in a range of from 350 to 425 ppm, through a tube containing a fixed bed of the metal ion-doped crystalline microporous aluminosilicate composition, results in complete breakthrough of CO₂ after adsorption of 0.2-0.5 mmol of CO₂ per gram of metal ion-doped crystalline microporous aluminosilicate composition.
Aspect 66. The metal ion-doped crystalline microporous aluminosilicate composition of any one of aspects 27-65, wherein passage of a gas source having (a) a total pressure in a range of from 50 kPa to 125 kPa, and (b) a CO₂ content in a range of from 350 to 425 ppm, through a tube containing a fixed bed of the metal ion-doped crystalline microporous aluminosilicate composition, results in complete breakthrough of CO₂ after adsorption of an amount of CO₂ (on a mmol/g basis) that is 1.4-1.6 times greater than the amount of CO₂ adsorbed by an equal weight of zeolite 13X before complete breakthrough of CO₂ occurs under the same conditions.
Aspect 67. The metal ion-doped crystalline microporous aluminosilicate composition of aspect 65 or aspect 66, wherein the gas source is 400 ppm CO₂/400 ppm Ar balanced by He at a flow rate of 20 mL·min⁻¹ at 30° C.
Aspect 68. The metal ion-doped crystalline microporous aluminosilicate composition of aspect 65 or aspect 66, wherein the gas source is 400 ppm CO₂/1% Ar/20% O₂/balance N₂, at a flow rate of 14 mL·min⁻¹ at 30° C.
Aspect 69. The metal ion-doped crystalline microporous aluminosilicate composition of any one of aspects 27-68, wherein adsorbed carbon dioxide is desorbed at a temperature of less than 130° C.
Aspect 70. The metal ion-doped crystalline microporous aluminosilicate composition of aspect 69, wherein adsorbed carbon dioxide is desorbed at a temperature of less than 125° C.
Aspect 71. The metal ion-doped crystalline microporous aluminosilicate composition of aspect 69, wherein adsorbed carbon dioxide is desorbed at a temperature of less than 120° C.
Aspect 72. The metal ion-doped crystalline microporous aluminosilicate composition of aspect 69, wherein adsorbed carbon dioxide is desorbed at a temperature of less than 115° C.
Aspect 73. The metal ion-doped crystalline microporous aluminosilicate composition of aspect 69, wherein adsorbed carbon dioxide is desorbed at a temperature of less than 110° C.
Aspect 74. The metal ion-doped crystalline microporous aluminosilicate composition of aspect 69, wherein adsorbed carbon dioxide is desorbed at a temperature of less than 100° C.
Aspect 75. The metal ion-doped crystalline microporous aluminosilicate composition of any one of aspects 27-74, wherein adsorbed CO₂ is completed desorbed at a temperature that is lower than the temperature required to completely desorb CO₂ from zeolite 13X under otherwise the same conditions.
Aspect 76. The metal ion-doped crystalline microporous aluminosilicate composition of any one of aspects 27-75, wherein the metal ion-doped crystalline microporous aluminosilicate composition has a selectivity for CO₂ over N₂ of at least 800:1.
Aspect 77. The metal ion-doped crystalline microporous aluminosilicate composition of any one of aspects 27-76, wherein the metal ion-doped crystalline microporous aluminosilicate composition has a selectivity for CO₂ over N₂ of at least 900:1.
Aspect 78. A method of preparing a metal ion-doped crystalline microporous aluminosilicate composition of any one of aspects 27-77, the method comprising contacting a calcined precursor crystalline microporous aluminosilicate with an aqueous solution of a salt of the metal ion, and optionally rinsing the resulting metal ion-doped crystalline microporous aluminosilicate with water and/or optionally drying the metal ion-doped crystalline microporous aluminosilicate.
Aspect 79. The method of aspect 78, wherein, wherein the calcined precursor crystalline microporous aluminosilicate has an AEI, AFX, or CHA topology.
Aspect 80. The method of aspect 79, wherein, wherein the calcined precursor crystalline microporous aluminosilicate has an AEI topology.
Aspect 81. The method of aspect 80, wherein, wherein the calcined precursor crystalline microporous aluminosilicate having an AEI topology is SSZ-39.
Aspect 82. The method of aspect 79, wherein, wherein the calcined precursor crystalline microporous aluminosilicate has an AFX topology.
Aspect 83. The method of aspect 82, wherein, wherein the calcined precursor crystalline microporous aluminosilicate having an AFX topology is SSZ-16.
Aspect 84. The method of aspect 79, wherein, wherein the calcined precursor crystalline microporous aluminosilicate has a CHA topology.
Aspect 85. The method of aspect 84, wherein, wherein the calcined precursor crystalline microporous aluminosilicate having an CHA topology is SSZ-13.
Aspect 86. The method of any one of aspects 78-85, wherein the metal ion is Zn²⁺.
Aspect 87. The method of any one of aspects 78-85, wherein the salt of a metal ion is Zn(OAc)₂, ZnCl₂, Zn(NO₃)₂, ZnSO₄, or ZnBr₂.
Aspect 88. A method of capturing carbon dioxide from a gaseous source mixture, the method comprising contacting the gaseous source mixture with the metal ion-doped crystalline microporous aluminosilicate of any one of aspects 27-87 such that carbon dioxide in the gaseous source mixture is adsorbed by the metal ion-doped crystalline microporous aluminosilicate.
Aspect 89. The method of aspect 88, further comprising desorbing the carbon dioxide from the carbon-dioxide laden metal ion-doped crystalline microporous aluminosilicate.
Aspect 90. The method of aspect 88, wherein the contacting of the metal ion-doped crystalline microporous aluminosilicate with the gaseous source mixture is done in the absence of, or without the use of, an added desiccant.
Aspect 91. The method of aspect 88, wherein the contacting of the metal ion-doped crystalline microporous aluminosilicate with the gaseous source mixture is done in the presence of, or with the use of, an added desiccant.
Aspect 92. The method of any one of aspects 88-91, wherein contacting the gaseous source mixture with the metal ion-doped crystalline microporous aluminosilicate comprises passing the gaseous source mixture through a fixed-bed of adsorbent comprising the metal ion-doped crystalline microporous aluminosilicate.
Aspect 93. The method of any one of aspects 88-92, wherein contacting the gaseous source mixture with the metal ion-doped crystalline microporous aluminosilicate occurs at a temperature of less than 50° C.
Aspect 94. The method of any one of aspects 89-93, wherein desorbing the carbon dioxide from the carbon-dioxide laden metal ion-doped crystalline microporous aluminosilicate occurs at a temperature less than 130° C.

What is claimed:

1. A metal ion-doped crystalline microporous aluminosilicate composition comprising:
(a) a three-dimensional aluminosilicate framework containing α-cages with 8-MR openings that are sized to accommodate the molecular dimensions of carbon dioxide (3.3 Å);
(b) the framework further comprising d6r (or D6MR) composite building blocks having 6-membered rings that face (are part of) or connect the α-cage of the framework;
wherein the crystalline microporous aluminosilicate contains 1.2 to 8 metal ions per unit cell, wherein the ratio of metal ions to aluminum within the unit cell is from 0.33 to 0.85; and
wherein the metal ion-doped crystalline microporous aluminosilicate composition adsorbs carbon dioxide when exposed to a gaseous mixture comprising carbon dioxide.

2. The metal ion-doped crystalline microporous aluminosilicate composition of claim 1, wherein the three-dimensional aluminosilicate framework has an AEI, AFT, AFX, CHA, EAB, KFI, LEV, or SAS topology.

3. The metal ion-doped crystalline microporous aluminosilicate composition of claim 2, wherein the three-dimensional aluminosilicate framework has an AEI, AFX, or CHA topology.

4. The metal ion-doped crystalline microporous aluminosilicate composition of claim 3, wherein the three-dimensional aluminosilicate framework has an AEI topology.

5. The metal ion-doped crystalline microporous aluminosilicate composition of claim 3, wherein the three-dimensional aluminosilicate framework has an AFX topology.

6. The metal ion-doped crystalline microporous aluminosilicate composition of claim 3, wherein the three-dimensional aluminosilicate framework has a CHA topology.

7. The metal ion-doped crystalline microporous aluminosilicate composition of claim 6, wherein the CHA is synthetic CHA.

8. The metal ion-doped crystalline microporous aluminosilicate composition of claim 1, wherein the composition has a Si:Al atomic ratio in a range of from 1:1 to 20:1.

9. The metal ion-doped crystalline microporous aluminosilicate composition of claim 1, wherein the composition has a Si:Al atomic ratio in a range of from 2:1 to 8.5:1, or from 2:1 to 7.5:1, or from 5.5:1 to 8.5:1, or from 6.5:1 to 7.5:1, or from 7.5:1 to 8.5:1.

10. The metal ion-doped crystalline microporous aluminosilicate composition claim 9, wherein the composition has a Si:Al atomic ratio in a range of from 5.5:1 to 8.5:1, or from 6.5:1 to 7.5:1, or from 7.5:1 to 8.5:1.

11. The metal ion-doped crystalline microporous aluminosilicate composition of claim 1, wherein the metal ions are positioned within the lattice of the three-dimensional aluminosilicate framework.

12. The composition according to claim 11, wherein the (transition) metal ions are iron, cobalt, nickel, copper, zinc, or silver.

13. The composition according to claim 12, wherein the metal ions are zinc.

14. The metal ion-doped crystalline microporous aluminosilicate composition of claim 1, wherein the metal ions are present within the framework lattice in a ratio of from 7 to 8 metal ions per unit cell.

15. The metal ion-doped crystalline microporous aluminosilicate composition of any one of claim 1, wherein the metal ions are present within the framework lattice in a ratio of from 1.21 to 2.6 metal ions per unit cell.

16. The metal ion-doped crystalline microporous aluminosilicate composition of claim 1, wherein the ratio of metal ions to aluminum within the unit cell is from 0.34 to 0.58.

17. The metal ion-doped crystalline microporous aluminosilicate composition of claim 1, wherein the ratio of metal ions to aluminum within the unit cell is from 0.59 to 0.85.

18. The metal ion-doped crystalline microporous aluminosilicate composition of claim 1, wherein the composition contains, or has the capacity to contain, carbon dioxide in a range of from 0.3 to 1.7 molecules adsorbed COZ per unit cell.

19. The metal ion-doped crystalline microporous aluminosilicate composition of claim 1, wherein exposure of the crystalline microporous aluminosilicate composition to a gas source having (a) a total pressure in a range of from 50 kPa to 125 kPa, and (b) a CO₂ content in a range of from 350 to 425 ppm, results in adsorption of carbon dioxide in a range of from 0.3 to 1.7 molecules adsorbed CO₂ per unit cell.

20. The metal ion-doped crystalline microporous aluminosilicate composition of claim 1, wherein exposure of the crystalline microporous aluminosilicate composition to a gas source having (a) a total pressure in a range of from 50 kPa to 125 kPa, and (b) a CO₂ content in a range of from 350 to 425 ppm, results in adsorption of carbon dioxide in a range of from 0.2 to 0.7 mmols adsorbed CO₂ per gram of metal ion-doped crystalline microporous aluminosilicate composition.

21. The metal ion-doped crystalline microporous aluminosilicate composition of claim 1, wherein passage of a gas source having (a) a total pressure in a range of from 50 kPa to 125 kPa, and (b) a CO₂ content in a range of from 350 to 425 ppm, through a tube containing a fixed bed of the metal ion-doped crystalline microporous aluminosilicate composition, results in complete breakthrough of CO₂ after adsorption of 0.2-0.5 mmol of CO₂ per gram of metal ion-doped crystalline microporous aluminosilicate composition.

22. The metal ion-doped crystalline microporous aluminosilicate composition of claim 1, wherein passage of a gas source having (a) a total pressure in a range of from 50 kPa to 125 kPa, and (b) a CO₂ content in a range of from 350 to 425 ppm, through a tube containing a fixed bed of the metal ion-doped crystalline microporous aluminosilicate composition, results in complete breakthrough of CO₂ after adsorption of an amount of CO₂ (on a mmol/g basis) that is 1.4-1.6 times greater than the amount of CO₂ adsorbed by an equal weight of zeolite 13X before complete breakthrough of CO₂ occurs under the same conditions.

23. The metal ion-doped crystalline microporous aluminosilicate composition of claim 1, wherein adsorbed carbon dioxide is desorbed at a temperature of less than 130° C.

24. A method of preparing a metal ion-doped crystalline microporous aluminosilicate composition of claim 1, the method comprising contacting a calcined precursor crystalline microporous aluminosilicate with an aqueous solution of a salt of the metal ion, and optionally rinsing the resulting metal ion-doped crystalline microporous aluminosilicate with water and/or optionally drying the metal ion-doped crystalline microporous aluminosilicate.

25. A method of capturing carbon dioxide from a gaseous source mixture, the method comprising contacting the gaseous source mixture with the metal ion-doped crystalline microporous aluminosilicate of claim 1 such that carbon dioxide in the gaseous source mixture is adsorbed by the metal ion-doped crystalline microporous aluminosilicate.
